(19) United States
(12) Patent Application Publication
(10) Pub. No.: US 2026/0089783 A1
(43) Pub. Date: Mar. 26, 2026

(54) SYSTEMS AND METHODS FOR DETERMINING LOCATIONS OF COLLOCATED ELECTRONIC DEVICES

(71) Applicant: Apple Inc., Cupertino, CA (US)

(72) Inventors: Tommy ROCHETTE, Santa Cruz, CA (US); Jiwoo JANG, San Francisco, CA (US); Patrick PIEMONTE, San Francisco, CA (US); Yann LY-GAGNON, San Francisco, CA (US); Joseph P. CERRA, San Francisco, CA (US); Anjali S. SANDESARA, Sunnyvale, CA (US); Peter F. HANDEL, San Jose, CA (US); Ronak J. SHAH, Sunnyvale, CA (US); Leanid VOUK, San Carlos, CA (US); Willem MATTELAER, San Jose, CA (US); Praveen Gowda IPPADI VEERABHADRE GOWDA, San Jose, CA (US)

(21) Appl. No.: 19/323,961

(22) Filed: Sep. 9, 2025

Related U.S. Application Data
(60) Provisional application No. 63/698,520, filed on Sep. 24, 2024.
(60) Provisional application No. 63/876,750, filed on Sep. 5, 2025.

(51) Int. Cl. H04W 76/15; H04W 64/00

(52) U.S. Cl. CPC H04W 76/15; H04W 64/00

(57) ABSTRACT

A first device 1) displays an element that is selectable to establish a multi-user communication session between a first user of the first device and a second user of a second device based on a pose of second device in a physical environment in which the first device and second device are collocated, 2) starts different types of sessions based on a type of device via which the second user accepts a request to join the session, 3) while in a multi-user communication session that includes the first user, the second user, without including a third user of a third device, transmits, to the third device, a shared coordinate system of the physical environment between the first and second devices, and/or 4) transmits, to the third device, shared origins of different devices in response to detecting that the first and third devices are collocated in the physical environment.

### CROSS-REFERENCE TO RELATED APPLICATIONS

This application claims the benefit of U.S. Provisional Application No. 63/876,750, filed Sep. 5, 2025, and U.S. Provisional Application No. 63/698,520, filed Sep. 24, 2024, the contents of which are herein incorporated by reference in their entireties for all purposes.

### FIELD OF THE DISCLOSURE

This relates generally to systems and methods for determining locations of electronic devices that are collocated in a physical environment.

### BACKGROUND OF THE DISCLOSURE

Some computer graphical environments provide two-dimensional and/or three-dimensional environments where at least some objects displayed for a user's viewing are virtual and generated by a computer. In some examples, three-dimensional environments are presented by multiple electronic devices in communication with each other. In some examples, a portal through which to visually communicate with a particular user is displayed in a three-dimensional environment presented at a respective electronic device.

### SUMMARY OF THE DISCLOSURE

Some examples of the disclosure are directed to systems and methods of determining locations of electronic devices that are collocated in a physical environment. For example, before a multi-user communication session is established between a first electronic device and a second electronic device, the first electronic device and/or the second electronic device may determine a location of the other electronic device in view of the present disclosure. For example, the first electronic device and the second electronic device may be collocated in a physical environment and may determine a shared reference origin in the physical environment based on map data determined by the first electronic device and/or map data determined by the second electronic device. The first electronic device may determine an offset between an origin of a coordinate system of the first electronic device and the shared reference origin. The first electronic device may transmit data indicative of the pose (e.g., position and orientation) of the first electronic device relative to the origin of the coordinate system of the first electronic device and data indicative of the offset to the second electronic device. In response to receiving such data, the second electronic device may determine a location of the first electronic device relative to the shared reference origin.

In some examples, a first electronic device initiates different types of multi-user communication sessions with a second user of a second electronic device based on a type of electronic device from which the second user of the second electronic device accepts a request to join a multi-user communication session with a first user of the first electronic device.

In some examples, a first electronic device detects and responds to a third user of a third electronic device being collocated in a physical environment with a first user of the first electronic device while in a multi-user communication session that includes the first user of the first electronic device and a second user of a second electronic device, without including the third user, where the first user and the second user are collocated in the physical environment, and where a shared spatial coordinate system of the physical environment between the first electronic device and the second electronic device is established.

In some examples, a first electronic device performs different location tracking processes with different electronic devices in response to detecting collocation with the different electronic devices.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 generally illustrates an electronic device presenting a three-dimensional environment, according to some examples of the disclosure.

FIGS. 2A-2C generally illustrate block diagrams of example architectures for electronic devices or systems, according to some examples of the disclosure.

FIG. 3 generally illustrates an example of a spatial group in a multi-user communication session that includes a first electronic device and a second electronic device, according to some examples of the disclosure.

FIGS. 4A-4G generally illustrate examples of a location tracking process being performed between a first electronic device and a second electronic device before a multi-user communication session is established between the first electronic device and the second electronic device, according to some examples of the disclosure.

FIG. 4H generally illustrates an example of electronic devices presenting shared virtual content while in a multi-user communication session, according to some examples of the disclosure.

FIG. 5 generally illustrates a flow diagram illustrating a method for displaying a user interface element selectable to establish a multi-user communication session between a first electronic device and a second electronic device, according to some examples of the disclosure.

FIG. 6 generally illustrates a flow diagram illustrating a method for performing an operation based on certain information, according to some examples of the disclosure.

FIGS. 7A through 7E-1 generally illustrate examples of a first electronic device initiating different types of multi-user communication sessions with a second user of a second electronic device based on a type of electronic device from which the second user of the second electronic device accepts a request to join a multi-user communication session with a first user of the first electronic device, according to some examples of the disclosure.

FIG. 8 generally illustrates a flow diagram illustrating a method for initiating different types of multi-user communication sessions with a second user of a second electronic device based on a type of electronic device from which the second user of the second electronic device accepts a request to join a multi-user communication session with a first user of a first electronic device, according to some examples of the disclosure.

FIGS. 9A through 9F generally illustrate examples of a first electronic device detecting and responding to a third user of a third electronic device being collocated in a physical environment with a first user of the first electronic device while in a multi-user communication session that includes the first user of the first electronic device and a second user of a second electronic device, without including the third user of the third electronic device, where the first user and the second user are collocated in the physical environment, and where a shared spatial coordinate system of the physical environment between the first electronic device and the second electronic device is established, according to some examples of the disclosure.

FIG. 10 generally illustrates a flow diagram illustrating a method for detecting and responding to a third user of a third electronic device being collocated in a physical environment with a first user of the first electronic device while in a multi-user communication session that includes the first user of the first electronic device and a second user of a second electronic device, without including the third user, where the first user and the second user are collocated in the physical environment, and where a shared spatial coordinate system of the physical environment between the first electronic device and the second electronic device is established, according to some examples of the disclosure.

FIGS. 11A through 110 generally illustrate examples of a first electronic device performing different location tracking processes with different electronic devices in response to detecting collocation with the different electronic devices, according to some examples of the disclosure.

FIG. 12 generally illustrates a flow diagram illustrating a method for performing different location tracking processes with different electronic devices in response detecting collocation with the different electronic devices, according to some examples of the disclosure.

### DETAILED DESCRIPTION

Some examples of the disclosure are directed to systems and methods of determining locations of electronic devices that are collocated in a physical environment. For example, before a multi-user communication session is established between a first electronic device and a second electronic device, the first electronic device and/or the second electronic device may determine a location of the other electronic device in view of the present disclosure. For example, the first electronic device and the second electronic device may be collocated in a physical environment and may determine a shared reference origin in the physical environment based on map data determined by the first electronic device and/or map data determined by the second electronic device. The first electronic device may determine an offset between an origin of a coordinate system of the first electronic device and the shared reference origin. The first electronic device may transmit data indicative of the pose (e.g., position and/or orientation) of the first electronic device relative to the origin of the coordinate system of the first electronic device and data indicative of the offset to the second electronic device. In response to receiving such data, the second electronic device may determine a location of the first electronic device relative to the shared reference origin.

In some examples, a first electronic device initiates different types of multi-user communication sessions with a second user of a second electronic device based on a type of electronic device from which the second user of the second electronic device accepts a request to join a multi-user communication session with a first user of the first electronic device.

In some examples, a first electronic device detects and responds to a third user of a third electronic device being collocated in a physical environment with a first user of the first electronic device while in a multi-user communication session that includes the first user of the first electronic device and a second user of a second electronic device, without including the third user, where the first user and the second user are collocated in the physical environment, and where a shared spatial coordinate system of the physical environment between the first electronic device and the second electronic device is established.

In some examples, a first electronic device performs different location tracking processes with different electronic devices in response to detecting collocation with the different electronic devices.

In some examples, initiating a multi-user communication session may include interaction with one or more user interface elements. In some examples, a user's gaze may be tracked by an electronic device as an input for targeting a selectable option/affordance within a respective user interface element that is displayed in the three-dimensional environment. For example, gaze can be used to identify one or more options/affordances targeted for selection using another selection input. In some examples, a respective option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In some examples, a spatial group or state in the multi-user communication session denotes a spatial arrangement or template that dictates locations of users and content that are located in or otherwise associated with the spatial group. In some examples, users in the same spatial group within the multi-user communication session experience spatial truth according to the spatial arrangement of the spatial group. In some examples, spatial truth requires a consistent spatial arrangement between users (or representations thereof) and virtual objects. In some examples, when the user of the first electronic device is in a first spatial group and the user of the second electronic device is in a second spatial group in the multi-user communication session, the users experience spatial truth that is localized to their respective spatial groups. In some examples, while the user of the first electronic device and the user of the second electronic device are grouped into separate spatial groups or states within the multi-user communication session, if the first electronic device and the second electronic device return to the same operating state, the user of the first electronic device and the user of the second electronic device are regrouped into the same spatial group within the multi-user communication session.

As used herein, a hybrid spatial group corresponds to a group or number of participants (e.g., users) in a multi-user communication session in which at least a subset of the participants is non-collocated in a physical environment. For example, as described via one or more examples in this disclosure, a hybrid spatial group includes at least two participants who are collocated in a first physical environment and at least one participant who is non-collocated with the at least two participants in the first physical environment (e.g., the at least one participant is located in a second physical environment, different from the first physical environment). In some examples, a hybrid spatial group in the multi-user communication session has a spatial arrangement that dictates locations of users and content that are located in the spatial group. In some examples, users in the same hybrid spatial group within the multi-user communication session experience spatial truth according to the spatial arrangement of the spatial group, as similarly discussed above.

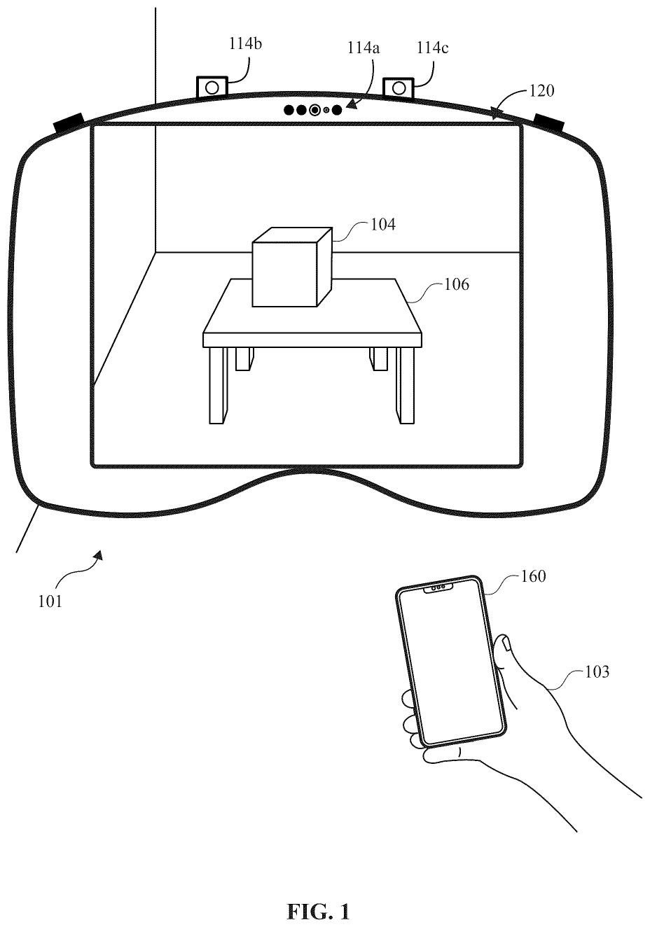

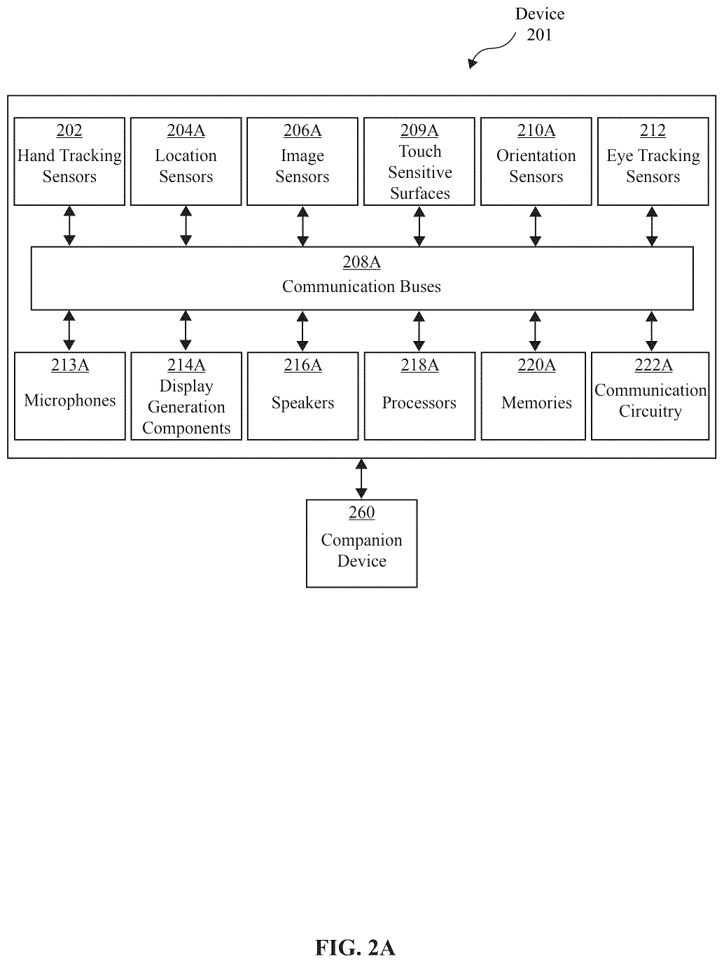

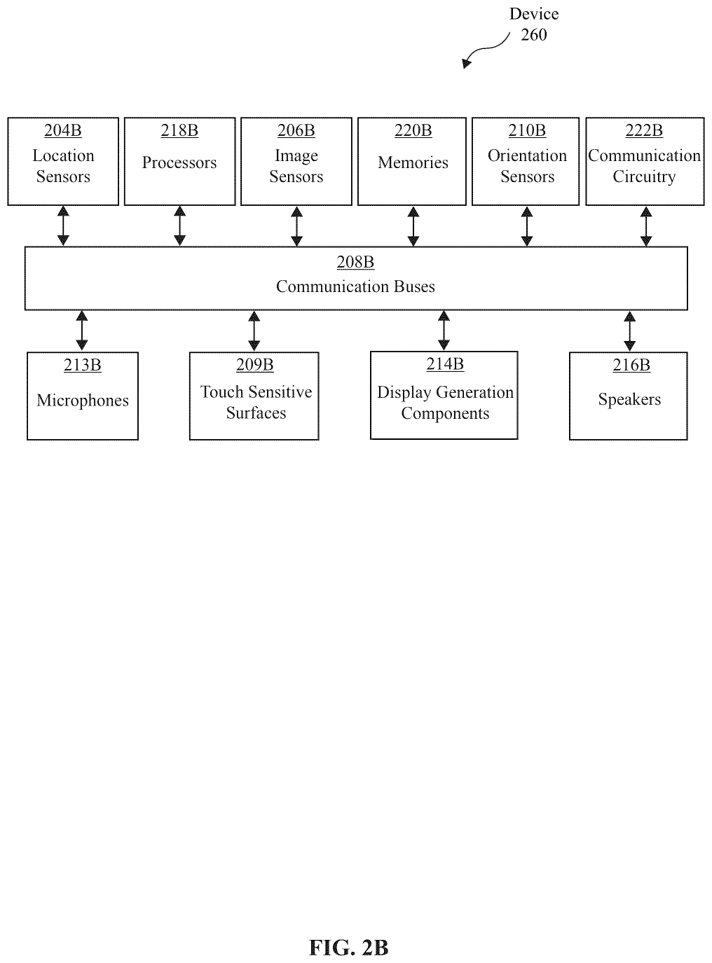

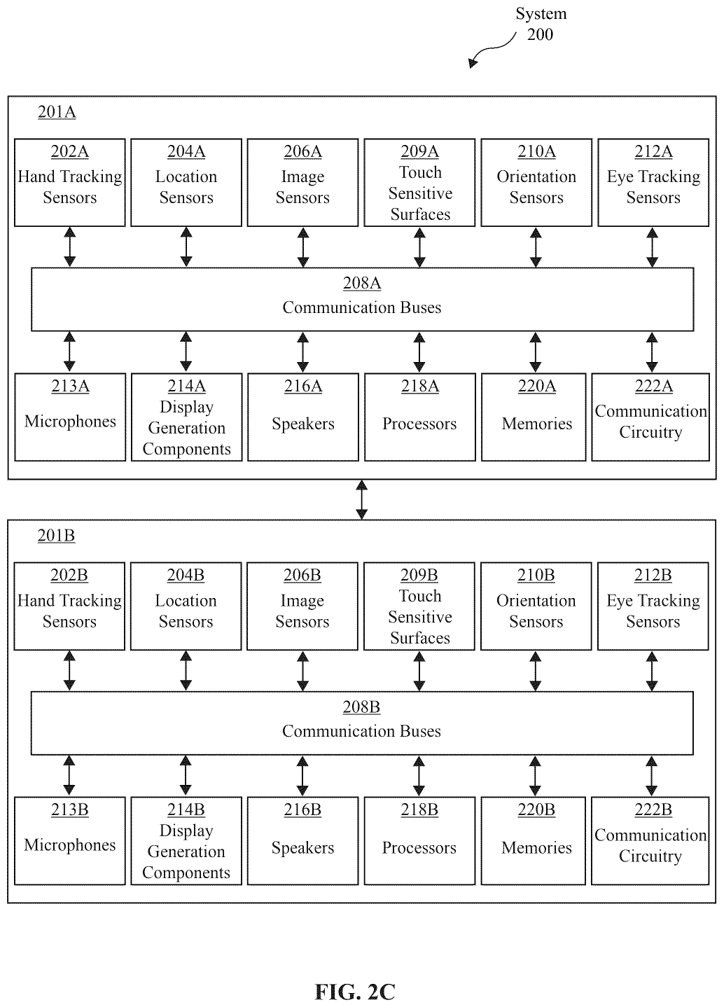

FIG. 1 illustrates an electronic device 101 presenting three-dimensional environment (e.g., an extended reality (XR) environment or a computer-generated reality (CGR) environment, optionally including representations of physical and/or virtual objects), according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2A. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of the physical environment including table 106 (illustrated in the field of view of electronic device 101).

In some examples, as shown in FIG. 1, electronic device 101 includes one or more internal image sensors 114a oriented towards a face of the user (e.g., eye tracking cameras as described below with reference to FIGS. 2A-2B). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user. In some examples, the field of view visible to the user is the same as a field of view of external image sensors 114b and 114c. For example, when display 120 is optionally part of a head-mounted device, the field of view of display 120 is optionally the same as or similar to the field of view of the user's eyes. In some examples, the field of view visible to the user is different from a field of view of external image sensors 114b and 114c (e.g., narrower than the field of view of external image sensors 114b and 114c). In other examples, the field of view of display 120 may be smaller than the field of view of the user's eyes. A viewpoint of a user determines what content is visible in the field of view, a viewpoint generally specfies a location and a direction relative to the three-dimensional environment. As the viewpoint of a user shifts, the field of view of the three-dimensional environment will also shift accordingly. In some examples, electronic device 101 may be an optical see-through device in which display 120 is a transparent or translucent display through which portions of the physical environment may be directly viewed. In some examples, display 120 may be included within a transparent lens and may overlap all or a portion of the transparent lens. In other examples, electronic device may be a video-passthrough device in which display 120 is an opaque display configured to display images of the physical environment using images captured by external image sensors 114b and 114c. While a single display is shown in FIG. 1, it is understood that display 120 optionally includes more than one display. For example, display 120 optionally includes a stereo pair of displays (e.g., left and right display panels for the left and right eyes of the user, respectively) having displayed outputs that are merged (e.g., by the user's brain) to create the view of the content shown in FIG. 1. In some examples, as discussed in more detail below with reference to FIGS. 2A-2B, the display 120 includes or corresponds to a transparent or translucent surface (e.g., a lens) that is not equipped with display capability (e.g., and is therefore unable to generate and display the virtual object 104) and alternatively presents a direct view of the physical environment in the user's field of view (e.g., the field of view of the user's eyes).

In some examples, the electronic device 101 is configured to display (e.g., in response to a trigger) a virtual object 104 in the three-dimensional environment. Virtual object 104 is represented by a cube illustrated in FIG. 1, which is not present in the physical environment, but is displayed in the three-dimensional environment positioned on the top of table 106 (e.g., real-world table or a representation thereof). Optionally, virtual object 104 is displayed on the surface of the table 106 in the three-dimensional environment displayed via the display 120 of the electronic device 101 in response to detecting the planar surface of table 106 in the physical environment 100.

It is understood that virtual object 104 is a representative virtual object and one or more different virtual objects (e.g., of various dimensionality such as two-dimensional or other three-dimensional virtual objects) can be included and rendered in a three-dimensional environment. For example, the virtual object can represent an application or a user interface displayed in the three-dimensional environment. In some examples, the virtual object can represent content corresponding to the application and/or displayed via the user interface in the three-dimensional environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

As discussed herein, one or more air pinch gestures performed by a user (e.g., with hand 103 in FIG. 1) are detected by one or more input devices of electronic device 101 and interpreted as one or more user inputs directed to content displayed by electronic device 101. Additionally or alternatively, in some examples, the one or more user inputs interpreted by the electronic device 101 as being directed to content displayed by electronic device 101 (e.g., the virtual object 104) are detected via one or more hardware input devices (e.g., controllers, touch pads, proximity sensors, buttons, sliders, knobs, etc.) rather than via the one or more input devices that are configured to detect air gestures, such as the one or more air pinch gestures, performed by the user. Such depiction is intended to be exemplary rather than limiting; the user optionally provides user inputs using different air gestures and/or using other forms of input.

In some examples, the electronic device 101 may be configured to communicate with a second electronic device, such as a companion device. For example, as illustrated in FIG. 1, the electronic device 101 is optionally in communication with electronic device 160. In some examples, electronic device 160 corresponds to a mobile electronic device, such as a smartphone, a tablet computer, a smart watch, a laptop computer, or other electronic device. In some examples, electronic device 160 corresponds to a non-mobile electronic device, which is generally stationary and not easily moved within the physical environment (e.g., desktop computer, server, etc.). Additional examples of electronic device 160 are described below with reference to the architecture block diagram of FIG. 2B. In some examples, the electronic device 101 and the electronic device 160 are associated with a same user. For example, in FIG. 1, the electronic device 101 may be positioned on (e.g., mounted to) a head of a user and the electronic device 160 may be positioned near electronic device 101, such as in a hand 103 of the user (e.g., the hand 103 is holding the electronic device 160), a pocket or bag of the user, or a surface near the user. The electronic device 101 and the electronic device 160 are optionally associated with a same user account of the user (e.g., the user is logged into the user account on the electronic device 101 and the electronic device 160). Additional details regarding the communication between the electronic device 101 and the electronic device 160 are provided below with reference to FIGS. 2A-2C.

In some examples, displaying an object in a three-dimensional environment is caused by or enables interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the descriptions that follows, an electronic device that is in communication with one or more displays and one or more input devices is described. It is understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it is understood that the described electronic device, display and touch-sensitive surface are optionally distributed between two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIGS. 2A-2C illustrate block diagrams of example architectures for electronic devices or systems according to some examples of the disclosure. In some examples, electronic device 201 and/or electronic device 260 include one or more electronic devices. For example, the electronic device 201 may be a portable device, an auxiliary device in communication with another device, a head-mounted display, a head-worn speaker, etc., respectively. In some examples, electronic device 201 corresponds to electronic device 101 described above with reference to FIG. 1. In some examples, electronic device 260 corresponds to electronic device 160 described above with reference to FIG. 1.

As illustrated in FIG. 2A, the electronic device 201 optionally includes one or more sensors, such as one or more hand tracking sensors 202, one or more location sensors 204A, one or more image sensors 206A (optionally corresponding to internal image sensors 114a and/or external image sensors 114b and 114c in FIG. 1), one or more touch-sensitive surfaces 209A, one or more motion and/or orientation sensors 210A, one or more eye tracking sensors 212, one or more microphones 213A or other audio sensors, one or more body tracking sensors (e.g., torso and/or head tracking sensors), etc. The electronic device 201 optionally includes one or more output devices, such as one or more display generation components 214A, optionally corresponding to display 120 in FIG. 1, one or more speakers 216A, one or more haptic output devices (not shown), etc. The electronic device 201 optionally includes one or more processors 218A, one or more memories 220A, and/or communication circuitry 222A. One or more communication buses 208A are optionally used for communication between the above-mentioned components of electronic device 201.

Additionally, the electronic device 260 optionally includes the same or similar components as the electronic device 201. For example, as shown in FIG. 2B, the electronic device 260 optionally includes one or more location sensors 204B, one or more image sensors 206B, one or more touch-sensitive surfaces 209B, one or more orientation sensors 210B, one or more microphones 213B, one or more display generation components 214B, one or more speakers 216B, one or more processors 218B, one or more memories 220B, and/or communication circuitry 222B. One or more communication buses 208B are optionally used for communication between the above-mentioned components of electronic device 260.

The electronic devices 201 and 260 are optionally configured to communicate via a wired or wireless connection (e.g., via communication circuitry 222A, 222B) between the two electronic devices. For example, as indicated in FIG. 2A, the electronic device 260 may function as a companion device to the electronic device 201. For example, in some examples, the electronic device 260 processes sensor inputs from electronic devices 201 and 260 and/or generates content for display using display generation components 214A of electronic device 201.

Communication circuitry 222A, 222B optionally includes circuitry for communicating with electronic devices, networks, such as the Internet, intranets, a wired network and/or a wireless network, cellular networks, and wireless local area networks (LANs). Communication circuitry 222A, 222B optionally includes circuitry for communicating using near-field communication (NFC) and/or short-range communication, such as Bluetooth®, etc. In some examples, communication circuitry 222A, 222B includes or supports Wi-Fi (e.g., an 802.11 protocol), Ethernet, ultra-wideband (“UWB”), high frequency systems (e.g., 900 MHz, 2.4 GHz, and 5.6 GHz communication systems), or any other communications protocol, or any combination thereof.

One or more processors 218A, 218B include one or more general processors, one or more graphics processors, and/or one or more digital signal processors. In some examples, one or more processors 218A, 218B include one or more microprocessors, one or more central processing units, one or more application-specific integrated circuits, one or more field-programmable gate arrays, one or more programmable logic devices, or a combination of such devices. In some examples, memories 220A and/or 220B are a non-transitory computer-readable storage medium (e.g., flash memory, random access memory, or other volatile or non-volatile memory or storage) that stores computer-readable instructions configured to be executed by the one or more processors 218A, 218B to perform the techniques, processes, and/or methods described herein. In some examples, memories 220A and/or 220B can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, one or more display generation components 214A, 214B include a single display (e.g., a liquid-crystal display (LCD), organic light-emitting diode (OLED), or other types of display). In some examples, the one or more display generation components 214A, 214B include multiple displays. In some examples, the one or more display generation components 214A, 214B can include a display with touch capability (e.g., a touch screen), a projector, a holographic projector, a retinal projector, a transparent or translucent display, etc. In some examples, the electronic device does not include one or more display generation components 214A or 214B. For example, instead of the one or more display generation components 214A or 214B, some electronic devices include transparent or translucent lenses or other surfaces that are not configured to display or present virtual content. However, it should be understood that, in such instances, the electronic device 201 and/or the electronic device 260 are optionally equipped with one or more of the other components illustrated in FIGS. 2A and 2B and described herein, such as the one or more hand tracking sensors 202, one or more eye tracking sensors 212, one or more image sensors 206A, and/or the one or more motion and/or orientations sensors 210A. Alternatively, in some examples, the one or more display generation components 214A or 214B are provided separately from the electronic devices 201 and/or 260. For example, the one or more display generation components 214A, 214B are in communication with the electronic device 201 (and/or electronic device 260), but are not integrated with the electronic device 201 and/or electronic device 260 (e.g., within a housing of the electronic devices 201, 260). In some examples, electronic devices 201 and 260 include one or more touch-sensitive surfaces 209A and 209B, respectively, for receiving user inputs, such as tap inputs and swipe inputs or other gestures (e.g., hand-based or finger-based gestures). In some examples, the one or more display generation components 214A, 214B and the one or more touch-sensitive surfaces 209A, 209B form one or more touch-sensitive displays (e.g., a touch screen integrated with each of electronic devices 201 and 260 or external to each of electronic devices 201 and 260 that is in communication with each of electronic devices 201 and 260).

Electronic devices 201 and 260 optionally include one or more image sensors 206A and 206B, respectively. The one or more image sensors 206A, 206B optionally include one or more visible light image sensors, such as charged coupled device (CCD) sensors, and/or complementary metal-oxide-semiconductor (CMOS) sensors operable to obtain images of physical objects from the real-world environment. The one or more image sensors 206A, 206B also optionally include one or more infrared (IR) sensors, such as a passive or an active IR sensor, for detecting infrared light from the real-world environment. For example, an active IR sensor includes an IR emitter for emitting infrared light into the real-world environment. The one or more image sensors 206A, 206B also optionally include one or more cameras configured to capture movement of physical objects in the real-world environment. The one or more image sensors 206A, 206B also optionally include one or more depth sensors configured to detect the distance of physical objects from electronic device 201, 260. In some examples, information from one or more depth sensors can allow the device to identify and differentiate objects in the real-world environment from other objects in the real-world environment. In some examples, one or more depth sensors can allow the device to determine the texture and/or topography of objects in the real-world environment. In some examples, the one or more image sensors 206A or 206B are included in an electronic device different from the electronic devices 201 and/or 260. For example, the one or more image sensors 206A, 206B are in communication with the electronic device 201, 260, but are not integrated with the electronic device 201, 260 (e.g., within a housing of the electronic device 201, 260). Particularly, in some examples, the one or more cameras of the one or more image sensors 206A, 206B are integrated with and/or coupled to one or more separate devices from the electronic devices 201 and/or 260 (e.g., but are in communication with the electronic devices 201 and/or 260), such as one or more input and/or output devices (e.g., one or more speakers and/or one or more microphones, such as earphones or headphones) that include the one or more image sensors 206A, 206B. In some examples, electronic device 201 or electronic device 260 corresponds to a head-worn speaker (e.g., headphones or earbuds). In such instances, the electronic device 201 or the electronic device 260 is equipped with a subset of the other components illustrated in FIGS. 2A and 2B and described herein. In some such examples, the electronic device 201 or the electronic device 260 is equipped with one or more image sensors 206A, 206B, the one or more motion and/or orientations sensors 210A, 210B, and/or speakers 216A, 216B.

In some examples, electronic device 201, 260 uses CCD sensors, event cameras, and depth sensors in combination to detect the physical environment around electronic device 201, 260. In some examples, the one or more image sensors 206A, 206B include a first image sensor and a second image sensor. The first image sensor and the second image sensor work in tandem and are optionally configured to capture different information of physical objects in the real-world environment. In some examples, the first image sensor is a visible light image sensor, and the second image sensor is a depth sensor. In some examples, electronic device 201, 260 uses the one or more image sensors 206A, 206B to detect the position and orientation of electronic device 201, 260 and/or the one or more display generation components 214A, 214B in the real-world environment. For example, electronic device 201, 260 uses the one or more image sensors 206A, 206B to track the position and orientation of the one or more display generation components 214A, 214B relative to one or more fixed objects in the real-world environment.

In some examples, electronic devices 201 and 260 include one or more microphones 213A and 213B, respectively, or other audio sensors. Electronic device 201, 260 optionally uses the one or more microphones 213A, 213B to detect sound from the user and/or the real-world environment of the user. In some examples, the one or more microphones 213A, 213B include an array of microphones (e.g., a plurality of microphones) that optionally operate in tandem, such as to identify ambient noise or to locate the source of sound in space of the real-world environment.

Electronic devices 201 and 260 include one or more location sensors 204A and 204B, respectively, for detecting a location of electronic device 201 and/or the one or more display generation components 214A and a location of electronic device 260 and/or the one or more display generation components 214B, respectively. For example, the one or more location sensors 204A, 204B can include a global positioning system (GPS) receiver that receives data from one or more satellites and allows electronic device 201, 260 to determine the absolute position of the electronic device in the physical world.

Electronic devices 201 and 260 include one or more orientation sensors 210A and 210B, respectively, for detecting orientation and/or movement of electronic device 201 and/or the one or more display generation components 214A and orientation and/or movement of electronic device 260 and/or the one or more display generation components 214B, respectively. For example, electronic device 201, 260 uses the one or more orientation sensors 210A, 210B to track changes in the position and/or orientation of electronic device 201, 260 and/or the one or more display generation components 214A, 214B, such as with respect to physical objects in the real-world environment. The one or more orientation sensors 210A, 210B optionally include one or more gyroscopes and/or one or more accelerometers.

Electronic device 201 includes one or more hand tracking sensors 202 and/or one or more eye tracking sensors 212, in some examples. It is understood, that although referred to as hand tracking or eye tracking sensors, that electronic device 201 additionally or alternatively optionally includes one or more other body tracking sensors, such as one or more leg, one or more torso and/or one or more head tracking sensors. The one or more hand tracking sensors 202 are configured to track the position and/or location of one or more portions of the user's hands, and/or motions of one or more portions of the user's hands with respect to the three-dimensional environment, relative to the one or more display generation components 214A, and/or relative to another defined coordinate system. The one or more eye tracking sensors 212 are configured to track the position and movement of a user's gaze (e.g., a user's attention, including eyes, face, or head, more generally) with respect to the real-world or three-dimensional environment and/or relative to the one or more display generation components 214A. In some examples, the one or more hand tracking sensors 202 and/or the one or more eye tracking sensors 212 are implemented together with the one or more display generation components 214A. In some examples, the one or more hand tracking sensors 202 and/or the one or more eye tracking sensors 212 are implemented separate from the one or more display generation components 214A. In some examples, electronic device 201 alternatively does not include the one or more hand tracking sensors 202 and/or the one or more eye tracking sensors 212. In some such examples, the one or more display generation components 214A may be utilized by the electronic device 260 to provide a three-dimensional environment and the electronic device 260 may utilize input and other data gathered via the other one or more sensors (e.g., the one or more location sensors 204A, the one or more image sensors 206A, the one or more touch-sensitive surfaces 209A, the one or more motion and/or orientation sensors 210A, and/or the one or more microphones 213A or other audio sensors) of the electronic device 201 as input and data that is processed by the one or more processors 218B of the electronic device 260. Additionally or alternatively, electronic device 260 optionally does not include other components shown in FIG. 2B, such as the one or more location sensors 204B, the one or more image sensors 206B, the one or more touch-sensitive surfaces 209B, etc. In some such examples, the one or more display generation components 214A may be utilized by the electronic device 260 to provide a three-dimensional environment and the electronic device 260 may utilize input and other data gathered via the one or more motion and/or orientation sensors 210A (and/or the one or more microphones 213A) of the electronic device 201 as input.

In some examples, the one or more hand tracking sensors 202 (and/or other body tracking sensors, such as leg, torso and/or head tracking sensors) can use the one or more image sensors 206 (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, the one or more image sensors 206A are positioned relative to the user to define a field of view of the one or more image sensors 206A and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, the one or more eye tracking sensors 212 include at least one eye tracking camera (e.g., IR cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic devices 201 and 260 are not limited to the components and configuration of FIGS. 2A-2B, but can include fewer, other, or additional components in multiple configurations. In some examples, electronic device 201 and/or electronic device 260 can each be implemented between multiple electronic devices (e.g., as a system). In some such examples, each of (or more of) the electronic devices may include one or more of the same components discussed above, such as various sensors, one or more display generation components, one or more speakers, one or more processors, one or more memories, and/or communication circuitry. A person or persons using electronic device 201 and/or electronic device 260, is optionally referred to herein as a user or users of the device.

FIG. 2C illustrates a block diagram of an example architecture for a system 200 according to some examples of the disclosure. In some examples, system 200 includes multiple electronic devices. For example, in FIG. 2C, the system 200 includes a first electronic device 201A and a second electronic device 201B, wherein the first electronic device 201A and the second electronic device 201B are in communication with each other. In some examples, the first electronic device 201A and the second electronic device 201B correspond to and/or have one or more characteristics of the electronic device 201 described above with reference to FIG. 2A. In some examples, the first electronic device 201A and the second electronic device 201B correspond to electronic device 101 described above with reference to FIG. 1. For example, as shown in FIG. 2C, the first electronic device 201A optionally includes various sensors (e.g., the one or more hand tracking sensors 202A, the one or more location sensors 204A, the one or more image sensors 206A, the one or more touch-sensitive surfaces 209A, the one or more motion and/or orientation sensors 210A, the one or more eye tracking sensors 212A, the one or more microphones 213A or other audio sensors, the one or more body tracking sensors (e.g., torso and/or head tracking sensors), the one or more display generation components 214A, the one or more speakers 216A, the one or more processors 218A, the one or more memories 220A, and/or the communication circuitry 222A described above with reference to FIGS. 2A-2B. Similarly, in some examples, the second electronic device 201B optionally includes various sensors (e.g., one or more hand tracking sensors 202B, the one or more location sensors 204B, the one or more image sensors 206B, the one or more touch-sensitive surfaces 209B, the one or more motion and/or orientation sensors 210B, one or more eye tracking sensors 212B, the one or more microphones 213B or other audio sensors, one or more body tracking sensors (e.g., torso and/or head tracking sensors), the one or more display generation components 214B, one or more speakers 216B, the one or more processors 218B, the one or more memories 220B, and/or the communication circuitry 222B described above with reference to FIGS. 2A-2B. In some examples, the one or more hand tracking sensors 202B have one or more characteristics of the one or more hand tracking sensors 202A discussed above. In some examples, the one or more eye tracking sensors 212B have one or more characteristics of the one or more eye tracking sensors 212A. One or more communication buses 208A and 208B are optionally used for communication between the above-mentioned components of first electronic device 201A and second electronic device 201B, respectively. First electronic device 201A and second electronic device 201B optionally communicate via a wired or wireless connection (e.g., via the communication circuitry 222A, 222B) between the two electronic devices.

System 200 is not limited to the components and configuration of FIG. 2C, but can include fewer, other, or additional components and/or electronic devices in multiple configurations. In some examples, system 200 can be implemented in a single device. A person or persons using system 200, is optionally referred to herein as a user or users of the system and/or the devices or devices.

Attention is now directed towards exemplary concurrent displays of a three-dimensional environment on a first electronic device (e.g., corresponding to electronic device 260) and a second electronic device (e.g., corresponding to electronic device 270). As discussed below, the first electronic device may be in communication with the second electronic device in a multi-user communication session. In some examples, an avatar (e.g., a representation of) a user of the first electronic device may be displayed in the three-dimensional environment at the second electronic device, and an avatar of a user of the second electronic device may be displayed in the three-dimensional environment at the first electronic device. In some examples, the user of the first electronic device and the user of the second electronic device may be associated with a spatial group in the multi-user communication session.

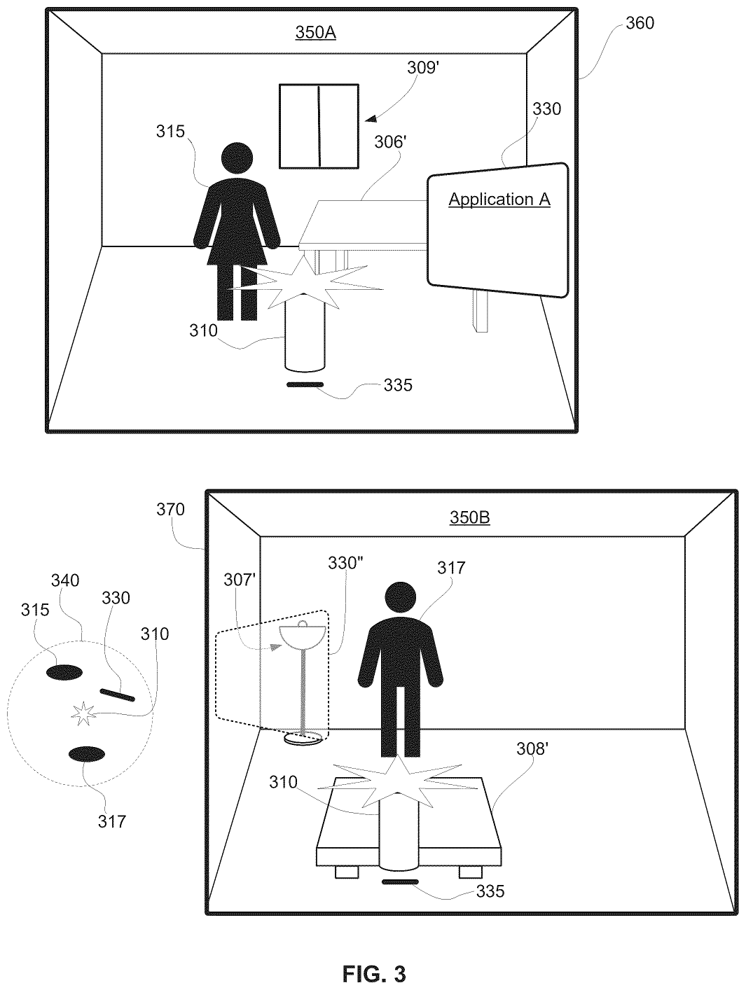

FIG. 3 illustrates an example of a spatial group 340 in a multi-user communication session that includes a first electronic device 360 and a second electronic device 370 according to some examples of the disclosure.

In some examples, the first electronic device 360 may present a three-dimensional environment 350A, and the second electronic device 370 may present a three-dimensional environment 350B. The first electronic device 360 and the second electronic device 370 may be similar to electronic device 101 or 201A/201B, and/or may be a head mountable system/device and/or projection-based system/device (including a hologram-based system/device) configured to generate and present a three-dimensional environment, such as, for example, heads-up displays (HUDs), head mounted displays (HMDs), windows having integrated display capability, displays formed as lenses designed to be placed on a person's eyes (e.g., similar to contact lenses), respectively. In the example of FIG. 3, a first user is optionally wearing the first electronic device 360 and a second user is optionally wearing the second electronic device 370, such that the three-dimensional environment 350A/350B can be defined by X, Y and Z axes as viewed from a perspective of the electronic devices (e.g., a viewpoint associated with the electronic device 360/370, which may be a head-mounted display, for example).

As shown in FIG. 3, the first electronic device 360 may be in a first physical environment that includes a table 306 and a window 309. Thus, the three-dimensional environment 350A presented using the first electronic device 360 optionally includes captured portions of the physical environment surrounding the first electronic device 360, such as a representation of the table 306′ and a representation of the window 309′. Similarly, the second electronic device 370 may be in a second physical environment, different from the first physical environment (e.g., separate from the first physical environment), that includes a floor lamp 307 and a coffee table 308. Thus, the three-dimensional environment 350B presented using the second electronic device 370 optionally includes captured portions of the physical environment surrounding the second electronic device 370, such as a representation of the floor lamp 307′ and a representation of the coffee table 308′. Additionally, the three-dimensional environments 350A and 350B may include representations of the floor, ceiling, and walls of the room in which the first electronic device 360 and the second electronic device 370, respectively, are located.

As mentioned above, in some examples, the first electronic device 360 is optionally in a multi-user communication session with the second electronic device 370. For example, the first electronic device 360 and the second electronic device 370 (e.g., via communication circuitry 222A/222B) are configured to present a shared three-dimensional environment 350A/350B that includes one or more shared virtual objects (e.g., content such as images, video, audio and the like, representations of user interfaces of applications, etc.). As used herein, the term “shared three-dimensional environment” refers to a three-dimensional environment that is independently presented, displayed, and/or visible at two or more electronic devices via which content, applications, data, and the like may be shared and/or presented to users of the two or more electronic devices. In some examples, while the first electronic device 360 is in the multi-user communication session with the second electronic device 370, an avatar corresponding to the user of one electronic device is optionally displayed in the three-dimensional environment that is displayed via the other electronic device. For example, as shown in FIG. 3, at the first electronic device 360, an avatar 315 corresponding to the user of the second electronic device 370 is displayed in the three-dimensional environment 350A. Similarly, at the second electronic device 370, an avatar 317 corresponding to the user of the first electronic device 360 is displayed in the three-dimensional environment 350B.

In some examples, the presentation of avatars 315/317 as part of a shared three-dimensional environment is optionally accompanied by an audio effect corresponding to a voice of the users of the electronic devices 370/360. For example, the avatar 315 displayed in the three-dimensional environment 350A using the first electronic device 360 is optionally accompanied by an audio effect corresponding to the voice of the user of the second electronic device 370. In some such examples, when the user of the second electronic device 370 speaks, the voice of the user may be detected by the second electronic device 370 (e.g., via the microphone(s) 213B) and transmitted to the first electronic device 360 (e.g., via the communication circuitry 222B/222A), such that the detected voice of the user of the second electronic device 370 may be presented as audio (e.g., using speaker(s) 216A) to the user of the first electronic device 360 in three-dimensional environment 350A. In some examples, the audio effect corresponding to the voice of the user of the second electronic device 370 may be spatialized such that it appears to the user of the first electronic device 360 to emanate from the location of avatar 315 in the shared three-dimensional environment 350A (e.g., despite being outputted from the speakers of the first electronic device 360). Similarly, the avatar 317 displayed in the three-dimensional environment 350B using the second electronic device 370 is optionally accompanied by an audio effect corresponding to the voice of the user of the first electronic device 360. In some such examples, when the user of the first electronic device 360 speaks, the voice of the user may be detected by the first electronic device 360 (e.g., via the microphone(s) 213A) and transmitted to the second electronic device 370 (e.g., via the communication circuitry 222A/222B), such that the detected voice of the user of the first electronic device 360 may be presented as audio (e.g., using speaker(s) 216B) to the user of the second electronic device 370 in three-dimensional environment 350B. In some examples, the audio effect corresponding to the voice of the user of the first electronic device 360 may be spatialized such that it appears to the user of the second electronic device 370 to emanate from the location of avatar 317 in the shared three-dimensional environment 350B (e.g., despite being outputted from the speakers of the first electronic device 360).

In some examples, while in the multi-user communication session, the avatars 315/317 are displayed in the three-dimensional environments 350A/350B with respective orientations that correspond to and/or are based on orientations of the electronic devices 360/370 (and/or the users of electronic devices 360/370) in the physical environments surrounding the electronic devices 360/370. For example, as shown in FIG. 3, in the three-dimensional environment 350A, the avatar 315 is optionally facing toward the viewpoint of the user of the first electronic device 360, and in the three-dimensional environment 350B, the avatar 317 is optionally facing toward the viewpoint of the user of the second electronic device 370. As a particular user moves the electronic device (and/or themself) in the physical environment, the viewpoint of the user changes in accordance with the movement, which may thus also change an orientation of the user's avatar in the three-dimensional environment. For example, with reference to FIG. 3, if the user of the first electronic device 360 were to look leftward in the three-dimensional environment 350A such that the first electronic device 360 is rotated (e.g., a corresponding amount) to the left (e.g., counterclockwise), the user of the second electronic device 370 would see the avatar 317 corresponding to the user of the first electronic device 360 rotate to the right (e.g., clockwise) relative to the viewpoint of the user of the second electronic device 370 in accordance with the movement of the first electronic device 360.

Additionally, in some examples, while in the multi-user communication session, a viewpoint of the three-dimensional environments 350A/350B and/or a location of the viewpoint of the three-dimensional environments 350A/350B optionally changes in accordance with movement of the electronic devices 360/370 (e.g., by the users of the electronic devices 360/370). For example, while in the communication session, if the first electronic device 360 is moved closer toward the representation of the table 306′ and/or the avatar 315 (e.g., because the user of the first electronic device 360 moved forward in the physical environment surrounding the first electronic device 360), the viewpoint of the three-dimensional environment 350A would change accordingly, such that the representation of the table 306′, the representation of the window 309′ and the avatar 315 appear larger in the field of view. In some examples, each user may independently interact with the three-dimensional environment 350A/350B, such that changes in viewpoints of the three-dimensional environment 350A and/or interactions with virtual objects in the three-dimensional environment 350A by the first electronic device 360 optionally do not affect what is shown in the three-dimensional environment 350B at the second electronic device 370, and vice versa.

In some examples, the avatars 315/317 are a representation (e.g., a full-body rendering) of the users of the electronic devices 370/360. In some examples, the avatar 315/317 is a representation of a portion (e.g., a rendering of a head, face, head and torso, etc.) of the users of the electronic devices 370/360. In some examples, the avatars 315/317 are a user-personalized, user-selected, and/or user-created representation displayed in the three-dimensional environments 350A/350B that is representative of the users of the electronic devices 370/360. It should be understood that, while the avatars 315/317 illustrated in FIG. 3 correspond to full-body representations of the users of the electronic devices 370/360, respectively, alternative avatars may be provided, such as those described above.

As mentioned above, while the first electronic device 360 and the second electronic device 370 are in the multi-user communication session, the three-dimensional environments 350A/350B may be a shared three-dimensional environment that is presented using the electronic devices 360/370. In some examples, content that is viewed by one user at one electronic device may be shared with another user at another electronic device in the multi-user communication session. In some such examples, the content may be experienced (e.g., viewed and/or interacted with) by both users (e.g., via their respective electronic devices) in the shared three-dimensional environment. For example, as shown in FIG. 3, the three-dimensional environments 350A/350B include a shared virtual object 310 (e.g., which is optionally a three-dimensional virtual sculpture) that is viewable by and interactive to both users. As shown in FIG. 3, the shared virtual object 310 may be displayed with a grabber affordance (e.g., a handlebar) 335 that is selectable to initiate movement of the shared virtual object 310 within the three-dimensional environments 350A/350B.

In some examples, the three-dimensional environments 350A/350B include unshared content that is private to one user in the multi-user communication session. For example, in FIG. 3, the first electronic device 360 is displaying a private application window 330 in the three-dimensional environment 350A, which is optionally an object that is not shared between the first electronic device 360 and the second electronic device 370 in the multi-user communication session. In some examples, the private application window 330 may be associated with a respective application that is operating on the first electronic device 360 (e.g., such as a media player application, a web browsing application, a messaging application, etc.). Because the private application window 330 is not shared with the second electronic device 370, the second electronic device 370 optionally displays a representation of the private application window 330″ in three-dimensional environment 350B. As shown in FIG. 3, in some examples, the representation of the private application window 330″ may be a faded, occluded, discolored, and/or translucent representation of the private application window 330 that prevents the user of the second electronic device 370 from viewing contents of the private application window 330.

As mentioned previously above, in some examples, the user of the first electronic device 360 and the user of the second electronic device 370 are in a spatial group 340 within the multi-user communication session. In some examples, the spatial group 340 may be a baseline (e.g., a first or default) spatial group within the multi-user communication session. For example, when the user of the first electronic device 360 and the user of the second electronic device 370 initially join the multi-user communication session, the user of the first electronic device 360 and the user of the second electronic device 370 are automatically (and initially, as discussed in more detail below) associated with (e.g., grouped into) the spatial group 340 within the multi-user communication session. In some examples, while the users are in the spatial group 340 as shown in FIG. 3, the user of the first electronic device 360 and the user of the second electronic device 370 have a first spatial arrangement (e.g., first spatial template) within the shared three-dimensional environment. For example, the user of the first electronic device 360 and the user of the second electronic device 370, including objects that are displayed in the shared three-dimensional environment, have spatial truth within the spatial group 340. In some examples, spatial truth requires a consistent spatial arrangement between users (or representations thereof) and virtual objects. For example, a distance between the viewpoint of the user of the first electronic device 360 and the avatar 315 corresponding to the user of the second electronic device 370 may be the same as a distance between the viewpoint of the user of the second electronic device 370 and the avatar 317 corresponding to the user of the first electronic device 360. As described herein, if the location of the viewpoint of the user of the first electronic device 360 moves, the avatar 317 corresponding to the user of the first electronic device 360 moves in the three-dimensional environment 350B in accordance with the movement of the location of the viewpoint of the user relative to the viewpoint of the user of the second electronic device 370. Additionally, if the user of the first electronic device 360 performs an interaction on the shared virtual object 310 (e.g., moves the virtual object 310 in the three-dimensional environment 350A), the second electronic device 370 alters display of the shared virtual object 310 in the three-dimensional environment 350B in accordance with the interaction (e.g., moves the virtual object 310 in the three-dimensional environment 350B).

It should be understood that, in some examples, more than two electronic devices may be communicatively linked in a multi-user communication session. For example, in a situation in which three electronic devices are communicatively linked in a multi-user communication session, a first electronic device would display two avatars, rather than just one avatar, corresponding to the users of the other two electronic devices. It should therefore be understood that the various processes and exemplary interactions described herein with reference to the first electronic device 360 and the second electronic device 370 in the multi-user communication session optionally apply to situations in which more than two electronic devices are communicatively linked in a multi-user communication session.

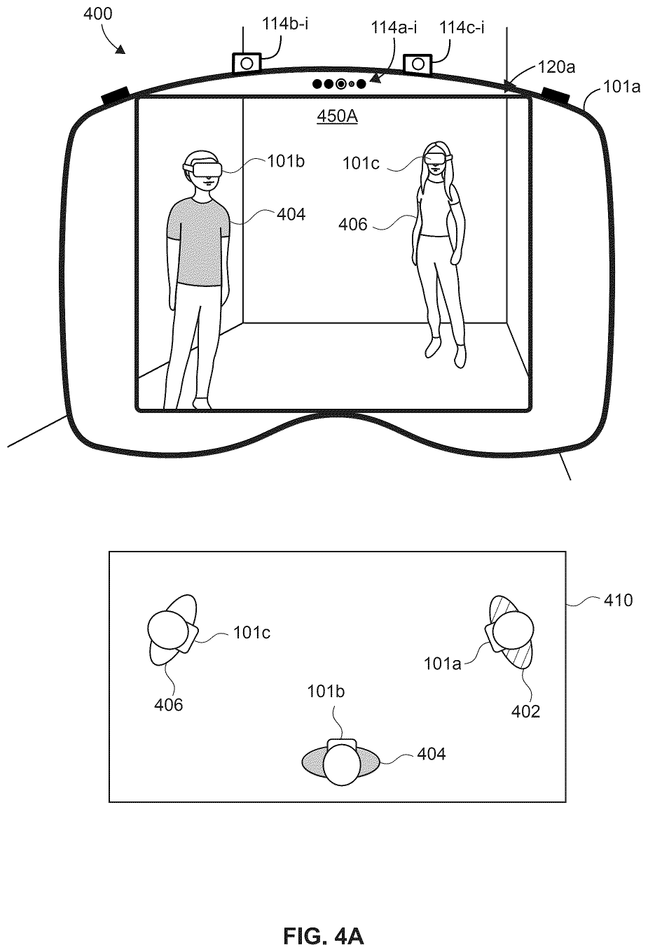

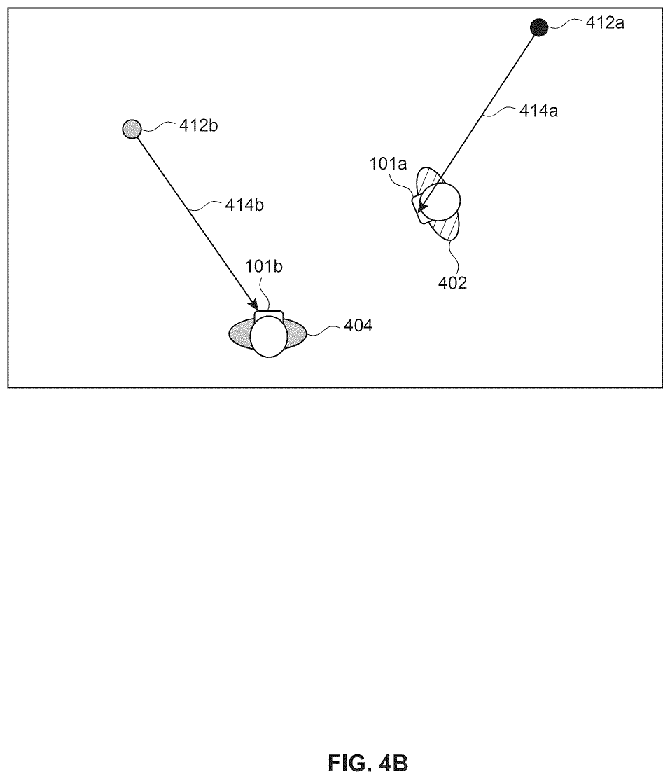

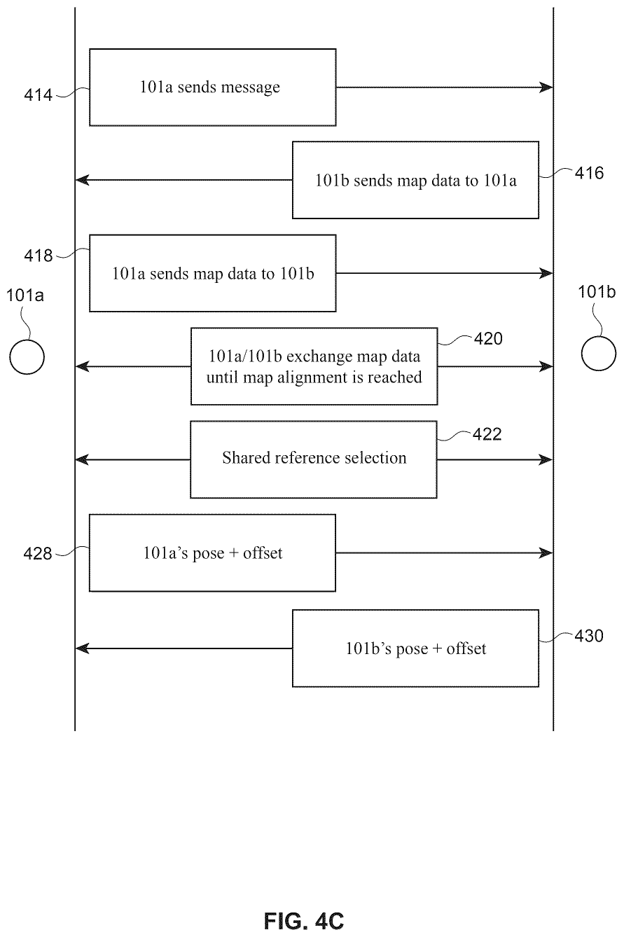

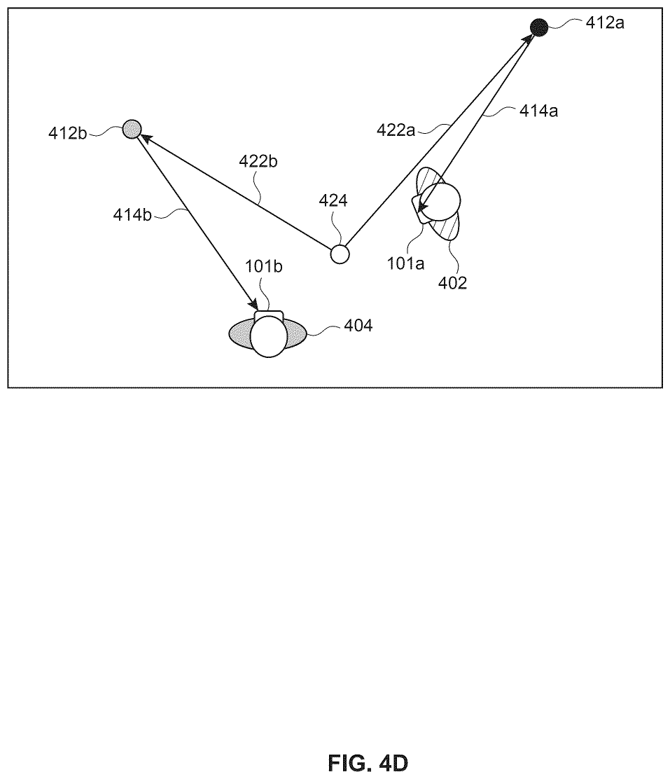

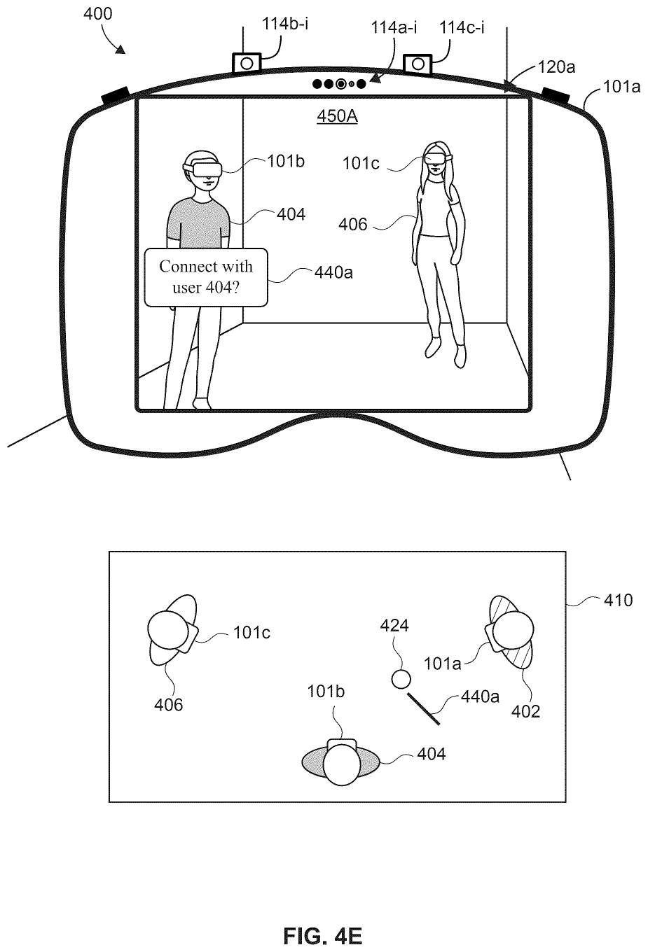

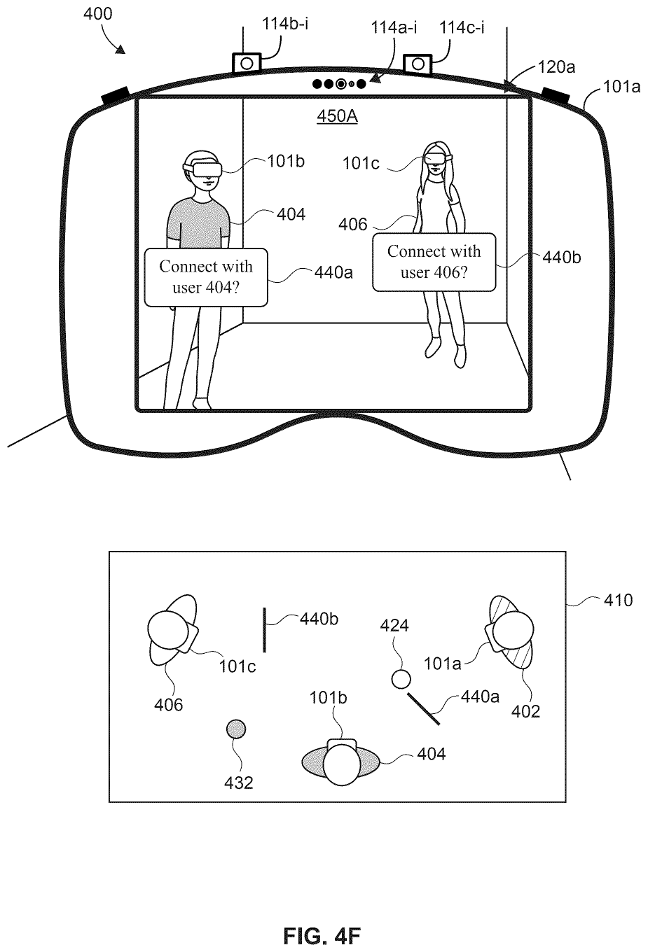

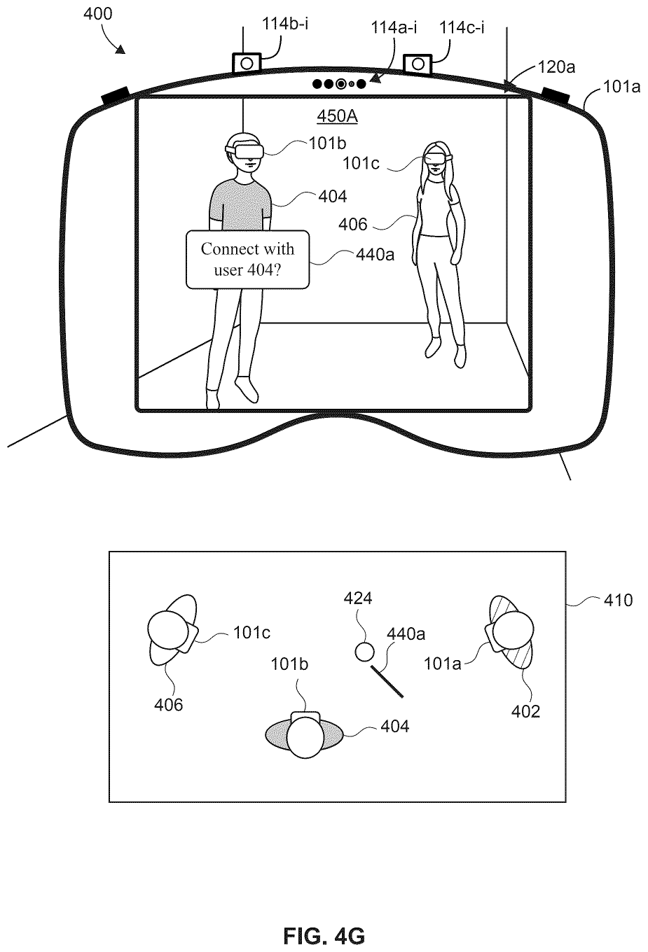

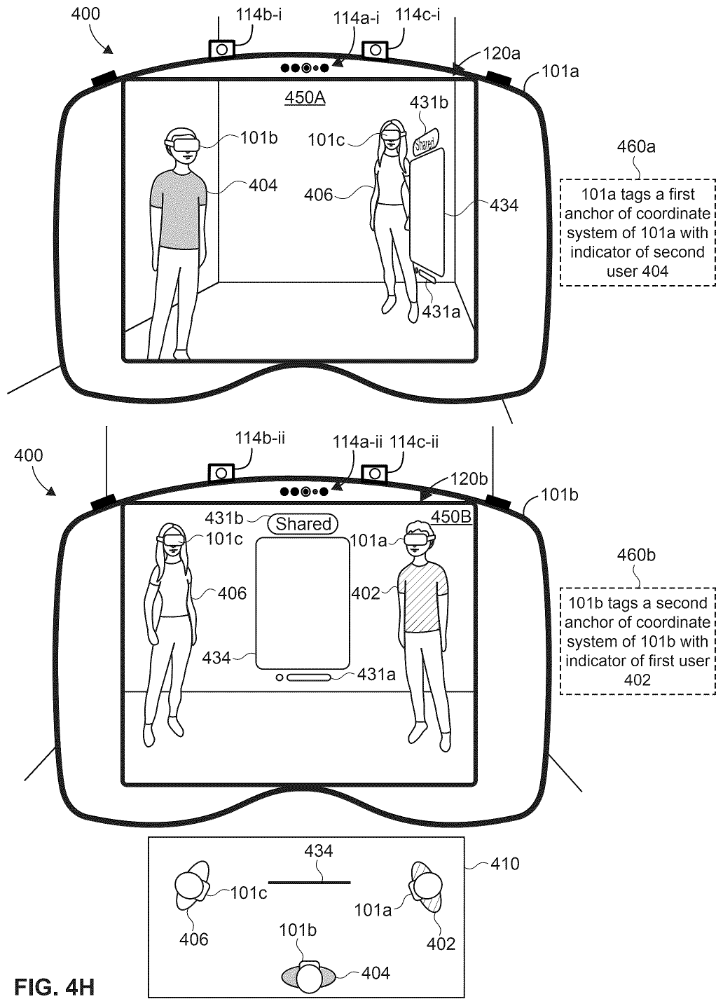

In some examples, it may be advantageous to provide mechanisms for facilitating a multi-user communication session that includes collocated users (e.g., collocated electronic devices associated with the users). For example, it may be desirable to enable users who are collocated in a first physical environment to establish a multi-user communication session, such that virtual content may be shared and presented in a three-dimensional environment that is optionally viewable by and/or interactive to the collocated users in the multi-user communication session. In some examples, as discussed below with reference to FIG. 4H, the presentation of virtual objects (e.g., avatars and shared virtual content) in the three-dimensional environment within a multi-user communication session that includes collocated users (e.g., relative to a first electronic device) is based on establishing a shared coordinate space/system based on at least the poses (e.g., positions and/or orientations) of the collocated users in a physical environment of the first electronic device. Particularly, unlike a multi-user communication session comprised of solely remote users (e.g., non-collocated users) in which a shared origin of the three-dimensional environment (e.g., according to which content is presented) is able to be determined/placed at any location relative to a first user's physical environment, a multi-user communication session that comprises solely collocated users may involve agreement and/or collaboration between the electronic devices on the placement of the shared origin of the three-dimensional environment.

In some examples, it may be advantageous to provide mechanisms for determining locations of collocated users (e.g., collocated electronic devices associated with the users) before a multi-user communication session is established between the collocated users. For example, it may be desirable to enable a user to select one or more collocated users for establishing a multi-user communication session. Further, it may be desirable to perform one or more operations relative to collocated electronic devices before establishing a multi-user communication session with the collocated electronic devices, such as operations directed to determining a location of the collocated users and/or displaying user interfaces and/or user interface elements that are selectable to establish a multi-user communication session.

In some examples, a first electronic device 101a performs a location tracking process to locate and/or track a location of the second electronic device 101b in response to a determination that the first electronic device 101a is collocated with the second electronic device 101b. In some examples, the second electronic device 101b performs a location tracking process to locate and/or track a location of the first electronic device 101a in response to a determination that the second electronic device 101b is collocated with the first electronic device 101a. In some examples, the location tracking process utilizes map data from the first electronic device 101a and map data from the second electronic device 101b. For example, the first electronic device may store Simultaneous Localization and Mapping (SLAM) map data determined (e.g., independently) by the first electronic device 101a and the second electronic device 101b may store SLAM map data determined (e.g., independently) by the second electronic device 101b. In some examples, the location tracking process is performed while a multi-user communication session between the first electronic device 101a and the second electronic device 101b has not been established.

FIGS. 4A-4G generally illustrate examples of a location tracking process being performed between a first electronic device 101a and a second electronic device 101b before a multi-user communication session is established between the first electronic device 101a and the second electronic device 101b according to some examples of the disclosure.

FIG. 4A shows the first electronic device 101a in the same physical environment 400 as the second electronic device 101b and a third electronic device 101c. In FIG. 4A, as illustrated in overhead view 410 (e.g., a top-down view), a first user 402 is wearing the first electronic device 101a, a second user 404 is wearing the second electronic device 101b, and a third user 406 is wearing the third electronic device 101c. Note that FIGS. 4A and 4E-4H include a respective overhead view 410, which is applicable to the respective figure in which it appears. In FIG. 4A, display 120a of the first electronic device 101a shows a first three-dimensional environment 450A that includes the second user 404 of the second electronic device 101b and the third user 406 of the third electronic device 101c. In some examples, the first electronic device 101a performs a location tracking process with the second electronic device 101b provided that the first electronic device 101a and the second electronic device 101b are collocated, such as described below. In some examples, the first electronic device 101a performs a location tracking process with the third electronic device 101c provided that the first electronic device 101a and third electronic device 101c are collocated, such as described below. Note that the location tracking process may be performed without specific user input requesting performance of the location tracking process. For example, as described above, the location tracking process between the first electronic device 101a and the second electronic device 101b may be performed in response to a determination of collocation between the first electronic device 101a and the second electronic device 101b.

In FIG. 4A, the first electronic device 101a and the second electronic device 101b are collocated in physical environment 400. In some examples, the first electronic device 101a and the second electronic device 101b are determined to be collocated because the first electronic device 101a and the second electronic device 101b are located in the same physical room. In some examples, were the first electronic device 101a and the second electronic device 101b not in the same physical room, it would be determined that the first electronic device 101a and the second electronic device 101b are not collocated.

In some examples, the determination that the first electronic device 101a and the second electronic device 101b are collocated in the physical environment 400 is based on a distance between the first electronic device 101a and the second electronic device 101b. For example, in FIG. 4A, the first electronic device 101a and the second electronic device 101b are collocated in the physical environment 400 because the first electronic device 101a is within a threshold distance (e.g., 0.1, 0.5, 1, 2, 3, 5, 10, 15, 20, etc. meters) of the second electronic device 101b. Were the first electronic device 101a and the second electronic device 101b not within the threshold distance, the first electronic device 101a and the second electronic device 101b may not be collocated.

In some examples, the determination that the first electronic device 101a and the second electronic device 101b are collocated in the physical environment 400 is based on communication between the first electronic device 101a and the second electronic device 101b. For example, in FIG. 4A, the first electronic device 101a and the second electronic device 101b may communicate (e.g., wirelessly, such as via BLUETOOTH, Wi-Fi, or a server (e.g., wireless communications terminal), with each other). For example, one or more signals transmitted by the first electronic device 101a may be detected by receptors at the second electronic device 101b, and/or one or more signals transmitted by the second electronic device 101b may be detected by receptors at the first electronic device 101a. Were no signal transmitted from the first electronic device 101a or detected by the second electronic device 101b, it may be determined that the first electronic device 101a and the second electronic device 101b are not collocated. Similarly, were no signal transmitted from the second electronic device 101b or detected by the first electronic device 101a, it may be determined that the first electronic device 101a and the second electronic device 101b are not collocated.

In some examples, the determination that the first electronic device 101a and the second electronic device 101b are collocated in the physical environment 400 is based on a strength of a wireless signal transmitted and detected between the first electronic device 101a and the second electronic device 101b. For example, in FIG. 4A, the first electronic device 101a and the second electronic device 101b are collocated in the physical environment 400 because a strength of a BLUETOOTH signal (or other wireless signal) transmitted and detected between the first electronic device 101a and the second electronic device 101b is greater than a threshold strength. For example, were the second electronic device 101b to detect a BLUETOOTH signal from the first electronic device 101a that is greater than a threshold signal strength, it may be determined that the first electronic device 101a and the second electronic device 101b are collocated. Similarly, were the first electronic device 101a to detect a BLUETOOTH signal from the second electronic device 101b that is greater than a threshold signal strength, it may be determined that the first electronic device 101a and the second electronic device 101b are collocated. Furthermore, were the second electronic device 101b to detect a BLUETOOTH signal from the first electronic device 101a that is less than the threshold signal strength, it may be determined that the first electronic device 101a and the second electronic device 101b are not collocated and/or that wireless transmission features or wireless reception features are turned off at the first electronic device 101a and/or the second electronic device 101b. Similarly, were the first electronic device 101a to detect a BLUETOOTH signal from the second electronic device 101b that is less than the threshold signal strength, it may be determined that the first electronic device 101a and the second electronic device 101b are not collocated and/or that wireless transmission features or wireless reception features are turned off at the second electronic device 101b and/or the first electronic device 101a.

In some examples, the determination of the collocation of the first electronic device 101a and the second electronic device 101b is based on the first electronic device 101a and the second electronic device 101b being connected to a same network (e.g., wireless network) in the physical environment 400. For example, were it determined that the first electronic device 101a and the second electronic device 101b are connected to the same wireless network, it may be determined that the first electronic device 101a and the second electronic device 101b are collocated. Continuing with this example, were it determined that the first electronic device 101a and the second electronic device 101b are not connected to the same wireless network, it may be determined that the first electronic device 101a and the second electronic device 101b are not collocated.

In some examples, the determination that the first electronic device 101a and the second electronic device 101b are collocated in the physical environment 400 is based on visual detection of the first electronic device 101a and the second electronic device 101b in the physical environment 400. For example, as shown in FIG. 4A, the second electronic device 101b is positioned in a field of view of the first electronic device 101a, which enables the first electronic device 101a to visually detect (e.g., identify or scan, such as via object detection/recognition or other image processing techniques) the second electronic device 101b (e.g., in one or more images captured by the first electronic device 101a, such as via external image sensors 114b-i and 114c-i). Additionally, were the first electronic device 101a in a field of view of the second electronic device 101b, it may be determined that the first electronic device 101a and the second electronic device 101b are collocated. Further, were the second electronic device 101b not in the field of view of the first electronic device 101a, it may be determined that the first electronic device 101a and the second electronic device 101b are not collocated. Similarly, were the first electronic device 101a not in the field of view of the second electronic device 101b, it may be determined that the first electronic device 101a and the second electronic device 101b are not collocated. Note that were the first electronic device 101a to detect the second electronic device 101b via image sensors of the first electronic device 101a, without the second electronic device 101b detecting the first electronic device 101a via image sensors of the second electronic device 101b, it may be determined that the first electronic device 101a and the second electronic device 101b are collocated. Similarly, note that were the second electronic device 101b to detect the first electronic device 101a via image sensors of the second electronic device 101b, without the first electronic device 101a detecting the second electronic device 101b via image sensors of the first electronic device 101a, it may be determined that the first electronic device 101a and the second electronic device 101b are collocated.

In some examples, the determination that the first electronic device 101a and the second electronic device 101b are collocated in physical environment 400 is based on the user of the other electronic device being in a contact list of the electronic device. For example, the first electronic device 101a and the second electronic device 101b may be collocated in physical environment 400 because the first user 402 of the first electronic device 101a is in a contact list on the second electronic device 101b (e.g., a contact list of an application accessible via the second electronic device 101b, such as a phone application, a contact list application, an email application, a communication application, or another type of application). Additionally or alternatively, as another example, the first electronic device 101a and the second electronic device 101b may be collocated in physical environment 400 because the second user 404 of the second electronic device 101b is in a contact list on the first electronic device 101a (e.g., a contact list of an application accessible via the first electronic device 101a, such as a phone application, a contact list application, an email application, a communication application, or another type of application). In some examples, were the user of the first electronic device 101a not in a contact list on the second electronic device 101b and/or were the user of the second electronic device 101b not in a contact list on the first electronic device 101a, it may be determined that the first electronic device 101a and the second electronic device 101b are not collocated in physical environment 400 even if they are in physical environment 400. Note that, in some examples, the first electronic device 101a and the second electronic device 101b may be determined to be collocated if the second user 404 of the second electronic device 101b is in the contact list on the first electronic device 101a, without the first user 402 being in a contact list on the second electronic device 101b. Note that, in some examples, the first electronic device 101a and the second electronic device 101b may be determined to not be collocated if the second user 404 of the second electronic device 101b is in the contact list on the first electronic device 101a, without the first user 402 being in a contact list on the second electronic device 101b.

Note that in FIG. 4A, it may be determined that the first electronic device 101a and the third electronic device 101c are collocated (or non-collocated) in physical environment 400, such as described above with reference to the determination that the first electronic device 101a and the second electronic device 101b are collocated (or non-collocated) in physical environment 400. Note that in FIG. 4A, a distance between the first electronic device 101a and third electronic device 101c is greater than a distance between the first electronic device 101a and the second electronic device 101b. In some examples, the distance is greater than a threshold distance such that is it determined that the first electronic device 101a and the third electronic device 101c are not collocated in the physical environment 400. In some examples, were the distance between the first electronic device 101a and the third electronic device 101c the same as the distance between the first electronic device 101a and the second electronic device 101b, it could still be determined that the first electronic device 101a and the third electronic device 101c are not collocated in physical environment 400. For example, as described above, collocation may be further based on users of electronic devices being in a contact list of the other electronic device, and were the user of the third electronic device 101c not in the contact list of the first electronic device 101a, it may be determined that the first electronic device 101a and the third electronic device 101c are not collocated in physical environment 400.

FIG. 4B shows an example of the pose (e.g., position and/or orientation) of first electronic device 101a and the pose (e.g., position and/or orientation) of the second electronic device 101b based on their respective reference origins (e.g., respective reference positions and orientations). In FIG. 4B, first electronic device 101a has a first reference origin 412a (e.g., a first reference location) by which its own pose (e.g., position and/or orientation) is determined. For example, the first reference origin 412a of the first electronic device 101a may be used by the first electronic device 101a to determine how it is positioned and/or oriented in physical environment 400, and may be used to determine how to present virtual content at the first electronic device 101a (e.g., virtual content that is private (e.g., not shared) to the first electronic device 101a)). For example, using the pose (e.g., position and/or orientation) of the first electronic device 101a, which is relative to the first reference origin 412a of the first electronic device 101a, the first electronic device 101a may display content at particular locations and/or may present spatialized audio at different locations relative to the current location of the first electronic device 101a based on its pose (e.g., position and/or orientation) relative to the first reference origin 412a of the first electronic device 101a. As such, the first electronic device 101a may present virtual content relative to the first reference origin 412a, enabling the first electronic device 101a to preserve spatial truth when interacting with the virtual content in the physical environment 400. In some examples, the first reference origin 412a of the first electronic device 101a was determined by the first electronic device 101a before a location tracking process between the first electronic device 101a and the second electronic device 101b is initiated. In some examples, the first reference origin 412a of the first electronic device 101a was determined by the first electronic device 101a before it was determined that the first electronic device 101a is collocated with the second electronic device 101b. For example, the first electronic device 101a may determine the first reference origin 412a in the physical environment 400 upon first use and/or powering on of the first electronic device 101a (e.g., by the first user 402) in the physical environment 400.

In FIG. 4B, illustratively, a vector 414a (e.g., an arrow) extends from the first reference origin 412a to the current location of the first electronic device 101a, and is indicative of the first pose (e.g., position and/or orientation) of the first electronic device 101a. For example, the vector 414a may be based on a Cartesian coordinate system and/or another coordinate system. In addition, an orientation (e.g., an angular orientation) of the first electronic device 101a at its current location may also be tracked and included in the pose information of the first electronic device 101a that is relative to the first reference origin 412a. As such, in some examples, vector 414a is representative of a position of the first electronic device 101a relative to the first reference origin 412a and of an orientation of the first electronic device 101a relative to an orientation of the first reference origin 412a. The pose (e.g., position and/or orientation) of the first electronic device 101a may follow Expression 1:

$$first pose = pose of first electronic device relative to first reference origin$$

Further, in FIG. 4B, the second electronic device 101b has a second reference origin 412b (e.g., second reference location) by which its own pose (e.g., position and/or orientation) is determined. For example, the second reference origin 412b of the second electronic device 101b may be used to determine how the second electronic device 101b is positioned and/or oriented in physical environment 400, and may be used by the second electronic device 101b to determine how to present virtual content at the second electronic device 101b (e.g., virtual content that is private (e.g., not shared) to the second electronic device 101b)). For example, using the pose (e.g., position and/or orientation) of the second electronic device 101b, which is relative to the second reference origin 412b of the second electronic device 101b, the second electronic device 101b may display content at particular locations and/or may present spatialized audio at different locations relative to the current location of the second electronic device 101b based on its pose (e.g., position and/or orientation) relative to the second reference origin 412b of the second electronic device 101b. As such, the second electronic device 101b may present virtual content relative to the second reference origin 412b, enabling the second electronic device 101b to preserve spatial truth when interacting with the virtual content in the physical environment 400. In some examples, the second reference origin 412b of the second electronic device 101b is determined by the second electronic device 101b before a location tracking process between the first electronic device 101a and the second electronic device 101b is initiated. In some examples, the second reference origin 412b of the second electronic device 101b was determined by the second electronic device 101b before it was determined that the first electronic device 101a is collocated with the second electronic device 101b. For example, the second electronic device 101b may determine the second reference origin 412b in the physical environment 400 upon first use and/or powering on of the second electronic device 101b (e.g., by the user 404) in the physical environment 400.

In FIG. 4B, illustratively, a vector 414b (e.g., an arrow) extends from the second reference origin 412b to the current location of the second electronic device 101b. For example, the vector 414b may be based on a Cartesian coordinate system and/or another coordinate system. In addition, an orientation (e.g., an angular orientation) of the second electronic device 101b at its current location may also be tracked and included in the pose information of the second electronic device 101b that is relative to the second reference origin 412b. As such, in some examples, vector 414b is representative of a position of the second electronic device 101b relative to the second reference origin 412b and of an orientation of the first electronic device 101a relative to an orientation of the second reference origin 412b. The pose (e.g., position and/or orientation) of the second electronic device 101b may follow Expression 2:

$$second pose = pose of second electronic device relative to second reference origin$$

Note that in FIG. 4B, vector 414a is private to the first electronic device 101a and vector 414b is private to the second electronic device 101b; as such, in FIG. 4B, vector 414a may not be shared to the second electronic device 101b and vector 414b may not be shared to the second electronic device 101b. For example, in FIG. 4B, the first electronic device 101a may not be sharing data indicative of its pose (e.g., position and/or orientation) to the second electronic device 101b and the second electronic device 101b may not be sharing data indicative of its pose (e.g., position and/or orientation) to the first electronic device 101a.

In some examples, the first reference origin 412a is shared to the second electronic device 101b (e.g., data indicative of the first reference origin 412a is shared to the second electronic device 101b). In some examples, the second reference origin 412b is shared to the first electronic device 101a (e.g., data indicative of the second reference origin 412b is shared to the first electronic device 101a). In some examples, the first reference origin 412a is shared to the second electronic device 101b, without sharing of the first pose (e.g., Expression 1, vector 414a) of the first electronic device 101a to the second electronic device 101b. In some examples, the second reference origin 412b is shared to the first electronic device 101a, without sharing of the second pose (e.g., Expression 2, vector 414b) of the second electronic device 101b to the first electronic device 101a. As such, in some examples, the first electronic device 101a advertises (e.g., wireless transmits data indicative of) the first reference origin 412a and/or the second electronic device 101b advertises (e.g., wireless transmits data indicative of) the second reference origin 412b.

FIG. 4C is an example flow diagram showing communications between the first electronic device 101a and the second electronic device 101b that may occur in response to the determination that the first electronic device 101a is collocated the second electronic device 101b. Note that the operations illustrated in FIG. 4C may be performed before a multi-user communication session between the first electronic device 101a and the second electronic device 101b is established (e.g., as described in more detail below). The operations illustrated in FIG. 4C include transmission of data between the first electronic device 101a and the second electronic device 101b. As such, data may be transmitted from the first electronic device 101a to the second electronic device 101b and/or from the second electronic device 101b to the first electronic device 101a before a multi-user communication session is established between the first electronic device 101a and the second electronic device 101b. For example, the first electronic device 101a may advertise first information via BLUETOOTH or another wireless protocol, such as the information associated with block 428 of FIG. 4C described below, and the second electronic device 101b may detect the first information, without a multi-user communication session between the first electronic device 101a and the second electronic device 101b established. Similarly, the second electronic device 101b may advertise second information via BLUETOOTH or another wireless protocol, such as the information associated with block 430 of FIG. 4C, and the first electronic device 101a may detect the second information, without a multi-user communication session between the first electronic device 101a and the second electronic device 101b established.

Furthermore, the first electronic device 101a and the second electronic device 101b may not have accepted a request to join or initiate a multi-user communication session with each other while one or more or all the operations of FIG. 4C are being performed. For example, the first electronic device 101a and the second electronic device 101b may not be presenting or displaying content that is being shared from the other electronic device because initiation of a multi-user communication session has not been accepted or the multi-user communication session has not been established between the first electronic device 101a and the second electronic device 101b while the operations of FIG. 4C are being performed. Further, in some examples, the illustrated operations of FIG. 4C may be performed by the first electronic device 101a and/or the second electronic device 101b without specific input from the first user 402 of the first electronic device 101a or the second user 404 of the second electronic device 101b that requests performance of the operations illustrated in FIG. 4C. Note that, in some examples, the illustrated operations of FIG. 4C are performed in the illustrated order. Note that, alternatively, in some examples, the illustrated operations of FIG. 4C are performed in a different order than the illustrated order.

At block 414, the first electronic device 101a transmits a message (e.g., a wireless signal such as via a BLUETOOTH communication) to the second electronic device 101b. In some examples, the message corresponds to a request for the second electronic device 101b to transmit map data to the first electronic device 101a. In some examples, the transmission of the message initiates the location tracking process between the first electronic device 101a and the second electronic device 101b. In some examples, before transmitting the message, a determination is made that the first electronic device is collocated with the second electronic device 101b, and the first electronic device 101a transmits the message in accordance with the determination. In some examples, were it determined that the first electronic device 101a and the second electronic device 101b are not collocated in physical environment 400, the first electronic device 101a may not transmit the message illustrated at block 414 to the second electronic device 101b.

In FIG. 4C, the second electronic device 101b detects the message from the first electronic device 101a, and responds by transmitting to the first electronic device 101a map data determined by second electronic device 101b (block 416). For example, in physical environment 400, the second electronic device 101b may detect image data via one or more external sensors of the second electronic device 101b and may use the image data to determine a mapping of the physical environment 400 (e.g., locations of walls, floors, objects in the room, etc.) relative to a viewpoint of the second electronic device 101b. The map data that the second electronic device 101b transmits to the first electronic device 101a may be based on such data. In some examples, the map data transmitted by the second electronic device 101b is SLAM data determined by the second electronic device 101b.

Further, as shown in FIG. 4C, the first electronic device 101a transmits its map data to the second electronic device 101b (block 418). For example, in physical environment 400, the first electronic device 101a may detect image data via one or more external sensors of the first electronic device 101a and may use the image data to determine a mapping of the physical environment 400 relative to a viewpoint of the first electronic device 101a. The map data that the first electronic device 101a transmits to the second electronic device 101b may be based on such data. In some examples, the map data transmitted by the first electronic device 101a is SLAM data determined (e.g., independently) by the first electronic device 101a. Note that the transmissions of data described with reference to FIG. 4C may be bits of data that are indicative of map data, are encrypted data, and/or may be decrypted by the recipient electronic device of the transmission.

In some examples, the first electronic device 101a processes its map data and the map data that the second electronic device 101b transmits to it. In some examples, the second electronic device 101b processes its map data and the map data that the first electronic device 101a transmits to it. In some examples, the first electronic device 101a receives map data from the second electronic device 101b without transmitting its map data to the second electronic device 101b. In some examples, the second electronic device 101b receives map data from the first electronic device 101a without transmitting its map data to the first electronic device 101a.

As shown in FIG. 4C, the first electronic device 101a and the second electronic device 101b may continue transmitting map data until alignment of map data is determined at either or both the first electronic device 101a and the second electronic device 101b (e.g., block 420). The map data of the first electronic device 101a and of the second electronic device 101b are processed (e.g., by the first electronic device 101a and/or the second electronic device 101b) until merging of the map data is complete. For example, the first electronic device 101a and the second electronic device 101b may continuously send their respective map data to each other until the map data is aligned, respectively. Additionally, in some examples, operations involved in block 420 may account for changes in the poses (e.g., positions and/or orientations) of the first electronic device 101a and/or the second electronic device 101b. For example, were one of the users (e.g., user 402 or user 404) to move, thereby causing the viewpoint of one of the electronic devices to change, the operations involved in block 420 may include transmission of map data that is determined at the transmitting electronic device based on the updated viewpoint of the transmitting electronic device (e.g., of the first electronic device 101a or the second electronic device 101b).

In some examples, in response to the merging of the map data (e.g., in accordance with a determination that the map data is aligned), the first electronic device 101a or the second electronic device 101b selects (block 422) a reference origin to serve as a shared reference origin (e.g., a shared reference location) of the location tracking process between the first electronic device 101a and the second electronic device 101b, such as shared reference origin 424 (e.g., shared reference location) in FIG. 4D. The shared reference origin 424 may be used as an origin for the first electronic device 101a tracking a location of the second electronic device 101b, for the second electronic device 101b tracking a location of the first electronic device 101a, and/or for other operations performed at either electronic device that may include, as an input, a location of the other electronic device. In some examples, the first electronic device 101a makes the selection. In some examples, the second electronic device 101b makes the selection. In some examples, which electronic device makes the selection is arbitrary. In some examples, which electronic device makes the selection is not arbitrary (e.g., the electronic device that performs the operations associated with block 414 makes the selection).

In some examples, the shared reference origin 424 is selected from a plurality of potential reference locations. In some examples, in response to the processing (e.g., comparison) of the map data of the first electronic device 101a and of the second electronic device 101b, a plurality of potential reference locations of the location tracking process is obtained. In some examples, in response to the comparison of the map data of the first electronic device 101a and of the second electronic device 101b, solely one potential reference location of the location tracking process between the first electronic device 101a and the second electronic device 101b is obtained. In some examples, the first electronic device 101a or the second electronic device 101b selects a potential reference location to be the shared reference origin of the location tracking process between the first electronic device 101a and the second electronic device 101b, such as shared reference origin 424 in FIG. 4D. In some examples, the first electronic device 101a makes the selection. In some examples, the second electronic device 101b makes the selection. In some examples, which electronic device makes the selection is not arbitrary (e.g., the electronic device that performs the operations associated with block 414 makes the selection).

In some examples, in response to the selection of the shared reference origin 424, the electronic device that made the selection transmits a message that notifies of the selection to the other electronic device. For example, were the first electronic device 101a to make the selection, the first electronic device 101a may transmit a message indicating the shared reference origin 424 to the second electronic device 101b, and were the second electronic device 101b to make the selection, the second electronic device 101b may transmit a message indicating the shared reference origin 424 to the first electronic device 101a. In some examples, the shared reference origin 424 is in between a location of the first electronic device 101a and a location of the second electronic device 101b (e.g., from the viewpoint of the first electronic device 101a and/or the second electronic device 101b). Note that, in some examples, the communications between the first electronic device 101a and the second electronic device 101b in the location tracking process between the first electronic device 101a and the second electronic device 101b are BLUETOOTH-based communications, and/or are another wireless signal-based communication protocol.

Note that the first electronic device 101a may determine the position and orientation of the shared reference origin 424 relative to the first reference origin 412a of the first electronic device 101a, such as at block 422 in FIG. 4C. In some examples, in response to determining the shared reference origin 424 between the first electronic device 101a and the second electronic device 101b, the first electronic device 101a determines a first offset (e.g., a displacement) between the shared reference origin 424 and the first reference origin 412a of the first electronic device 101a, such as illustratively shown by the first offset vector 422a (e.g., first offset arrow) in FIG. 4D. Note that first offset vector 422a in FIG. 4D is indicative of a positional offset and of an orientational (e.g., directional) offset between the position and orientation of the shared reference origin 424 and the position and orientation of the first reference origin 412a. For example, the origin indicated by the first reference origin 412a of the first electronic device 101a may not be aligned positionally and/or orientationally with the origin indicated by the shared reference origin 424. The first offset vector 414a in FIG. 4D between the shared reference origin 424 and the first reference origin 412a of the first electronic device 101a may follow Expression 3:

$$first offset vector = first reference origin - shared reference origin$$

In some examples, the first electronic device 101a transmits data indicative of the first offset vector 414a and data indicative of the first pose (e.g., position and/or orientation) to the second electronic device 101b, such as shown with block 428 of FIG. 4C. In some examples, the data also includes an identification of the shared reference origin 424 and of the first electronic device 101a. Note that the location data (e.g., the first offset vector 414a and/or the first pose) may be encrypted; thus, an encryption key may be exchanged between the first electronic device 101a and the second electronic device 101b. Having the data indicative of the first offset vector 414a and data indicative of the first pose (e.g., position and/or orientation) to the second electronic device 101b, the second electronic device 101a may determine the pose (e.g., position and/or orientation) of the first electronic device 101a relative to the shared reference origin 424 using Expression 4, which is as follows:

$$location of first electronic device relative to shared reference origin = location of first electronic device relative to the first reference origin - the first offset vector$$

Expression 4 may also be expressed as:

$$Expression 4 = Expression 1 - Expression 3$$

The second electronic device 101b may calculate Expression 4 in response to receiving data indicative of Expression 1 and data indicative of Expression 3 from the first electronic device 101a to determine the location of the first electronic device 101a relative to the shared reference origin 424 (e.g., relative to the second electronic device 101b's understanding of where shared reference origin 424 is located, such as the determination made at block 422 in FIG. 4C). Thus, the first electronic device 101a may transmit the first offset and its pose (e.g., the first pose indicated by vector 414a in FIG. 4D), which is relative to the first reference origin 412a, without transmitting its pose (e.g., position and/or orientation) relative to a different location (e.g., a different origin), and the second electronic device 101b may calculate Expression 4 to determine the location of the first electronic device 101a relative to the shared reference origin 424, the location of which the second electronic device 101b already knows in its local coordinate system.

Note that the second electronic device 101b may determine the position and orientation of the shared reference origin 424 relative to the second reference origin 412b of the second electronic device 101b, such as at block 422 in FIG. 4C. In some examples, in response to determining the shared reference origin 424 between the first electronic device 101a and the second electronic device 101b, the second electronic device 101b determines a second offset (e.g., a displacement) between the shared reference origin 424 and the second reference origin 412b of the second electronic device 101b, such as illustratively shown by the second offset vector 422b (e.g., second offset arrow) in FIG. 4D. Note that second offset vector 422b in FIG. 4D is indicative of a positional offset and of an orientational (e.g., directional) offset between the position and orientation of the shared reference origin 424 and the position and orientation of the second reference origin 412b. For example, the origin indicated by the second reference origin 412b of the second electronic device 101b may not be aligned positionally and/or orientationally with the origin indicated by the shared reference origin 424. The second offset vector 422b in FIG. 4D between the shared reference origin 424 and the second reference origin 412b of the second electronic device 101b may follow Expression 5:

$$second offset vector = second reference origin - shared reference origin$$

In some examples, the second electronic device 101b transmits data indicative of the second offset vector 414b and data indicative of the second pose (e.g., position and/or orientation) to the first electronic device 101a, such as shown with block 430 of FIG. 4C. In some examples, the data also includes an identification of the shared reference origin 424 and of the second electronic device 101b. Note that the location data (e.g., the second offset vector 414b and/or the second pose) may be encrypted; thus, an encryption key may be exchanged between the first electronic device 101a and the second electronic device 101b. Having the data indicative of the second offset vector 414b and data indicative of the second pose (e.g., position and/or orientation) of the second electronic device 101b, the first electronic device 101a may determine the pose (e.g., position and/or orientation) of the second electronic device 101b relative to the shared reference origin 424 using Expression 6, which is as follows:

$$location of second electronic device relative to the shared reference origin = location of second electronic device relative to the second reference origin - the second offset vector$$

Expression 6 may also be expressed as:

$$Expression 6 = Expression 2 - Expression 4$$

The first electronic device 101a may calculate Expression 6 in response to receiving data indicative of Expression 2 and data indicative of Expression 4 from the second electronic device 101b to determine the location of the second electronic device 101b relative to shared reference origin 424 (e.g., relative to the first electronic device 101a's understanding of where shared reference origin 424 is located, such as the determination made at block 422 in FIG. 4C). Thus, the second electronic device 101b may transmit the second offset and its pose (e.g., the second pose indicated by vector 414b in FIG. 4D), which is relative to the second reference origin 412b, without transmitting its pose (e.g., position and/or orientation) relative to a different location (e.g., different origin), and the second electronic device 101b may calculate Expression 6 to determine the location of the first electronic device 101a relative to the shared reference origin 424, the location of which the first electronic device 101a already knows in its local coordinate system.

As such, the first electronic device 101a may transmit to the second electronic device 101b data indicative of the first pose (e.g., in accordance with Expression 1) and of the first offset vector (e.g., in accordance with Expression 3), and the second electronic device 101b may determine the location of the first electronic device 101a using the data in accordance with Expression 4. Similarly, the second electronic device 101b may transmit to the first electronic device 101a data indicative of the second pose (e.g., in accordance with Expression 2) and of the second offset vector (e.g., in accordance with Expression 4), and the second electronic device 101b may determine the location of the first electronic device 101a using the data in accordance with Expression 6.

Having determined Expression 6 before a multi-user communication session between the first electronic device 101a and the second electronic device 101b has been established (e.g., before either electronic device has accepted a request to establish a multi-user communication session with the other electronic device), the first electronic device 101a may use such information in different ways. For example, the first electronic device 101a may display a user interface element that is selectable to establish a multi-user communication session between the first electronic device 101a and the second electronic device 101b, such as user interface element 440a in FIG. 4E, based on where the first electronic device 101a has determined the second electronic device 101b to be located. For example, were the second electronic device 101b in the field of view of the user of the first electronic device 101a, the first electronic device 101a would display user interface element 440a at a location that is based on the location of the second electronic device 101b that is in the field of view of the user of the first electronic device 101a. Continuing with this example, were the second electronic device 101b not in the field of view of the user of the first electronic device 101a, the second electronic device 101b may not display user interface element 440a. In addition, the first electronic device 101a may display user interface element 440a facing the user of the first electronic device 101a such that, were the first electronic device 101a to move about the location of second electronic device 101b, user interface element 440a may move (e.g., rotate about the location of the second electronic device 101b) in accordance with the movement of the first electronic device 101a about the location of the second electronic device 101b. In some examples, the user interface element 440a includes one or more regions selectable to perform different operations, such as a first region selectable to establish the multi-user communication session (e.g., selectable to share content for presentation with the second electronic device 101b), and a second region, different from the first region, selectable to cease display of the user interface element 440a without establishing the multi-user communication session.

FIG. 4F illustrates an example of the first electronic device 101a concurrently displaying the user interface element 440a, which is selectable to establish a multi-user communication session between the first electronic device 101a and the second electronic device 101b, and a user interface element 440b, which is selectable to establish a multi-user communication session between the first electronic device 101a and the third electronic device 101c. For example, the first electronic device 101a and the third electronic device 101c may have been determined to be collocated in physical environment 400, and the operations performed between the first electronic device 101a and the second electronic device 101b may have also been performed between the first electronic device 101a and the third electronic device 101c. For example, the operations described with reference to the first electronic device 101a and the second electronic device 101b in FIG. 4C may, independently, be performed between the first electronic device 101a and third electronic device 101c. As such, the first electronic device 101a may maintain the shared reference origin 424 between the first electronic device 101a and the second electronic device 101b, and may maintain a shared reference location 432 (e.g., a shared reference origin) between the first electronic device 101a and the third electronic device 101c. Thus, in some examples, the first electronic device 101a may display multiple user interface elements selectable to establish a multi-user communication session with different electronic devices based on the respective shared reference locations determined between the respective electronic devices. Further, the first electronic device 101a may understand the location of the second electronic device 101b relative to shared reference origin 424 (e.g., according to Expression 6) and may understand the location of the third electronic device 101c relative to shared reference location 432 of user interface element 440b in FIG. 4F.

Returning again to the location tracking process between the first electronic device 101a and the second electronic device 101b, having determined Expression 5 before a multi-user communication session between the first electronic device 101a and the second electronic device 101b has been established (e.g., before either electronic device has accepted a request to establish a multi-user communication session with the other electronic device), the second electronic device 101b may use such information in different ways. For example, the second electronic device 101b may display a user interface element that is selectable to establish a multi-user communication session between the first electronic device 101a and the second electronic device 101b, such as user interface element 440a in FIG. 4E, but based on where the second electronic device 101b has determined the first electronic device 101a to be located, such as described above with reference to the second electronic device 101b being in the field of view of the user of the first electronic device 101a.

Note that, in some examples, solely the first electronic device 101a displays the user interface element 440a or the second electronic device 101b displays a user interface element selectable (e.g., similar to user interface element 440a) to initiate the multi-user communication session between the first electronic device 101a and the second electronic device 101b. Also, note that the user interface element 440a is not being shared from the first electronic device 101a to the second electronic device 101b. For example, the user interface element 440a may not be visible to the second electronic device 101b (e.g., is not being displayed by the second electronic device 101b); however, the second electronic device 101b may display a user interface element that is selectable to establish a multi-user communication session between the first electronic device 101a and the second electronic device 101b, such as described with reference to display of user interface element 440a. Note that, while the user interface element 440a is being displayed, a multi-user communication session between the first electronic device 101a and the second electronic device 101b has not been established. For example, visual and/or audio content is not being shared between the first electronic device 101a and the second electronic device 101b while the user interface element is being displayed and/or while the location tracking process between the first electronic device 101a and the second electronic device 101b is being performed.

In some examples, the first electronic device 101a displays the user interface element in between the location of the first electronic device 101a and the location of the second electronic device 101b from the perspective of the user of the first electronic device 101a, such as the location of user interface element 440a in FIG. 4E. In some examples, the first electronic device 101a displays the user interface element at a midpoint between the between the location of the first electronic device 101a and the location of the second electronic device 101b. In some examples, the first electronic device 101a displays the user interface element closer to the location of the first electronic device 101a than to the location of the second electronic device 101b from the viewpoint of the first electronic device 101a. In some examples, the first electronic device 101a displays the user interface element closer to the location of the second electronic device 101b than to the location of the first electronic device 101a from the viewpoint of the first electronic device 101a. In some examples, the location of the second electronic device 101b does not overlap the location of the user interface element 440a from the viewpoint of the first electronic device 101a.

In some examples, were the location of the second electronic device 101b to change while the first electronic device 101a is displaying the user interface element that is selectable to initiate a multi-user communication session with the second electronic device 101b, the first electronic device 101a may change the location of display of the user interface element, such as shown with the location of display user interface element 440a in FIG. 4E being different from the location of display of user interface element 440a in FIG. 4G due to the change of location of the second electronic device 101b. As such, the first electronic device 101a may update the location of the display of the user interface element 440a based on detection of updates to the location of the second electronic device 101b.

In some examples, while displaying the user interface element 440a, the first electronic device 101a detects selection of the user interface element 440a. For example, the first electronic device 101a may detect a hand gesture (e.g., an air pinch gesture) directed at the user interface element 440a while gaze of the user is directed at the user interface element 440a. In response, a multi-user communication session between the first electronic device 101a and the second electronic device 101b may be initiated. In some examples, the multi-user communication session between the first electronic device 101a and the second electronic device 101b may be initiated in response to the input from the first user 402 corresponding to selection of user interface element 440a and in response to user input from the second user 404 of the second electronic device 101b that accepts the request to initiate the multi-user communication session with the first electronic device 101a. In some examples, the second electronic device 101b does not present a notification to the second user 404 that the second electronic device 101b is involved in a location tracking process with the first electronic device 101a. In some examples, the first electronic device 101a does not present a notification to the first user 402 that the first electronic device 101a is involved in a location tracking process with the second electronic device 101b. In some examples, display of user interface element 440a serves as the notification to the first user 402 that the first electronic device 101a is involved in the location tracking process with the second electronic device 101b. In some examples, while the multi-user communication session is active, the first electronic device 101a or the second electronic device 101b may request to share virtual content (e.g., virtual visual and/or audio content) with the other electronic device in the multi-user communication session. In response to detecting the request, a process is initiated for presentation of the virtual content. For example, were the first electronic device 101a to request to share display of a user interface with the second electronic device 101b, the second electronic device 101b would display the user interface, optionally at a corresponding location in the physical environment that the first electronic device 101a displays the user interface, such as shown with user interface 434 in FIG. 4H. For example, in FIG. 4H, user interface 434 is being displayed in the first three-dimensional environment 450A presented via display 120a of the first electronic device 101a and is being displayed in the second three-dimensional environment 450B presented via display 120b of the second electronic device 101b at the same corresponding location in the physical environment 400. Thus, in some examples, shared visual virtual content between the first electronic device 101a and the second electronic device 101b may be placed at the same corresponding location in the physical environment 400. Further, a first user interface element 431a (e.g., for re-positioning the user interface 434) and a second user interface element 431b that indicates that the user interface 434 is shared is displayed in the respective three-dimensional environments 450A/450B.

In some examples, when a multi-user communication session between the first electronic device 101a and the second electronic device 101b is established, an origin of the multi-user communication session is established for presenting virtual content in a manner that maintains spatial truth between the first electronic device 101a and the second electronic device 101b. Additionally, in some examples, when the multi-user communication session between the first electronic device 101a and the second electronic device 101b is established, the first electronic device 101a is configured to present, to the first user 402 of the first electronic device 101a, virtual content from the second electronic device 101b. For example, when the multi-user communication session between the first electronic device 101a and the second electronic device 101b is established, virtual content may be presented at the first electronic device 101a as if the second electronic device 101b were streaming the virtual content to the first electronic device 101a while also itself presenting the virtual content to the second user 404. As another example, when the multi-user communication session between the first electronic device 101a and the second electronic device 101b is established, the second electronic device 101b may be displaying virtual content, and were the second electronic device 101b to share the virtual content with the first electronic device 101a, the first electronic device 101a would display the virtual content, optionally at the same corresponding location in physical environment 400 as is the display of the virtual content via the second electronic device 101b. Continuing with this example, while the first electronic device 101a and the second electronic device 101b are displaying the virtual content, operations resulting from interaction with the virtual content from the first user 402 of the first electronic device 101a or the second user 404 of the second electronic device 101b may be displayed at both the first electronic device 101a and the second electronic device 101b, as similarly described above with reference to FIG. 3.

In some examples, in response to detecting selection of the user interface element 440a, the location tracking process described above between the first electronic device 101a and the second electronic device 101b (e.g., with reference to FIGS. 4A-4G) ceases. For example, in response to detecting selection of user interface element 440a, the first electronic device 101a and/or the second electronic device 101b may start tracking the other electronic device using a different process than described above. For example, a reference location (e.g., reference origin) that is different from the shared reference origin 424 may be selected (and/or otherwise agreed to by the first electronic device 101a and/or the second electronic device 101b) for use in location tracking of the other electronic device and/or for presenting shared virtual content at the first electronic device 101a and the second electronic device 101b in the multi-user communication session. For example, the reference origin used by the first electronic device 101a and the second electronic device 101b to display user interface 434 in FIG. 4H is different from the shared reference origin 424.

In some examples, while in the physical environment 400, the first electronic device 101a associates different locations (e.g., one or more locations) in the physical environment 400 with different anchors (e.g., one or more anchors) of a coordinate system of the physical environment 400. For example, the first electronic device 101a may assign (e.g., create and assign) a first anchor of the coordinate system of the physical environment 400 to a first location in the physical environment 400 and a second anchor of the coordinate system of the physical environment 400 to a second location in the physical environment 400. In some examples, while in the multi-user communication session in FIG. 4H, which includes the first user 402 of the first electronic device 101a and the second user 404 of the second electronic device 101b, the first electronic device 101a tags (e.g., associates) an anchor of the coordinate system of the physical environment 400 with one or more indicators, such as described below.

In some examples, while in the multi-user communication session in FIG. 4H, the first electronic device 101a tags (e.g., associates) a first anchor of a coordinate system of the physical environment 400 with an indicator of the users of electronic devices that are with the first electronic device 101a (e.g., that are collocated with the first electronic device 101a in the physical environment 400) in the multi-user communication session, such as shown in glyph 460a in FIG. 4H. For example, while in the multi-user communication session of FIG. 4H, the first electronic device 101a tags a first anchor of a coordinate system of the physical environment 400 with an indicator of the second user 404. In some examples, if the multi-user communication session in FIG. 4H also includes the third user 406 of the third electronic device 101c, the first electronic device 101a tags the first anchor of the coordinate system of the physical environment 400 with the indicator of the second user 404 and an indicator of the third user 406. In some examples, the first anchor is of a coordinate system of the physical environment 400 that is private to the first electronic device 101a (e.g., is not shared with the second electronic device 101b or the third electronic device 101c). For example, the first anchor is optionally one anchor of a plurality of anchors included in and/or generated using the SLAM map data of the physical environment 400 determined by the first electronic device 101a, such as the SLAM map data determined by the first electronic device 101a described above.

Likewise, in some examples, while in the multi-user communication session in FIG. 4H, the second electronic device 101b tags a second anchor of a coordinate system of the physical environment 400 with an indicator of the users of electronic devices that are with the second electronic device 101b (e.g., that are collocated with the second electronic device 101b in the physical environment 400) in the multi-user communication session, such as shown in glyph 460b in FIG. 4H. For example, while in the multi-user communication session of FIG. 4H, the second electronic device 101b tags a second anchor of a coordinate system of the physical environment 400 with an indicator of the first user 402. In some examples, if the multi-user communication session in FIG. 4H also includes the third user 406 of the third electronic device 101c, the second electronic device 101b tags the second anchor of the coordinate system of the physical environment 400 with the indicator of the first user 402 and an indicator of the third user 406. In some examples, the second anchor is of a coordinate system of the physical environment 400 that is private to the second electronic device 101b (e.g., is not shared with the first electronic device 101a or the third electronic device 101c). For example, the second anchor is optionally one anchor of a plurality of anchors included in and/or generated using the SLAM map data of the physical environment 400 determined by the second electronic device 101b, such as the SLAM map data determined by the second electronic device 101b described above. Note that, in some examples, the anchors (e.g., the first anchor and the second anchor) are not visible or displayed by the first electronic device 101a and the second electronic device 101b, but are part of the respective coordinate system of the first electronic device 101a and the second electronic device 101b. For example, the first electronic device 101a optionally does not display the first anchor and the second electronic device 101b optionally does not display the second anchor.

In some examples, the first electronic device 101a tags (e.g., associates) a first anchor of a coordinate system of a physical environment with an indicator of another user of another electronic device when the first electronic device is in a multi-user communication session with the other electronic device and is collocated with the other electronic device in the physical environment. For example, if the first electronic device 101a is not in the multi-user communication session with the other electronic device with which the first electronic device is collocated in a physical environment, the first electronic device does not tag the first anchor with the indicator of the user of the other electronic device. As another example, if the first electronic device is in a first multi-user communication session and the other electronic device is not in the first multi-user communication session, and if the first electronic device and the other electronic device are collocated in the physical environment, the first electronic device 101a does not tag the first anchor of the coordinate system with the indicator of the user of the other electronic device.

In some examples, the first electronic device 101a maintains knowledge of the tagged first anchor described above when the multi-user communication session in FIG. 4H ceases. For example, the first electronic device 101a optionally maintains knowledge of the first anchor that the first electronic device 101a tagged with the indicator of the second user 404 (and the indicator of the third user 406 provided that the multi-user communication session in FIG. 4H includes the first user 402 with the second user 404 and the third user 406) even after the multi-user communication session of FIG. 4H ceases. In some examples, the first electronic device 101a maintains the knowledge of the tagged first anchor (e.g., knowledge of the indicators associated with the tagged first anchor) for a predetermined amount of time. In some examples, the predetermined amount of time is 3 hours, 1 day, 10 days, 45 days, or another amount of time. In some examples, the predetermined amount of time with which the first electronic device 101a maintains knowledge of the first anchor that is tagged with the indicator of the second user 404 is relative to a time since the first electronic device 101a was party to a multi-user communication session with the second user 404 of the second electronic device 101b while being collocated in the physical environment 400 with the second electronic device 101b.

In some examples, the first electronic device 101a and the second electronic device 101b perform the process illustrated and/or described with reference to FIG. 4C in response to detecting that the first anchor is tagged with the second user 404 of the second electronic device 101b and the second anchor is tagged with the first user 402 of the first electronic device 101a, respectively. For example, the first electronic device 101a optionally tags the first anchor with the indicator of the second user 404 while in the multi-user communication session with the second user 404, as shown in FIG. 4H. Continuing with this example, after the ceasing of multi-user communication session of FIG. 4H, if the first electronic device 101a and the second electronic device 101b are determined to be collocated in the physical environment 400 and the first anchor is still tagged with the indicator of the second user 404 of the second electronic device 101b, the first electronic device 101a optionally performs, with the second electronic device 101b, the process illustrated and/or described with reference to FIG. 4C. Continuing with this example, after the ceasing of multi-user communication session of FIG. 4H, if the first electronic device 101a and the second electronic device 101b are determined to be collocated in the physical environment 400 and the first anchor is not still tagged with the indicator of the second user 404 of the second electronic device 101b, the first electronic device 101a optionally forgoes performing, with the second electronic device 101b, the process illustrated and/or described with reference to FIG. 4C. Likewise, as another example, the second electronic device 101b optionally tags the second anchor with the indicator of the first user 402 while in the multi-user communication session with the first user 402, as shown in FIG. 4H. Continuing with this example, after the ceasing of multi-user communication session of FIG. 4H, if the first electronic device 101a and the second electronic device 101b are determined to be collocated in the physical environment 400 and the second anchor is still tagged with the indicator of the first user 402 of the first electronic device 101a, the second electronic device 101b optionally performs, with the first electronic device 101a, the process illustrated and/or described with reference to FIG. 4C. Continuing with this example, after the ceasing of multi-user communication session of FIG. 4H, if the first electronic device 101a and the second electronic device 101b are determined to be collocated in the physical environment 400 and the second anchor is not still tagged with the indicator of the first user 402 of the first electronic device 101a, the second electronic device 101b optionally forgoes performing, with the first electronic device 101a, the process illustrated and/or described with reference to FIG. 4C.

In some examples, the first electronic device 101a updates the indicators of the first tagged anchor on a per-user basis. For example, as described above, if the multi-user communication session in FIG. 4H also includes the third user 406 of the third electronic device 101c, the first electronic device 101a tags the first anchor of the coordinate system of the physical environment 400 with the indicator of the second user 404 and an indicator of the third user 406. Continuing with this example, after the ceasing of the multi-user communication session, if the first electronic device 101a and the second electronic device 101b are determined to be collocated in the physical environment 400, without the third electronic device 101c, the first electronic device 101a optionally determines whether a tagged anchor of the coordinate system of the physical environment 400 indicates the second user 404 of the second electronic device 101b (e.g., whether the first tagged anchor indicates the second user 404 of the second electronic device 101b), optionally without determining whether the tagged anchor of the coordinate system of the physical environment 400 indicates the third user 406 of the third electronic device 101c. Continuing with this example, since the first tagged anchor indicates the second user 404 of the second electronic device 101b, the first electronic device 101a and the second electronic device 101b optionally perform the operations described with reference to FIG. 4C optionally in the illustrated order or in an order that is different from the illustrated order. Additionally, in this example, the first electronic device 101a optionally resets the predetermined amount of time for maintaining the indicator of the second user 404 of the second electronic device 101b, without resetting the predetermined amount of time for maintaining the indicator of the third user 406 of the third electronic device 101c (e.g., since the first user 402 of the first electronic device 101a and the second user 404 of the second electronic device 101b are determined to be collocated again). In some examples, the first electronic device 101a resets the predetermined amount of time for maintaining the indicator of the second user 404 of the second electronic device 101b provided that a new multi-user communication session that includes the first user 402 of the first electronic device 101a and the second user 404 of the second electronic device 101b collocated in the physical environment 400.

As described above, in some examples, the first electronic device 101a and the second electronic device 101b perform the operations described with reference to FIG. 4C in response to the determination that the first electronic device 101a and the second electronic device 101b are collocated in a physical environment. Additionally, as described above, in some examples, the first electronic device 101a and the second electronic device 101b are collocated in the physical environment 400 in FIG. 4A because the first electronic device 101a and the second electronic device 101b satisfy the determination criteria described with reference to FIG. 4A. For example, as described above, the first electronic device 101a and the second electronic device 101b are determined to be collocated in the physical environment 400 in FIG. 4A optionally based on a distance between the first electronic device 101a and the second electronic device 101b, based on communication between the first electronic device 101a and the second electronic device 101b, based on a strength of a wireless signal transmitted and detected between the first electronic device 101a and the second electronic device 101b, based on the first electronic device 101a and the second electronic device 101b being connected to a same network (e.g., wireless network) in the physical environment 400, based on visual detection of the first electronic device 101a and the second electronic device 101b in the physical environment 400, based on the user of the other electronic device being in a contact list of the electronic device, and/or because the first electronic device 101a and the second electronic device 101b are in the same physical room.

Additionally, in some examples, the first electronic device 101a and the second electronic device 101b perform the process illustrated and/or described with reference to FIG. 4C because the first electronic device 101a and the second electronic device 101b were party to a multi-user communication session that was previously established while the first electronic device 101a and the second electronic device 101b were collocated in the physical environment 400. For example, if the first electronic device 101a and the second electronic device 101b were party to a multi-user communication session that was previously established while the first electronic device 101a and the second electronic device 101b were collocated in the physical environment 400, the first electronic device 101a and the second electronic device 101b optionally initiate the process illustrated and/or described with reference to FIG. 4C. Continuing with this example, if the first electronic device 101a and the second electronic device 101b were not party to a multi-user communication session that was previously established while the first electronic device 101a and the second electronic device 101b were collocated in the physical environment 400, the first electronic device 101a and the second electronic device 101b forgo performing the process illustrated and/or described with reference to FIG. 4C. For example, if the first electronic device 101a and the second electronic device 101b are currently collocated in the physical environment 400, and if the first electronic device 101a and the second electronic device 101b were not party to a multi-user communication session that was previously established while the first electronic device 101a and the second electronic device 101b were collocated in the physical environment 400, the first electronic device 101a can perform a first process to enable performance of the process illustrated and/or described with reference to FIG. 4C. In some examples, the first process includes, presenting instructions for enabling performance of the process illustrated and/or described with reference to FIG. 4C. In some examples, the instructions include instruction that a respective input is to be provided (e.g., detected) at the second electronic device 101b in order to enable performance of the process illustrated and/or described with reference to FIG. 4C between the first electronic device 101a and the second electronic device 101b. In some examples, the instructions include an instruction that a code (e.g., a passcode or a PIN) is to be provided to the second electronic device 101b. In some examples, if the first electronic device 101a detects an indication that the second electronic device 101b has detected performance of the respective input, the first electronic device 101a enables (e.g., initiates) performance of the process illustrated and/or described with reference to FIG. 4C with the second electronic device 101b.

In some examples, the first electronic device 101a and the second electronic device 101b perform the process illustrated and/or described with reference to FIG. 4C because the first electronic device 101a and the second electronic device 101b were last party to a multi-user communication session that was previously established while the first electronic device 101a and the second electronic device 101b were collocated in the physical environment 400 within a threshold length of time (e.g., 3 hours, 1 day, 10 days, 45 days, or another amount of time). For example, if the first electronic device 101a and the second electronic device 101b were party to a multi-user communication session that was previously established while the first electronic device 101a and the second electronic device 101b were collocated in the physical environment 400 within the threshold length of time, the first electronic device 101a and the second electronic device 101b optionally initiate the process illustrated and/or described with reference to FIG. 4C. Continuing with this example, if the first electronic device 101a and the second electronic device 101b were last party to a multi-user communication session that was previously established while the first electronic device 101a and the second electronic device 101b were collocated in the physical environment 400 greater the threshold length of time, the first electronic device 101a and the second electronic device 101b forgo performing the process illustrated and/or described with reference to FIG. 4C.

It is understood that the examples shown and described herein are merely exemplary and that additional and/or alternative elements may be provided within the three-dimensional environment for facilitating sharing of content in multi-user communication sessions that include collocated users. It should be understood that the appearance, shape, form, and size of each of the various user interface elements and objects shown and described herein are exemplary and that alternative appearances, shapes, forms and/or sizes may be provided. For example, the virtual objects representative of user interfaces (e.g., user interface element 440a and user interface element 440b) may be provided in an alternative shape than a rectangular shape, such as a circular shape, triangular shape, etc. In some examples, the various selectable affordances (e.g., user interface element 440a and user interface element 440b) described herein may be selected verbally via user verbal commands (e.g., “select option” or “select virtual object” verbal command). Additionally or alternatively, in some examples, the various options, user interface elements, control elements, etc. described herein may be selected and/or manipulated via user input received via one or more separate input devices in communication with the electronic device(s). For example, selection input may be received via physical input devices, such as a mouse, trackpad, keyboard, etc. in communication with the electronic device(s).

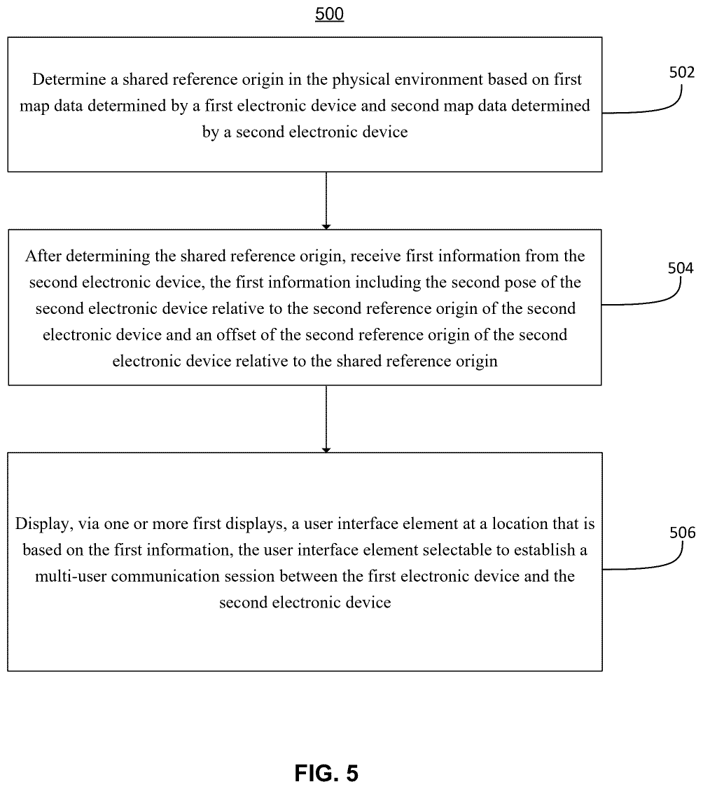

FIG. 5 illustrates a flow diagram illustrating a method 500 for displaying a user interface element selectable to establish a multi-user communication session between a first electronic device and a second electronic device according to some examples of the disclosure. One or more examples of method 500 are illustrated and/or described above with reference to one or more of FIGS. 4A-4H. It is understood that method 500 is an example and that more, fewer, or different operations can be performed in the same or in a different order. Additionally, the operations in method 500 described below are, optionally, implemented by running one or more functional modules in an information processing apparatus such as general-purpose processors (e.g., as described with respect to FIGS. 2A-2C) or application specific chips, and/or by other components of FIGS. 2A-2C.

Therefore, according to the above, some examples of the disclosure are directed to a method (e.g., method 500 of FIG. 5). The illustrated method 500 may be performed at a first electronic device in communication with one or more first displays and one or more first input devices, wherein the first electronic device is collocated with a second electronic device in a physical environment, wherein the first electronic device has a first pose (e.g., position and/or orientation) relative to a first reference origin of the first electronic device in the physical environment, and wherein the second electronic device has a second pose (e.g., position and/or orientation) relative to a second reference origin of the second electronic device in the physical environment. Additionally, the illustrated method 500 may be performed before establishing a multi-user communication session between the first electronic device and the second electronic device. Method 500 includes, determining (502) a shared reference origin in the physical environment based on first map data determined by the first electronic device and second map data determined by the second electronic device, after determining the shared reference origin, receiving (504) first information from the second electronic device, the first information including the second pose (e.g., position and/or orientation) of the second electronic device relative to the second reference origin of the second electronic device and an offset of the second reference origin of the second electronic device relative to the shared reference origin, and displaying (506), via the one or more first displays, a user interface element at a location that is based on the first information, the user interface element selectable to establish the multi-user communication session between the first electronic device and the second electronic device.

Additionally or alternatively, in some examples, the first electronic device being collocated with the second electronic device is in accordance with a determination that the second electronic device is in a field of view of the first electronic device in the physical environment.

Additionally or alternatively, in some examples, the first electronic device being collocated with the second electronic device is in accordance with a determination that the second electronic device is within a signal-based distance range of the first electronic device in the physical environment.

Additionally or alternatively, in some examples, the first electronic device being collocated with the second electronic device is in accordance with a determination that the second electronic device is within a threshold distance of the first electronic device.

Additionally or alternatively, in some examples, the first electronic device being collocated with the second electronic device is in accordance with a determination that a user of the second electronic device is in a contact list of the first electronic device.

Additionally or alternatively, in some examples, determining the shared reference origin is performed in accordance with at least one of (e.g., one or more or all of) a first determination that the second electronic device is within a signal-based distance range of the first electronic device in the physical environment, a second determination that the second electronic device is within a threshold distance of the first electronic device, and a third determination that a user of the second electronic device is in a contact list of the first electronic device.

Additionally or alternatively, in some examples, the shared reference origin is different from the first reference origin of the first electronic device and the second reference origin of the second electronic device.

Additionally or alternatively, in some examples, the first reference origin of the first electronic device is different from the second reference origin of the second electronic device.

Additionally or alternatively, in some examples, the location at which the user interface element is displayed corresponds to a respective location in the physical environment that is between a first location of the first electronic device in the physical environment and a second location of the second electronic device in the physical environment from a viewpoint of the first electronic device.

Additionally or alternatively, in some examples, a distance between the respective location and the first location is a first distance, a distance between the respective location and the second location is a second distance, and the first distance is less than the second distance.

Additionally or alternatively, in some examples, a distance between the respective location and the first location is a first distance, a distance between the respective location and the second location is a second distance, and the second distance is less than the first distance.

Additionally or alternatively, in some examples, the second pose (e.g., position and/or orientation) of the second electronic device relative to the second reference origin of the second electronic device that is included in the first information is a first respective pose (e.g., position and/or orientation) of the second electronic device at a first time, and the method 500 comprises after receiving the first information from the second electronic device and after displaying the user interface element at the location that is based on the first information, receiving updated first information from the second electronic device, the updated first information including a pose (e.g., position and/or orientation) of the second electronic device at a second time, after the first time, wherein the pose of the second electronic device at the second time is a second respective pose, different from the first respective pose, of the second electronic device relative to the second reference origin of the second electronic device and the offset of the second reference origin of the second electronic device relative to the shared reference origin, and displaying, via the one or more first displays, the user interface element at a respective location that is based on the updated first information.

Additionally or alternatively, in some examples, determining the shared reference origin is in accordance with detecting an indication that the second electronic device has selected the shared reference origin to be the shared reference origin.

Additionally or alternatively, in some examples, determining the shared reference origin includes determining a plurality of potential shared reference origins and selecting the shared reference origin from the plurality of potential shared reference origins.

Additionally or alternatively, in some examples, the method 500 is part of a first location detection process for determining a location of the second electronic device and is not part of a second location detection process for determining a location of the second electronic device, and the method 500 comprises detecting, via the one or more input devices, input corresponding to selection of the user interface element, and in response to detecting the input corresponding to selection of the user interface element, performing the second location detection process for determining the location of the second electronic device without performing the first location detection process for determining the location of the second electronic device. For example, the first location detection process optionally includes establishing a shared spatial coordinate system of the physical environment for determining a location of the second electronic device (e.g., to display a selectable option to request initiation of a multi-user communication session with the second electronic device) before a multi-user communication session is established between the first electronic device and the second electronic device. Continuing with this example, the second location detection process optionally includes establishing a shared spatial coordinate system of the physical environment 400 for the multi-user communication session between the first electronic device and the second electronic device, such as for displaying virtual content of the multi-user communication session that is shared between the first electronic device and the second electronic device.

Additionally or alternatively, in some examples, the second electronic device is in communication with one or more second displays, and the method 500 comprises while displaying the user interface element at the location based on the first information, detecting, via the one or more first input devices, input corresponding to selection of the user interface element, in response to detecting the input corresponding to the selection of the user interface element, establishing the multi-user communication session between the first electronic device and the second electronic device, and while the multi-user communication session between the first electronic device and the second electronic device is active, displaying, via the one or more first displays, shared virtual content at a corresponding location in the physical environment, wherein the shared virtual content is also displayed via the one or more second displays at the corresponding location in the physical environment.

Additionally or alternatively, in some examples, the first electronic device is also collocated with a third electronic device in the physical environment, wherein the third electronic device has a third pose (e.g., position and/or orientation) relative to a third reference origin of the third electronic device in the physical environment, and the method 500 comprises while a multi-user communication session has not been established between the first electronic device and the third electronic device, determining a respective shared reference origin in the physical environment based on the first map data detected by the first electronic device and third map data received from the third electronic device, after determining the respective shared reference origin, receiving respective information from the third electronic device, the respective information including the third pose (e.g., position and/or orientation) of the third electronic device relative to the third reference origin of the third electronic device and a respective offset of the third reference origin of the third electronic device relative to the respective shared reference origin, and displaying, via the one or more first displays, a respective user interface element at a respective location that is based on the respective information, the respective user interface element selectable to establish the multi-user communication session between the first electronic device and the third electronic device.

Additionally or alternatively, in some examples, the method 500 includes, while displaying the user interface element, detecting, via the one or more first input devices, selection of the user interface element, such as selection of user interface element 440a in FIG. 4G, and, in response to detecting the selection of the user interface element, establishing the multi-user communication session between the first electronic device and the second electronic device, such as the multi-user communication session between the first electronic device 101a and the second electronic device 101b in FIG. 4H, wherein the multi-user communication session between the first electronic device and the second electronic device is a first multi-user communication session between the first electronic device and the second electronic device. Additionally or alternatively, in some examples, the method 500 includes, while in the first multi-user communication session with the second electronic device, associating a first anchor of a coordinate system of the physical environment of the first electronic device with an indicator of a second user of the second electronic device, such as shown in glyph 460a in FIG. 4H, and after associating the first anchor of the coordinate system of the physical environment of the first electronic device with the indicator of the second user of the second electronic device, ceasing the first multi-user communication session. Additionally or alternatively, in some examples, the method 500 includes, after ceasing the first multi-user communication session, in accordance with a determination that the first electronic device and the second electronic device are collocated in the physical environment after ceasing the first multi-user communication session, performing a first process before establishing a second multi-user communication session between the first electronic device and the second electronic device, such as the process illustrated and/or described with reference to FIG. 4C between the first electronic device 101a and the second electronic device 101b. Additionally or alternatively, in some examples, the method 500 includes, after ceasing the first multi-user communication session, in accordance with a determination that the first electronic device and the second electronic device are not collocated in the physical environment after ceasing the first multi-user communication session, forgoing performing the first process, such as forgoing performance of the process illustrated and/or described with reference to FIG. 4C between the first electronic device 101a and the second electronic device 101b. Additionally or alternatively, in some examples, the determination that the first electronic device and the second electronic device are collocated in the physical environment after ceasing the first multi-user communication session includes one or more of a determination that the second user of the second electronic device is in a contact list of an application on the first electronic device after ceasing the first multi-user communication session, a determination that the second electronic device is within a signal-based distance range of the first electronic device in the physical environment after ceasing the first multi-user communication session, a determination that an amount of time elapsed since ceasing of the first multi-user communication session is less than a threshold amount of time, and a determination that the first anchor of the coordinate system of the physical environment of the first electronic device is still associated with the indicator of the second user of the second electronic device after ceasing the first multi-user communication session. Additionally or alternatively, in some examples, determining that the first anchor of the coordinate system of the physical environment of the first electronic device is still tagged with the indicator of the second user of the second electronic device after ceasing the first multi-user communication session includes determining that the amount of time elapsed since ceasing of the first multi-user communication session is less than the threshold amount of time. Additionally or alternatively, in some examples, determining that the first anchor of the coordinate system of the physical environment of the first electronic device is not still tagged with the indicator of the second user of the second electronic device after ceasing the first multi-user communication session includes determining that the amount of time elapsed since ceasing of the first multi-user communication session is not less than the threshold amount of time. Additionally or alternatively, in some examples, after ceasing the first multi-user communication session, the first electronic device is collocated with the second electronic device in the physical environment, the first electronic device has a first respective pose relative to a first respective reference origin of the first electronic device in the physical environment, and the second electronic device has a second respective pose relative to a second respective reference origin of the second electronic device in the physical environment. Additionally or alternatively, in some examples, the first process includes, before establishing the second multi-user communication session between the first electronic device and the second electronic device, determining a respective shared reference origin in the physical environment based on first respective map data determined by the first electronic device and second respective map data determined by the second electronic device, such as described with reference to block 422 in FIG. 4C. Additionally or alternatively, in some examples, the first process includes, after determining the respective shared reference origin, receiving first respective information from the second electronic device, the first respective information including the second respective pose of the second electronic device relative to the second respective reference origin of the second electronic device and a respective offset of the second respective reference origin of the second electronic device relative to the respective shared reference origin, such as described with reference to block 430 in FIG. 4C. Additionally or alternatively, in some examples, the first process includes displaying, via the one or more first displays, the user interface element at a respective location that is based on the first respective information, the user interface element being selectable to establish the second multi-user communication session between the first electronic device and the second electronic device, such as the user interface element 440a in FIG. 4G. Additionally or alternatively, in some examples, method 500 may further include one or more operations described with reference to method 600.

Some examples of the disclosure are directed to an electronic device, comprising: one or more processors; memory; and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

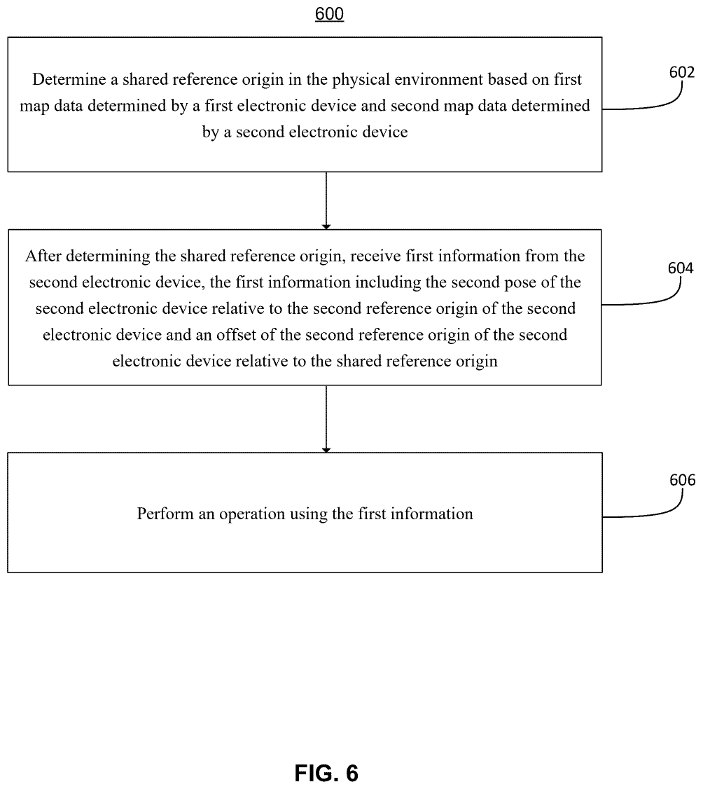

FIG. 6 illustrates a flow diagram illustrating a method 600 performing an operation based on certain information according to some examples of the disclosure. One or more examples of method 600 are illustrated and/or described above with reference to one or more of FIGS. 4A-4H. It is understood that method 600 is an example and that more, fewer, or different operations can be performed in the same or in a different order. Additionally, the operations in method 600 described below are, optionally, implemented by running one or more functional modules in an information processing apparatus such as general-purpose processors (e.g., as described with respect to FIGS. 2A-2C) or application specific chips, and/or by other components of FIGS. 2A-2C.

Therefore, according to the above, some examples of the disclosure are directed to a method (e.g., method 600 of FIG. 6). The illustrated method 600 may be performed at a first electronic device in communication with one or more first displays and one or more first input devices, wherein the first electronic device is collocated with a second electronic device in a physical environment, wherein the first electronic device has a first pose (e.g., position and/or orientation) relative to a first reference origin of the first electronic device in the physical environment, and wherein the second electronic device has a second pose (e.g., position and/or orientation) relative to a second reference origin of the second electronic device in the physical environment. Additionally, the illustrated method 600 may be performed before establishing a multi-user communication session between the first electronic device and the second electronic device. Method 600 includes, determining (602) a shared reference origin in the physical environment based on first map data determined by the first electronic device and second map data determined by the second electronic device, after determining the shared reference origin, receiving (604) first information from the second electronic device, the first information including the second pose (e.g., position and/or orientation) of the second electronic device relative to the second reference origin of the second electronic device and an offset of the second reference origin of the second electronic device relative to the shared reference origin, and performing (606) an operation based on the first information. Additionally or alternatively, in some examples, method 600 may further include one or more operations described with reference to method 500. For example, at block 606 of method 600, the operation of block 506 of FIG. 5 may be performed and/or a different operation may be performed.

Some examples of the disclosure are directed to an electronic device, comprising: one or more processors; memory; and one or more programs stored in the memory and configured to be executed by the one or more processors, the one or more programs including instructions for performing any of the above methods. Some examples of the disclosure are directed to a non-transitory computer readable storage medium storing one or more programs, the one or more programs comprising instructions, which when executed by one or more processors of an electronic device, cause the electronic device to perform any of the above methods. Some examples of the disclosure are directed to an electronic device, comprising one or more processors, memory, and means for performing any of the above methods. Some examples of the disclosure are directed to an information processing apparatus for use in an electronic device, the information processing apparatus comprising means for performing any of the above methods.

Note that the multi-user communication session between the user of the first electronic device 360 and the user of the second electronic device 370 in FIG. 3 is a multi-user communication session of a first type. As illustrated and/or described with reference to FIG. 3, in some examples, in the first type of multi-user communication session, a three-dimensional environment that is presented at a respective electronic device in the multi-user communication session of the first type includes visual representations (e.g., two-dimensional and/or three-dimensional representations, such as avatars) of other users in the first type of multi-user communication session. For example, in FIG. 3, the first electronic device 360 presents the avatar 315 of the user of the second electronic device 370. As illustrated and/or described with reference to FIG. 3, in some examples, in the first type of multi-user communication session, a respective electronic device enables audio detection, via audio input devices (e.g., microphones such as the one or more microphones 213A in FIG. 2A) of the respective electronic device. For example, the first electronic device 360 enables audio detection, via audio input devices of the first electronic device 360. Additionally, the first electronic device 360 optionally transmits detected audio to the second electronic device 370. Additionally, as illustrated and/or described with reference to FIG. 3, in some examples, in the first type of multi-user communication session, a respective electronic device enables presentation, via audio output devices (e.g., internal and/or external speakers, such as the speakers 216A) of the respective electronic device, of audio associated with other users in the first type of multi-user communication session. For example, the first electronic device 360 enables presentation, at the first electronic device 360, of audio captured by the second electronic device 370. Additionally, in some examples, respective electronic devices in the first type of multi-user communication session present shared content of the multi-user communication session relative to different anchors (e.g., origin points) of coordinate systems of the physical environment in which the respective electronic devices are located.

Note that the multi-user communication session between the first user 402 of the first electronic device 101a and the second user 404 of the second electronic device 101b in FIG. 4H is a multi-user communication session of a second type that is different from the first type. In some examples, users of electronic devices that are in the second type of multi-user communication session with each other are collocated in a physical environment and are presented via their physical bodies rather than via avatars relative to each other, such as illustrated and/or described with reference to FIG. 4H. Additionally, in some examples, the electronic devices associated with the users that are in the second type of multi-user communication session with each other do not present (e.g., disable presentation of) audio of the users that are in the second type of multi-user communication session with each other. Additionally, in some examples, the electronic devices of the users that are in the second type of multi-user communication session with each other have established a shared spatial coordinate system of the physical environment in which they are located in order to align presentation of virtual content of the multi-user communication session (e.g., in order to have spatial truth (e.g., a consistent spatial arrangement between users (or representations thereof) and shared virtual objects) in the physical environment). For example, two electronic devices that are in the second type of multi-user communication session with each other present shared content of the multi-user communication session at the same corresponding location in the physical environment in which they are located. In some examples, users in the multi-user communication session of the second type are collocated with each other in a physical environment. In some examples, a multi-user communication session of the second type does not include users of electronic devices that are not collocated in a physical environment. In some examples, a first electronic device can initiate a mixed multi-user communication session, which is a multi-user communication session of the first type and a multi-user communication session of the second type. For example, while in a multi-user communication session of the first type with a set of users, the first electronic device can be in a multi-user communication session of the second type with a subset of the set of users.

A first user of a first electronic device may wish to initiate a multi-user communication session. For example, the first user of the first electronic device may wish to initiate a multi-user communication session to share content (e.g., a user interface of an application, such as the user interface 434) with a second user of a second electronic device. In some examples, the first electronic device can detect and respond to user input requesting to initiate a multi-user communication session with one or more users by transmitting requests to the electronic devices associated with those users. In some examples, after transmitting the requests, the first electronic device detects indications that the one or more users have accepted the requests via the one or more electronic devices of the one or more users. In some examples, in response to detecting the indications, the first electronic device initiates a multi-user communication session of a first type or of a second type with a respective user of a respective electronic device of the one or more users of electronic devices based on a type of the respective electronic device from which a respective user accepts the request to join the multi-user communication session. For example, if the respective user of the respective electronic device is collocated in a physical environment with the first user of the first electronic device, if the respective user of the respective electronic device accepts, via the respective electronic device, the request to join the multi-user communication session with the first user of the first electronic device, and if the respective electronic device is a first type of electronic device, the first electronic device initiates the first type of multi-user communication session with the respective user of the respective electronic device. Continuing with this example, if the respective user of the respective electronic device is collocated in a physical environment with the first user of the first electronic device, if the respective user of the respective electronic device accepts, via the respective electronic device, the request to join the multi-user communication session with the first user of the first electronic device, and if the respective electronic device is a second type of electronic device, different from the first type of electronic device, the first electronic device initiates the second type of multi-user communication session with the respective user of the respective electronic device instead of initiating the first type of multi-user communication session with the respective user of the respective electronic device.

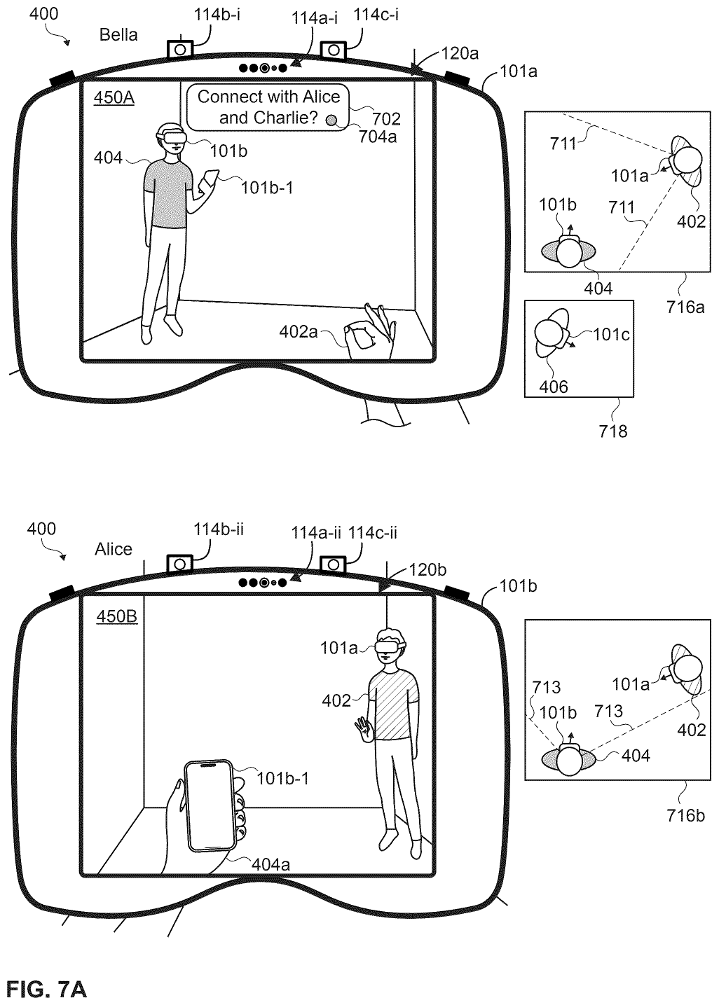

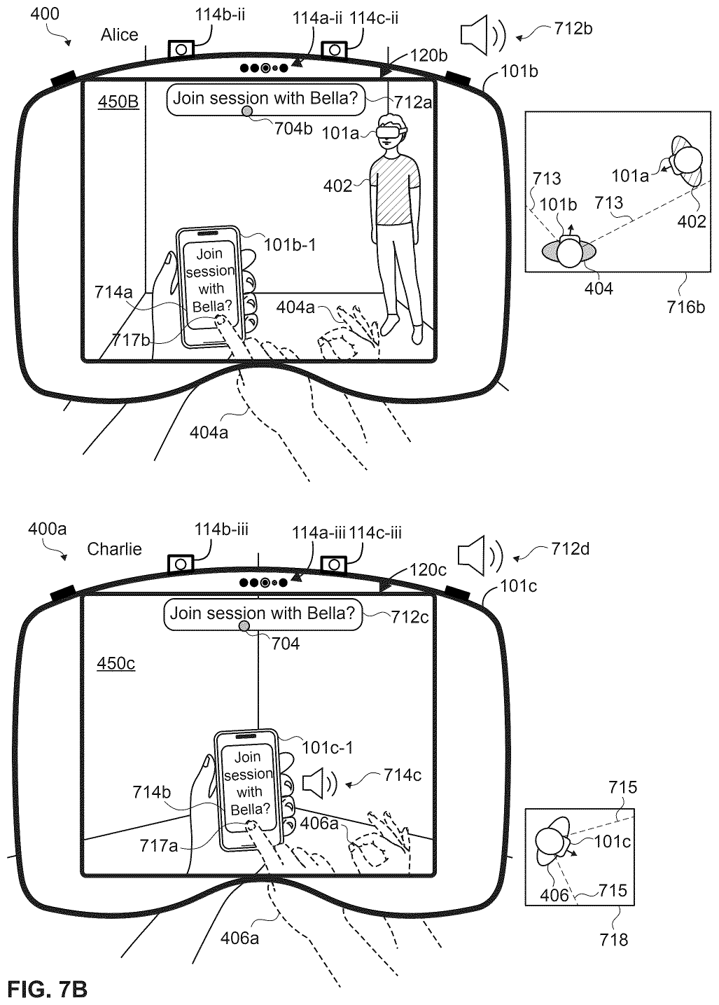

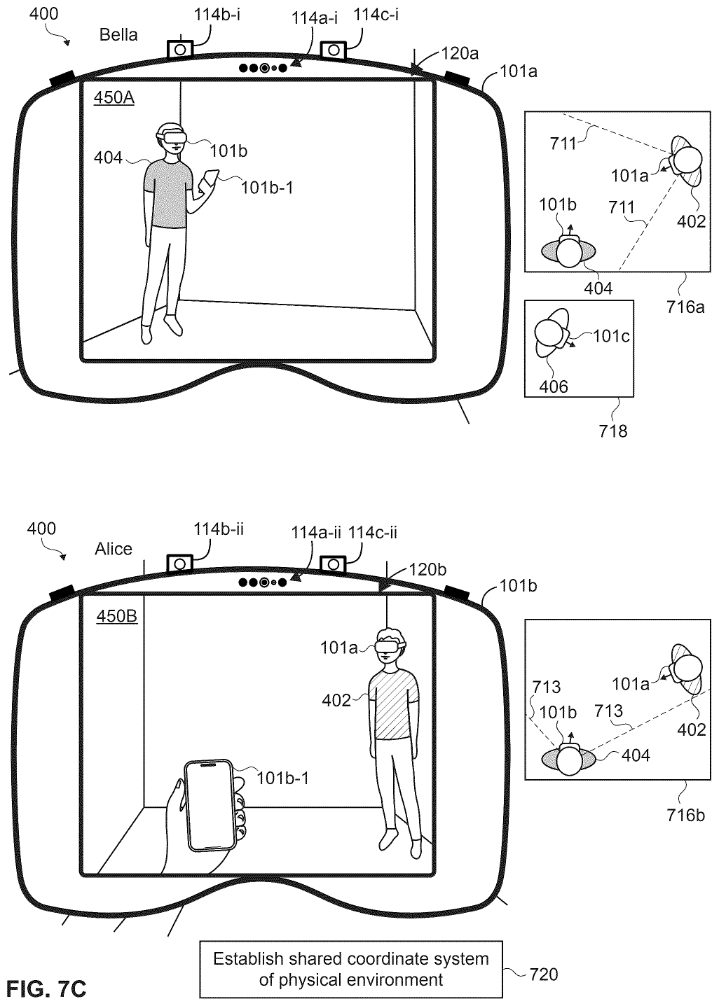

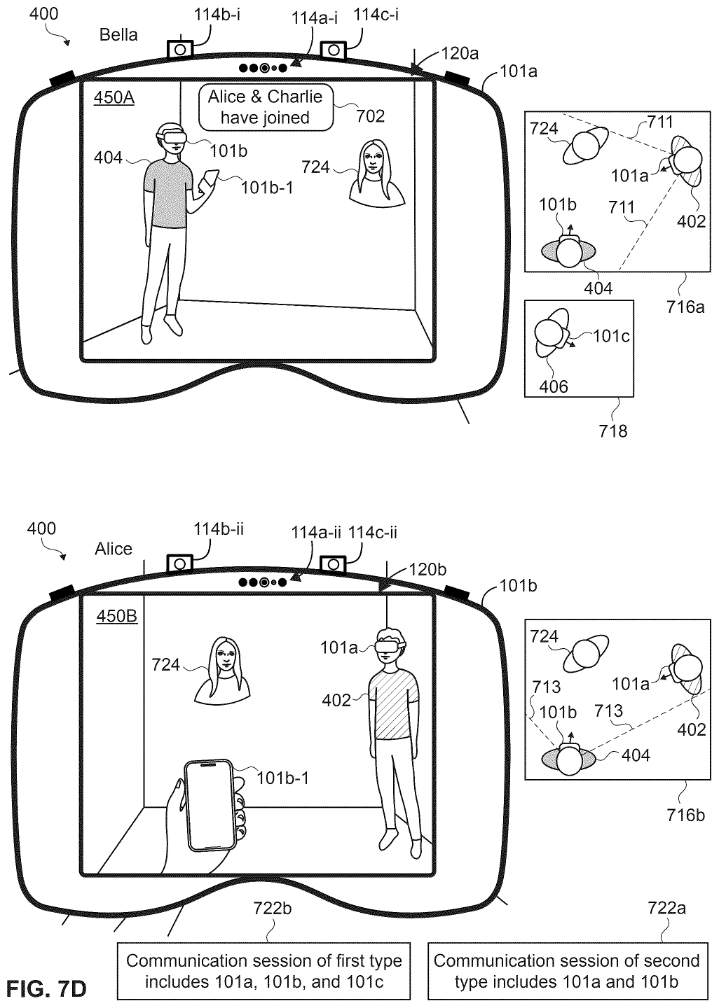

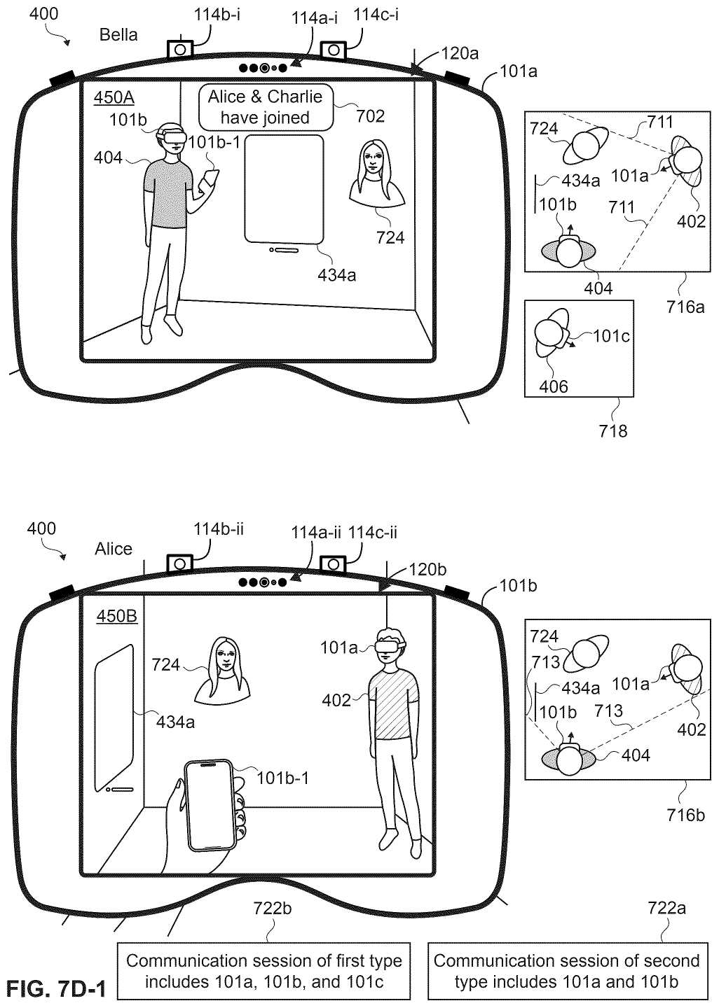

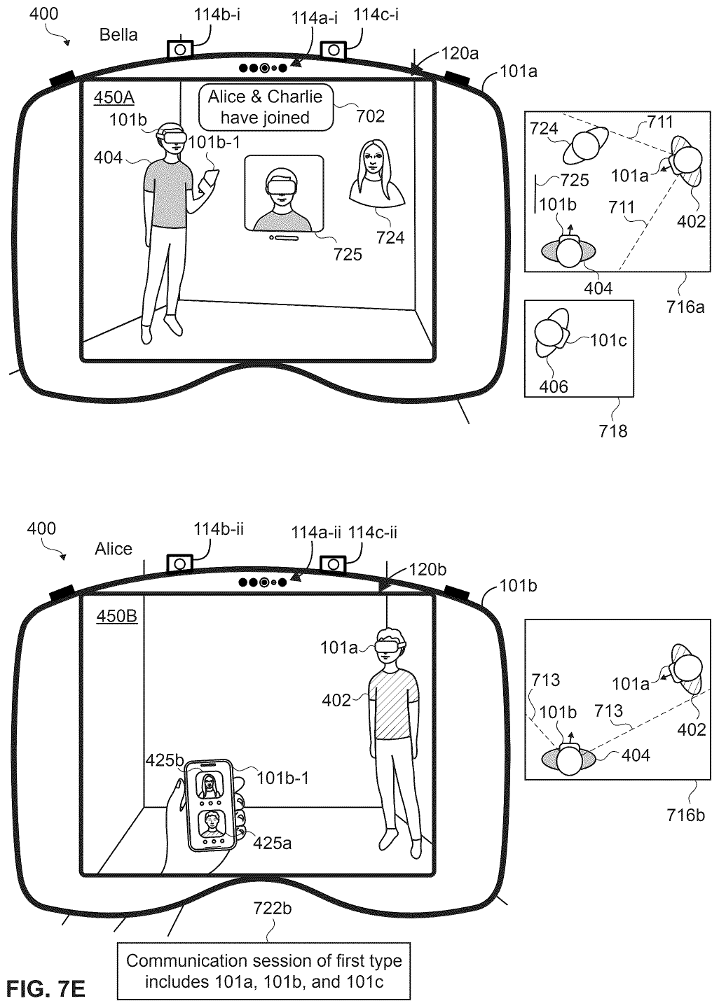

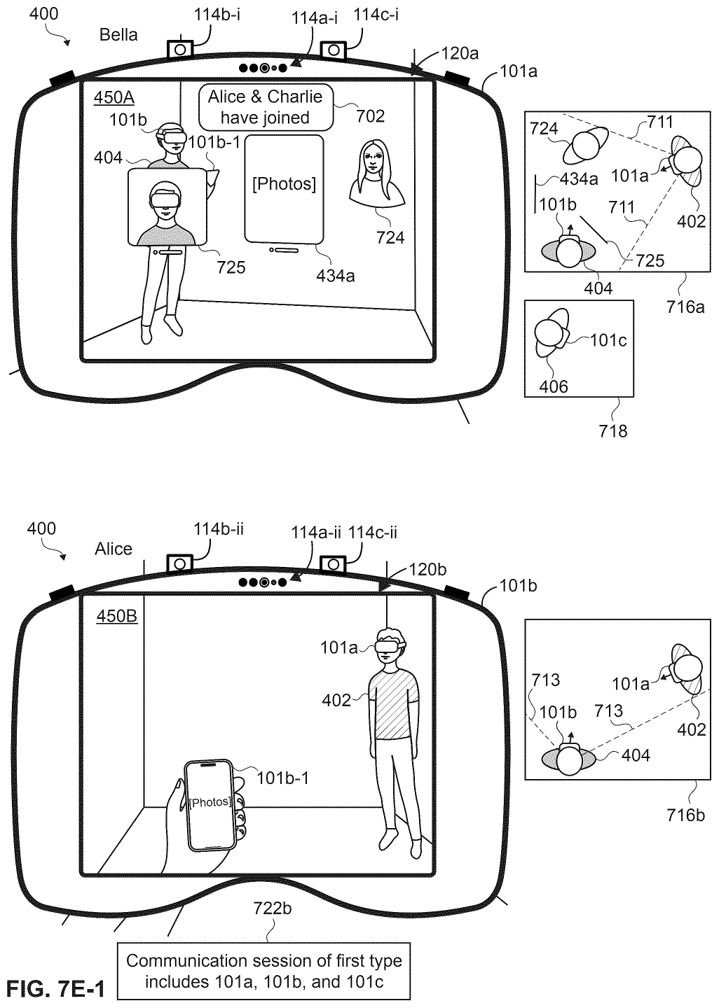

FIGS. 7A through 7E-1 generally illustrate examples of a first electronic device initiating different types of multi-user communication sessions with a second user of a second electronic device based on a type of electronic device from which the second user of the second electronic device accepts a request to join a multi-user communication session with a first user of the first electronic device, according to some examples of the disclosure.

FIG. 7A illustrates the first electronic device 101a detecting input requesting to initiate a multi-user communication session with the second user 404 of the second electronic device 101b and the third user 406 of the third electronic device 101c, where the second user 404 is with the first user 402 in the physical environment 400, and where the third user 406 is not with the first user 402 in the physical environment 400, according to some examples of the disclosure.

In FIG. 7A, the first electronic device 101a (e.g., a wearable electronic device) worn by the first user 402 of the first electronic device 101a presents the first three-dimensional environment 450A from a viewpoint of the first electronic device 101a, such as the viewpoint of the first electronic device 101a illustrated in the overhead view 716a. Overhead views 716a in FIGS. 7A, 7C through 7E-1 and 9A through 9C, generally show relative positioning of objects in the first three-dimensional environment 450A in a horizontal dimension and a depth dimension and show the viewpoint of the first electronic device 101a, as indicated with the arrow extending from the first electronic device 101a in the respective figure. Likewise, in FIGS. 7A and 7C through 7E-1, the display 120a has a field of view (e.g., a field of view captured by external image sensors 114b and 114c (e.g., external image sensors 114b-i and 114c-i of the first electronic device 101a) of the first electronic device 101a and/or visible to the first user 402 via display 120a) that corresponds to the content shown in display 120a in FIGS. 7A and 7C through 7E-1, respectively. For example, in FIG. 7A, the viewing boundaries of the first user 402 via the first electronic device 101a are given by the viewing boundaries 711 in overhead view 716a. Because the display 120a is optionally a head-mounted device, the field of view of display 120a is optionally the same as or similar to the field of view of the first user 402. For example, the view of the first three-dimensional environment 450A depicts what is visible to the first user 402 (via display 120a) when the viewpoint of the first electronic device 101a is located as shown in the overhead view 716a of the first three-dimensional environment 450A and the first electronic device 101a is optionally oriented in the direction indicated by the direction arrow emanating from the first electronic device 101a in the overhead view 716a.

In FIG. 7A, the second electronic device 101b (e.g., a wearable electronic device) worn by the second user 404 of the second electronic device 101b presents the second three-dimensional environment 450B from a viewpoint of the second electronic device 101b, such as the viewpoint of the second electronic device 101b illustrated in the overhead view 716b. Overhead views 716b in FIGS. 7A through 7E-1 generally show relative positioning of objects in the second three-dimensional environment 450B in a horizontal dimension and a depth dimension and show the viewpoint of the second electronic device 101b, as indicated with the arrow extending from the second electronic device 101b in the respective figure. Likewise, in FIGS. 7A through 7E-1, the display 120b has a field of view (e.g., a field of view captured by external image sensors 114b and 114c (e.g., external image sensors 114b-ii and 114c-ii of the second electronic device 101b) of the second electronic device 101b and/or visible to the second user 404 via display 120b) that corresponds to the content shown in display 120b in FIGS. 7A through 7E-1, respectively. For example, in FIG. 7A, the viewing boundaries of the second user 404 via the second electronic device 101b are given by the viewing boundaries 713 in overhead view 716b. Because the display 120b is optionally a head-mounted device, the field of view of display 120b is optionally the same as or similar to the field of view of the second user 404. For example, the view of the second three-dimensional environment 450B depicts what is visible to the second user 404 (via display 120b) when the viewpoint of the second electronic device 101b is located as shown in the overhead view 716b of the second three-dimensional environment 450B and the second electronic device 101b is optionally oriented in the direction indicated by the direction arrow emanating from the second electronic device 101b in the overhead view 716b.

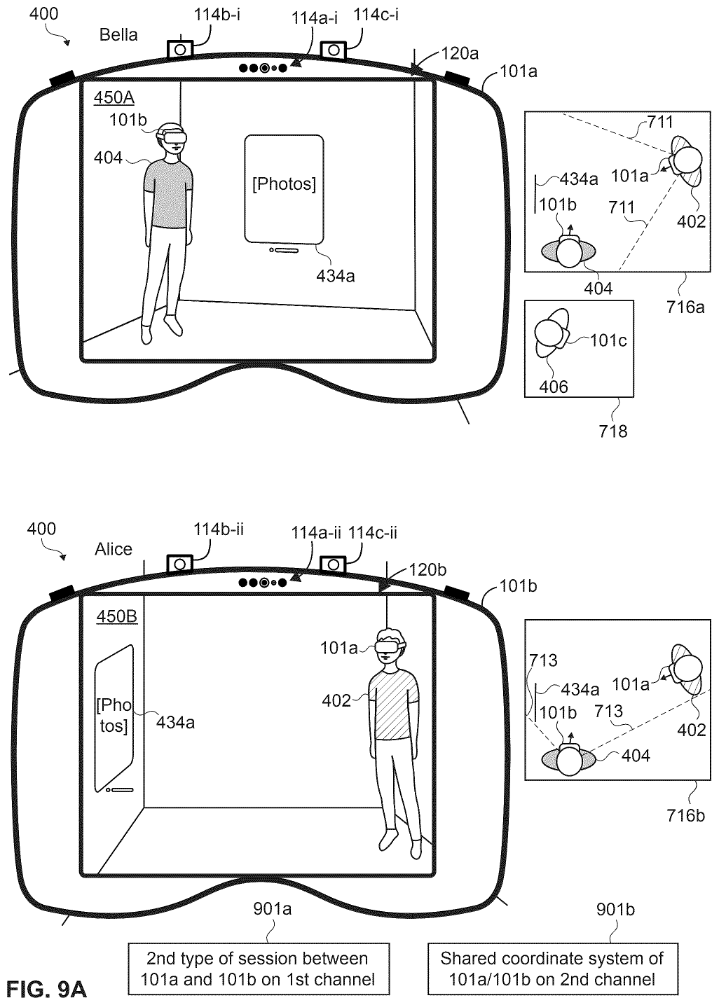

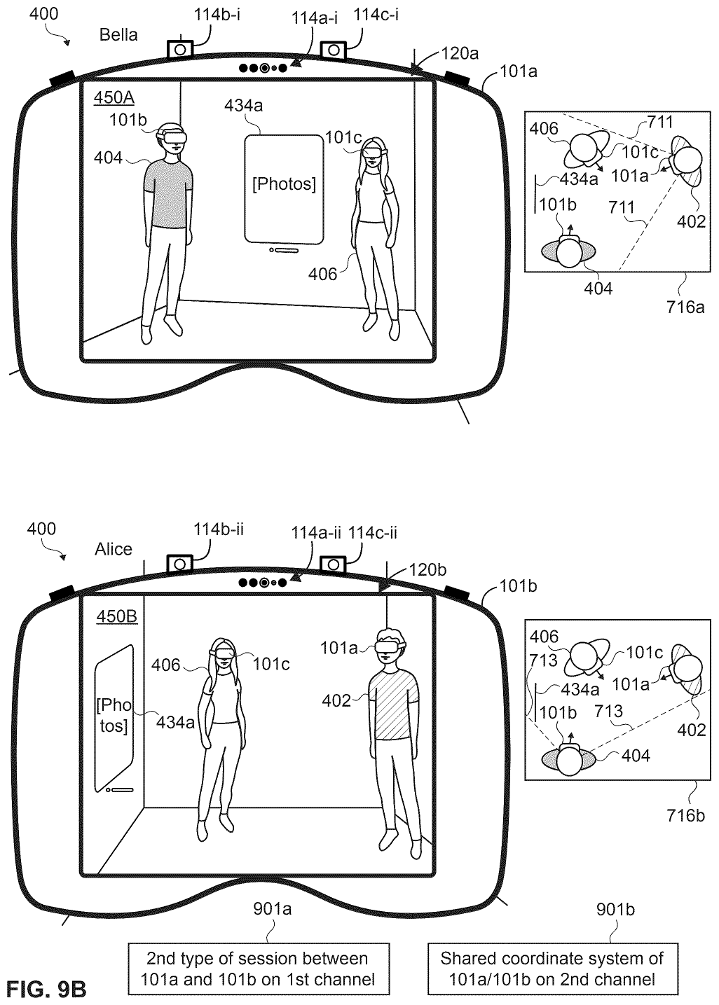

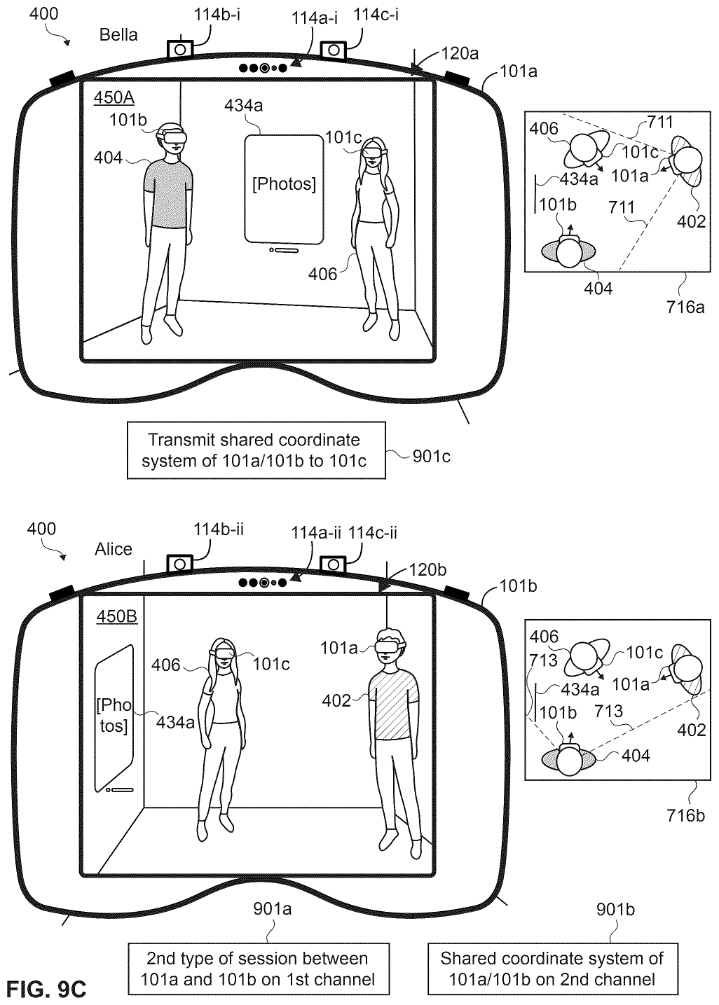

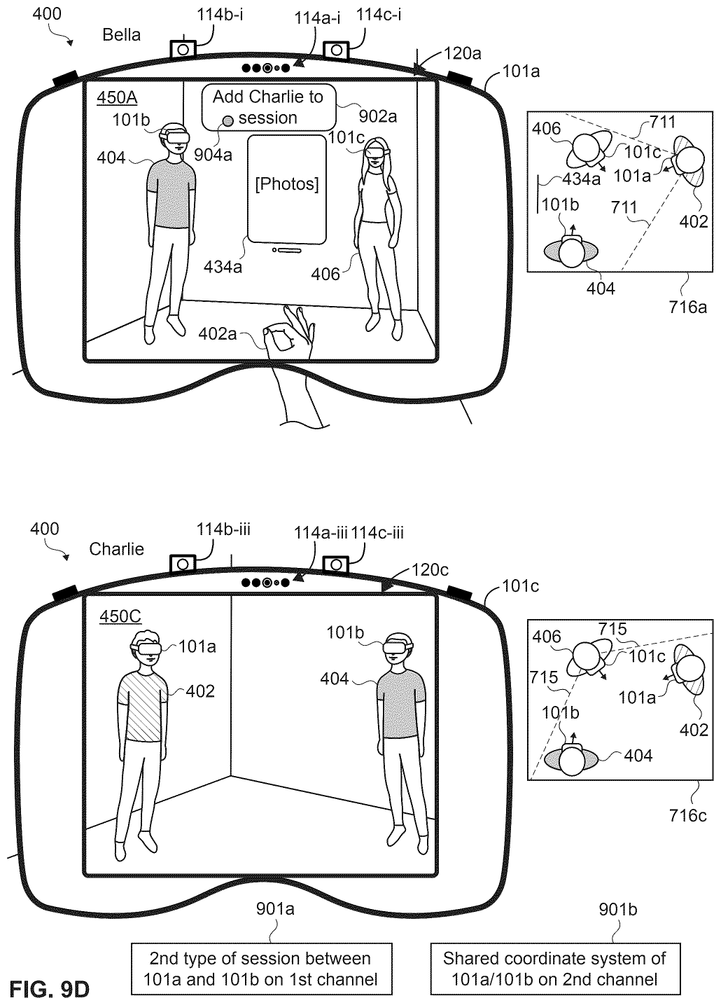

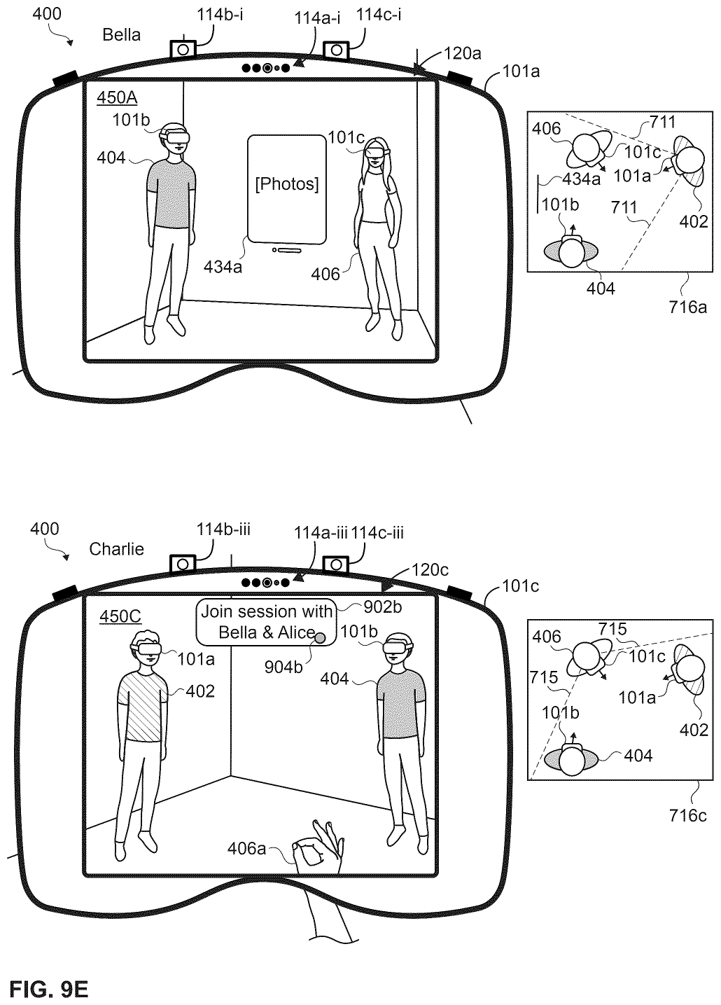

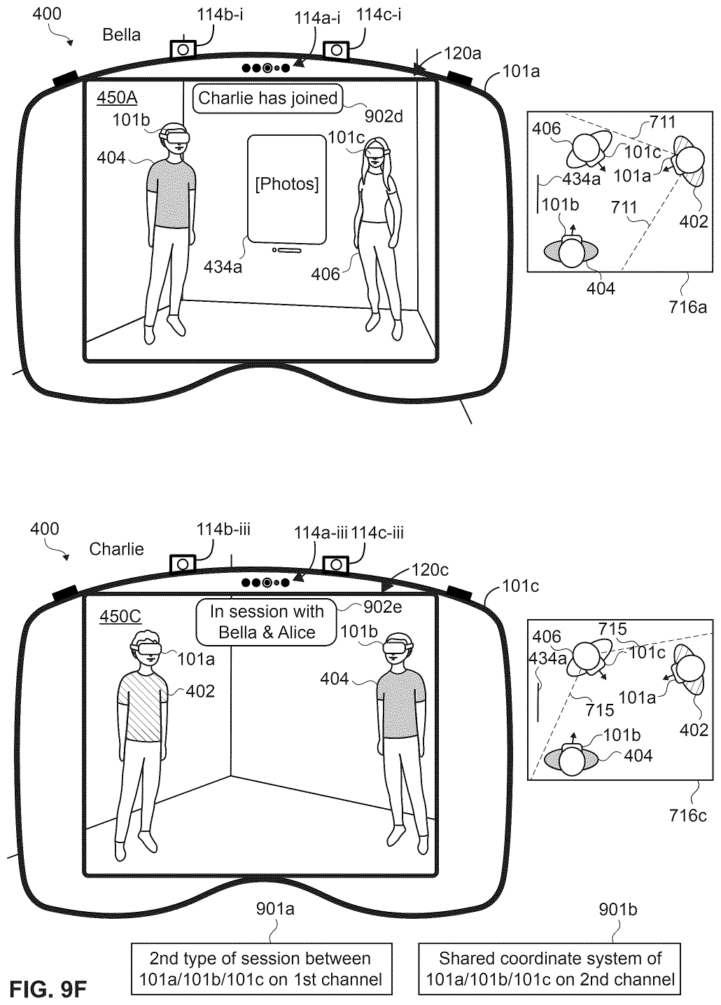

In FIG. 7B, the third electronic device 101c (e.g., a wearable electronic device) worn by the third user 406 of the third electronic device 101c presents the third three-dimensional environment 450C from a viewpoint of the third electronic device 101c, such as the viewpoint of the third electronic device 101c illustrated in the overhead view 718. Overhead view 718 in FIGS. 7A through 7E-1 and overhead view 716c in FIGS. 9D through 9F generally show relative positioning of objects in the third three-dimensional environment 450C in a horizontal dimension and a depth dimension and show the viewpoint of the third electronic device 101c, as indicated with the arrow extending from the third electronic device 101c in the respective figure. Likewise, in FIGS. 7B and 9D through 9F, the display 120c has a field of view (e.g., a field of view captured by external image sensors 114b and 114c (e.g., external image sensors 114b-iii and 114c-iii of the third electronic device 101c) of the third electronic device 101c and/or visible to the third user 406 via display 120c) that corresponds to the content shown in display 120c in the respective figure. For example, in FIG. 7B and FIGS. 9D through 9F, the viewing boundaries of the third user 406 via the third electronic device 101c are given by the viewing boundaries 715 in the overhead view 718 and overhead view 716c in the respective figure. Because the display 120c is optionally a head-mounted device, the field of view of display 120c is optionally the same as or similar to the field of view of the third user 406. For example, in FIG. 7B, the view of the third three-dimensional environment 450C depicts what is visible to the third user 406 (via display 120c) when the viewpoint of the third electronic device 101c is located as shown in the overhead view 718 of the third three-dimensional environment 450C and the third electronic device 101c is optionally oriented in the direction indicated by the direction arrow emanating from the third electronic device 101c in the overhead view 718.

In FIG. 7A, the second user 404 of the second electronic device 101b is also a user of a second respective electronic device 101b-1. For example, in FIG. 7A, the second user 404 is logged into the second electronic device 101b and the second respective electronic device 101b-1. For example, the operating systems of the second electronic device 101b and the second respective electronic device 101b-1 are associated with the same user account (e.g., same username and/or password) because the second user 404 logged into the second electronic device 101b and the second respective electronic device 101b-1 using the same username and password. In FIG. 7A, the second respective electronic device 101b-1 is a mobile phone (e.g., a handheld electronic device or a wearable electronic device); however, in some examples, the second respective electronic device 101b-1 is alternatively a tablet, a computer, a laptop computer, a watch or another type of electronic device that is different from a type of electronic device that the second electronic device 101b in FIG. 7A is. In some examples, the second respective electronic device 101b-1 includes one or more characteristics described with reference to electronic devices 160/260. In some examples, the second electronic device 101b is a head-mounted display system.

In FIG. 7A, the second user 404 is wearing the second electronic device 101b and is holding (e.g., in hand 404a of the second user 404) the second respective electronic device 101b-1. In some examples, the second user 404 is interacting with the second respective electronic device 101b-1 in FIG. 7A while wearing the second electronic device 101b. In some examples, the second user 404 is not interacting with the second respective electronic device 101b-1 in FIG. 7A while wearing the second electronic device 101b.

In FIG. 7A, the first user 402 of the first electronic device 101a and the second user 404 of the second electronic device 101b are determined to be collocated in the physical environment 400, such as described above with reference to the first electronic device 101a and the second electronic device 101b being collocated in the physical environment 400 in FIG. 4A. In some examples, if the second user 404 is solely a user of the respective electronic device 101b-1 (e.g., if the second electronic device 101b is not in the physical environment 400 and/or if the second electronic device 101b is not being worn or used by the second user 404), the first user 402 and the second user 404 would not be determined to be collocated in the physical environment 400. In some examples, if the second user 404 is solely a user of the second electronic device 101b, the first user 402 and the second user 404 would be determined to be collocated in the physical environment 400. In some examples, if the second user 404 is a user of the second electronic device 101b and the second respective electronic device 101b-1, the first user 402 and the second user 404 would be determined to be collocated in the physical environment 400. In FIG. 7A, the first user 402 and the third user 406 of the third electronic device 101c are in different physical environments. In FIG. 7A, the first user 402 is with the second user 404 in the physical environment 400, and the third user 406 is in the physical environment 400a. In FIG. 7A, the first user 402 of the first electronic device 101a wishes to initiate a multi-user communication session of the first type with the second user 404 of the second electronic device 101b and the third user 406 of the third electronic device 101c.

In FIG. 7A, the first electronic device 101a displays an option 702 that is selectable to transmit requests to the second user 404 and the third user 406 to join a multi-user communication session that includes the first user 402. For example, the option 702 is selectable to cause the first electronic device 101a to transmit, to one or more electronic devices associated with the second user 404, a first request that indicates that the first user 402 requests for the second user 404 to join the multi-user communication session with the first user 402, and to transmit, to one or more electronic devices associated with the third user 406, a second request that indicates that the first user 402 requests for the third user 406 to join the multi-user communication session with the first user 402. In FIG. 7A, the first electronic device 101a detects user input directed to the option 702. For example, in FIG. 7A, the user input includes attention 704a (e.g., gaze) of the first user 402 directed to the option 702 while a hand 402a of the first user 402 performs an air pinch gesture. In response to detecting the user input in FIG. 7A, the first electronic device 101a transmits requests to the electronic devices that are associated with the second user 404 and the third user 406, as shown in FIG. 7B.

In some examples, the first electronic device 101a transmits different types of requests to the electronic devices associated with the second user 404 and the third user 406 based on whether the respective user is collocated with the first user 402 in the physical environment 400. For example, if the second user 404 is collocated with the first user 402 in the physical environment 400 when the user input in FIG. 7A is detected, which is the illustrated case in FIG. 7A, the first electronic device 101a transmits a first type of request to the one or more electronic devices associated with the second user 404 in response to the input in FIG. 7A. Alternatively, continuing with this example, if the second user 404 is not collocated with the first user 402 in the physical environment 400 when the user input in FIG. 7A is detected, the first electronic device 101a transmits a second type of request, different from the first type of request, to the one or more electronic devices associated with the second user 404 in response to the input in FIG. 7A. Likewise, if the third user 406 is collocated with the first user 402 in the physical environment 400 when the user input in FIG. 7A is detected, the first electronic device 101a transmits a first type of request to the one or more electronic devices associated with the third user 406 in response to the input in FIG. 7A. Alternatively, continuing with this example, if the third user 406 is not collocated with the first user 402 in the physical environment 400 when the user input in FIG. 7A is detected, which is the illustrated case in FIG. 7A, the first electronic device 101a transmits a second type of request, different from the first type of request, to the one or more electronic devices associated with the third user 406 in response to the input in FIG. 7A.

In some examples, transmitting the first type of request enables the recipient to join a multi-user communication session of the first type or of the second type with the first user 402 based on the electronic device from which the recipient joins. In some examples, transmitting the second type of request solely enables the recipient to join the multi-user communication session of the first type with the first user 402, without enabling the recipient to join the multi-user communication session of the second type, independent of the electronic device from which the recipient joins.

For example, as described above, in FIG. 7A, the first user 402 and the second user 404 are collocated in the physical environment 400. Thus, the first user 402 and the second user 404 are collocated in the physical environment 400 when the user input in FIG. 7A is detected. Accordingly, the first electronic device 101a transmits the first type of request for initiating a multi-user communication session with the second user 404, where the first type of request enables the second user 404 to join a multi-user communication session of the first type or of the second type with the first user 402 based on the electronic device from which the second user 404 accepts the request from the first user 402. Continuing with this example, as described above, in FIG. 7A, the first user 402 and the third user 406 are not collocated in the physical environment 400. Thus, the first user 402 and the third user 406 are not collocated in the physical environment 400 when the user input in FIG. 7A is detected. Accordingly, the first electronic device 101a transmits the second type of request for initiating a multi-user communication session with the third user 406, where the second type of request solely enables the third user 406 to join the multi-user communication session of the first type with the first user 402, without enabling the third user 406 to join the multi-user communication session of the second type with the first user 402, independent of the electronic device from which the third user 406 joins.

FIG. 7B illustrates the electronic devices associated with the second user 404 detecting and/or responding to the first type of request from the first electronic device 101a for initiating a multi-user communication session with the second user 404 (e.g., that is transmitted from the first electronic device 101a in response to the user input in FIG. 7A) and the electronic devices associated with the third user 406 detecting and/or responding to the second type of request for initiating a multi-user communication session with the third user 406 (e.g., that is transmitted from the first electronic device 101a in response to the user input in FIG. 7A), according to some examples. In particular, as described above, in response to detecting the user input in FIG. 7A that corresponds to the request to initiate a multi-user communication session that includes the first user 402 with the second user 404 and the third user 406, the first electronic device 101a transmits, to the electronic devices associated with the second user 404 and the third user 406, a request for the second user 404 and the third user 406 to join a multi-user communication session with the first user 402.

As shown in FIG. 7B, in response to detecting the request for the second user 404 to join the multi-user communication session that includes the first user 402, the second electronic device 101b presents a user interface element 712a (e.g., a visual notification) and presents an audio notification 712b. In FIG. 7B, the user interface element 712a is selectable to accept the request from the first user 402 (“Bella”) to join the multi-user communication session that includes the first user 402. In some examples, if the request to join the multi-user communication session with the first user 402 were to include the first user 402 sharing content in the multi-user communication session, the user interface element 712a would further visually indicate the specific application that the first user 402 is requesting to share with the second user 404 in the multi-user communication session. Additionally, in FIG. 7B, in response to detecting the request for the second user 404 to join the multi-user communication session that includes the first user 402, the second electronic device 101b presents the audio notification 712b (e.g., a ring or a ringtone) that indicates that the first user 402 requests that the second user 404 join the multi-user communication session with the first user 402.

Furthermore, as shown in FIG. 7B, in response to detecting the request for the second user 404 to join the multi-user communication session that includes the first user 402, the second respective electronic device 101b-1 presents a notification (e.g., a visual notification) 714a that indicates that the first user 402 requests that the second user 404 join a multi-user communication session with the first user 402. Note that, in FIG. 7B, the second respective electronic device 101b-1 includes a display and audio output devices, and the second respective electronic device 101b-1 can present notifications via the display and/or audio output devices; however, in FIG. 7B, the second respective electronic device 101b-1 presents the notification (e.g., a visual notification) 714a that indicates that the first user 402 requests that the second user 404 join a multi-user communication session with the first user 402 solely via the display, without presenting an audio notification that indicates that the first user 402 requests that the second user 404 join the multi-user communication session with the first user 402, optionally to direct the first user 402 toward providing user input for accepting the request via the second electronic device 101b and not via the second respective electronic device 101b-1. In particular, if the second respective electronic device 101b-1 detects user input from the second user 404 accepting the request for the second user 404 to join the multi-user communication session with the first user 402, a multi-user communication session of the first type will be initiated between the first electronic device 101a and the second respective electronic device 101b-1, and if the second electronic device 101b detects user input from the second user 404 accepting the request for the second user 404 to join the multi-user communication session with the first user 402, a multi-user communication session of the second type will be initiated between the first electronic device 101a and the second electronic device 101b even though the first electronic device 101a and the second electronic device 101b are collocated in the physical environment 400. User experiences in the multi-user communication session of the second type between collocated users optionally are more desirable than user experiences of the first type between collocated users. For example, a multi-user communication session of the second type between collocated users in a physical environment is desirable for reducing issues that may arise from collocated electronic devices in a multi-user communication session of the first type (e.g., audio feedback, inconsistent spatial alignment of virtual content of the multi-user communication session, etc.). Thus, in some examples, different electronic devices associated with a collocated recipient present different types or sets of notifications that indicate that the first user 402 requests for the collocated recipient to join a multi-user communication session with the first user 402, and different types of multi-user communication sessions can be initiated based on which electronic device the collocated recipient uses to accept the request. These features are further illustrated and/or described with reference to FIGS. 7C and 7D below.

Likewise, as shown in FIG. 7B, in response to detecting the request for the third user 406 to join the multi-user communication session that includes the first user 402, the third electronic device 101c presents a user interface element 712c (e.g., a visual notification) that is selectable to accept the request and presents an audio notification 712d. In FIG. 7B, the user interface element 712c includes one or more characteristics described with reference to the user interface element 712a, but is selectable to accept the request from the first user 402 (“Bella”) for the third user 406 (“Charlie”) to join the multi-user communication session that includes the first user 402. The audio notification 712d (e.g., a ring or a ringtone) indicates that the first user 402 requests that the third user 406 (“Charlie”) join a multi-user communication session with the first user 402. The audio notification 712d includes one or more characteristics described with reference to the audio notification 712b.

Furthermore, as shown in FIG. 7B, in response to detecting the request for the third user 406 to join the multi-user communication session that includes the first user 402, the third respective electronic device 101c-1 presents a user interface element 714b (e.g., a visual notification) that indicates that the first user 402 requests that the third user 406 join a multi-user communication session with the first user 402 and an audio notification 714c that indicates that the first user 402 requests that the third user 406 join a multi-user communication session with the first user 402. The user interface element 714b includes one or more characteristics of the user interface element 714a. The third respective electronic device 101c-1 includes one or more characteristics described with reference to the second respective electronic device 101b-1. For example, the third respective electronic device 101c-1 optionally includes one or more characteristics described with reference to electronic devices 160/260. Additionally, unlike the second respective electronic device 101b-1, the third respective electronic device 101c-1 presents the audio notification 714c, which includes one or more characteristics described with reference to the audio notification 712d and the audio notification 712b, that indicates that the first user 402 requests that the third user 406 (“Charlie”) join a multi-user communication session with the first user 402. In some examples, both the third electronic device 101c and the third respective electronic device 101c-1 present an audio notification that indicates that the third user 406 (“Charlie”) is requested to join a multi-user communication session with the first user 402 because the request from the first electronic device 101a is of the second type. That is, as described above, the second type of request solely enables the third user 406 to join the multi-user communication session of the first type, without enabling the third user 406 to join the multi-user communication session of the second type, independent of the electronic device from which the third user 406 joins. Thus, in some examples, different electronic devices associated with a non-collocated recipient present notifications that indicate that the first user 402 requests for the collocated recipient to join a multi-user communication session with the first user 402, and the same type of multi-user communication session—a multi-user communication session of the first type as described herein—can be initiated independent of the specific electronic device from which the non-collocated recipient accepts the request. Note that the first electronic device 101a optionally includes one or more characteristics described with reference to electronic devices 101/201B/201B, the second electronic device 101b optionally includes one or more characteristics described with reference to electronic device 101/201B/201B, and the third electronic device 101c optionally includes one or more characteristics described with reference to electronic device 101/201B/201B.

Additionally, in FIG. 7B, the third electronic device 101c detects user input directed to the user interface element 712c. For example, in FIG. 7B, the third electronic device 101c detects attention 704c (e.g., gaze) of the third user 406 directed to the user interface element 712c while the hand 406a of the third user 406 performs an air pinch gesture. In response to detecting the user input, the third electronic device 101c optionally transmits, to the first electronic device 101a, an indication that the third user 406 accepts the request of the first user 402 to join the multi-user communication session. Alternatively, in FIG. 7B, the third respective electronic device 101c-1 detects the contact 717a of the hand 406a at a position on the display (e.g., touch-sensitive display) of the third respective electronic device 101c-1 that corresponds to selection of the user interface element 714b (e.g., the user interface element 714b that the third respective electronic device 101c-1 displays in FIG. 7B), which corresponds to the third user 406 accepting the request to join the multi-user communication session with the first user 402, without the third electronic device 101c detecting input corresponding to acceptance of the request. In response, the third respective electronic device 101c-1 transmits, to the first electronic device 101a, an indication that the third user 406 has accepted the request to join the multi-user communication session with the first user 402. In some examples, independent of the electronic device from which the third user 406 joins, the first electronic device 101a and the third electronic device 101c establish a multi-user communication session of the first type in response to the first electronic device 101a detecting the indication.

FIGS. 7C and 7D illustrate the first electronic device 101a initiating a multi-user communication session (e.g., a mixed multi-user communication session that includes a multi-user communication session of the first type and a multi-user communication session of the second type) in response to detecting an indication from the second electronic device 101b that the second user 404 has accepted the request to join the multi-user communication session with the first user 402 and an indication from an electronic device associated with the third user 406 that the third user 406 has accepted the request to join the multi-user communication session with the first user 402, according to some examples. For example, in FIG. 7B, the second electronic device 101b optionally detects input that corresponds to the second user 404 accepting the request to join the multi-user communication session with the first user 402, without the second respective electronic device 101b-1 detecting input corresponding to acceptance of the request. For example, in FIG. 7B, the second electronic device 101b detects input including attention 704b (e.g., gaze) of the first user 402 directed to the user interface element 712a while the hand 402a of the first user 402 performs an air pinch gesture. In response to the second electronic device 101b detecting the input in FIG. 7B, the second electronic device 101b transmits, to the first electronic device 101a, an indication that the second user 404 has accepted the request to join the multi-user communication session with the first user 402. In response to detecting the indication of acceptance from the second electronic device 101b, the first electronic device 101a initiates a process to establish a shared spatial coordinate system of the physical environment 400 between the first electronic device 101a and the second electronic device 101b, as shown with glyph 720 in FIG. 7C, and such as described below.

In some examples, the process to establish the shared spatial coordinate system of the physical environment 400 between the first electronic device 101a and the second electronic device 101b includes aligning first map data of the physical environment 400 determined by the first electronic device 101a (e.g., determined by the first electronic device 101a relative to a viewpoint of the first electronic device 101a) with second map data of the physical environment 400 determined by the second electronic device 101b (e.g., determined by the second electronic device 101b relative to a viewpoint of the second electronic device 101b) to establish the shared spatial coordinate system of the physical environment 400 between the first electronic device 101a and the second electronic device 101b. In some examples, the process to establish the shared spatial coordinate system of the physical environment 400 between the first electronic device 101a and the second electronic device 101b includes detecting image data of the physical environment 400 via one or more sensors of the first electronic device 101a and detecting image data of the physical environment 400 via one or more sensors of the second electronic device 101b, and then merging and/or aligning the image data to create and/or determine the shared spatial coordinate system of the physical environment 400. For example, the first electronic device 101a transmits, to the second electronic device 101b, the image data of the physical environment 400 captured via the one or more sensors of the first electronic device 101a, and the second electronic device 101b transmits, to the first electronic device 101a, the image data of the physical environment 400 captured via the one or more sensors of the second electronic device 101b. In some examples, establishing the shared spatial coordinate system of the physical environment 400 includes one or more characteristics described above with reference to blocks (e.g., operations) 414, 416, 418, and/or 420 in FIG. 4C. If the shared spatial coordinate system of the physical environment 400 is successfully established between the first electronic device 101a and the second electronic device 101b in the physical environment 400, the first electronic device 101a and the second electronic device 101b establish a multi-user communication session of the second type with each other while in the multi-user communication session of the first type with the third electronic device 101c, as shown in FIG. 7D.

In FIG. 7D, a multi-user communication session of the second type is established between the first electronic device 101a and the second electronic device 101b (e.g., between the first user 402 and the second user 404), as shown in glyph 722a, while a multi-user communication session of the first type that includes the first electronic device 101a, the second electronic device 101b, and the third electronic device 101c is established, as shown in glyph 722b. Accordingly, from FIG. 7A to FIG. 7B to FIG. 7C to FIG. 7D, the first electronic device 101a establishes a multi-user communication session of the second type with the second user 404 in response to detecting the indication that the second user 404 has accepted the request to join the multi-user communication session with the first user 402 from the second electronic device 101b and establishes a multi-user communication session of the first type with the third user 406 in response to detecting the indication that the third user 406 has accepted the request to the multi-user communication session with the first user 402, and the multi-user communication session of the first type in FIG. 7D includes the first user 402, the second user 404, and the third user 406. For example, in the multi-user communication session of the first type in FIG. 7D, the first user 402 and the second user 404 are in a first spatial group and the third user 406 is in a spatial group that is different from the first spatial group. For example, as shown in FIG. 7D, the first electronic device 101a presents a visual representation (e.g., avatar 724) of the third user 406 and the second electronic device 101b presents a visual representation (e.g., avatar 724) of the third user 406 at the same corresponding location in the physical environment 400 using a shared spatial coordinate system of the physical environment 400 between the first electronic device 101a and the second electronic device 101b.

FIG. 7D-1 illustrates the first electronic device 101a and the second electronic device 101b presenting a user interface 434a of a photos application (e.g., shared virtual content) at a similar (e.g., the same) corresponding location in the physical environment 400 using the shared spatial coordinate system of the physical environment 400 established between the first electronic device 101a and the second electronic device 101b while in the multi-user communication session with each other, as indicated by glyphs 722a/722b. In some examples, the user interface 434a of the photos application includes one or more characteristics of the user interface 434. Note that the user interface 434a of the photos application is representative; for example, a user interface of a messaging application, of a content playback application, such as a video playback application or a music playback application, or a user interface of another type of application could alternatively be shared. Additionally, FIG. 7D-1 illustrates the first electronic device 101a and the second electronic device 101b presenting the avatar 724 of the third user 406 at a similar (e.g., the same) corresponding location in the physical environment 400 using the shared spatial coordinate system of the physical environment 400 established between the first electronic device 101a and the second electronic device 101b while in the multi-user communication session with each other, as indicated by glyphs 722a/722b. Accordingly, collocated electronic devices in a multi-user communication session can align presentation of shared content of the multi-user communication session using the shared spatial coordinate system of the physical environment 400 established between the collocated electronic devices.

FIGS. 7B and 7E illustrate the first electronic device 101a initiating a multi-user communication session of the first type in response to detecting an indication from the second respective electronic device 101b-1 that the second user 404 has accepted the request to join the multi-user communication session with the first user 402 and an indication from an electronic device associated with the third user 406 that the third user 406 has accepted the request to join the multi-user communication session with the first user 402, according to some examples. For example, in FIG. 7B, alternatively, the second respective electronic device 101b-1 detects the contact 717b of the hand 404a at a position on the display (e.g., touch-sensitive display) of the second respective electronic device 101b-1 that corresponds to selection of the user interface element 714a, which corresponds to the second user 404 accepting the request to join the multi-user communication session with the first user 402, without the second electronic device 101b detecting input corresponding to acceptance of the request. In response, the second respective electronic device 101b-1 transmits, to the first electronic device 101a, an indication that the second user 404 has accepted the request to join the multi-user communication session with the first user 402. In response to detecting the indication of acceptance from the second respective electronic device 101b-1, the first electronic device 101a initiates a multi-user communication session of the first type between the first electronic device 101a and the second electronic device 101b (e.g., between the first user 402 and the second user 404) even though the first user 402 and the second user 404 are with each other (e.g., collocated) in the physical environment 400, as shown in FIG. 7C. Likewise, in response to detecting an indication of acceptance of the request for the third user 406 to join the multi-user communication session with the first user 402, the first electronic device 101a initiates a multi-user communication session of the first type between the first electronic device 101a and the third electronic device 101c (e.g., between the first user 402 and the third user 406). Accordingly, from FIG. 7A to FIG. 7B to FIG. 7E, the first electronic device 101a establishes a multi-user communication session of the first type with the second user 404 in response to detecting the indication that the second user 404 has accepted the request to join the multi-user communication session with the first user 402 from the second respective electronic device 101b-1 and establishes a multi-user communication session of the first type with the first user 402 in response to detecting the indication that the third user 406 has accepted the request to the multi-user communication session with the first user 402, and the multi-user communication session of the first type in FIG. 7E includes the first user 402, the second user 404, and the third user 406. Thus, in FIG. 7E, a multi-user communication session of the first type is established between the first electronic device 101a, the second electronic device 101b, and the third electronic device 101c (e.g., between the first user 402, the second user 404, and the third user 406). For example, in FIG. 7E, the first user 402, the second user 404, and the third user 406 are in the same spatial group, such as described with reference to FIG. 3. Additionally, while in the multi-user communication session with the first user 402 and the second user 404, the first electronic device 101a concurrently presents a visual representation 725 (e.g., a two-dimensional tile) of the second user 404 that optionally includes video feed from a camera of the second respective electronic device 101b-1, and the avatar 724 of the third user 406.

Furthermore, as shown in FIG. 7E, the second respective electronic device 101b-1 presents a visual representation of other users in the multi-user communication session of the first type. For example, in FIG. 7E, the second respective electronic device 101b-1 presents a visual representation 725a of the first user 402 and a visual representation 725b of the third user 406.

FIG. 7E-1 illustrates the first electronic device 101a and the second electronic device 101b presenting the user interface 434a (e.g., shared virtual content) at different locations in the physical environment 400 while in the multi-user communication session of the first type, as indicated by glyph 722a (e.g., and without being in a multi-user communication session of the second type). In some examples, the first electronic device 101a and the second electronic device 101b present the user interface 434a at different locations in the physical environment 400 because the first electronic device 101a and the second electronic device 101b have not established a shared spatial coordinate system of the physical environment 400. Additionally, FIG. 7E-1 illustrates the first electronic device 101a and the second electronic device 101b presenting the avatar 724 of the third user 406 at different locations in the physical environment 400 while in the multi-user communication session of the first type, as indicated by glyph 722a (e.g., and without being in a multi-user communication session of the second type). In some examples, the first electronic device 101a and the second electronic device 101b present the avatar 724 of the third user 406 at different locations in the physical environment 400 because the first electronic device 101a and the second electronic device 101b have not established a shared spatial coordinate system of the physical environment 400. Accordingly, non-collocated electronic devices (e.g., electronic devices that have not established a shared spatial coordinate system of the physical environment in which the electronic devices are commonly located) in a multi-user communication session present shared content of the multi-user communication session without spatial alignment between presentation of the shared content, which reduces processing power associated with presenting shared content of the multi-user communication session between the non-collocated electronic devices.

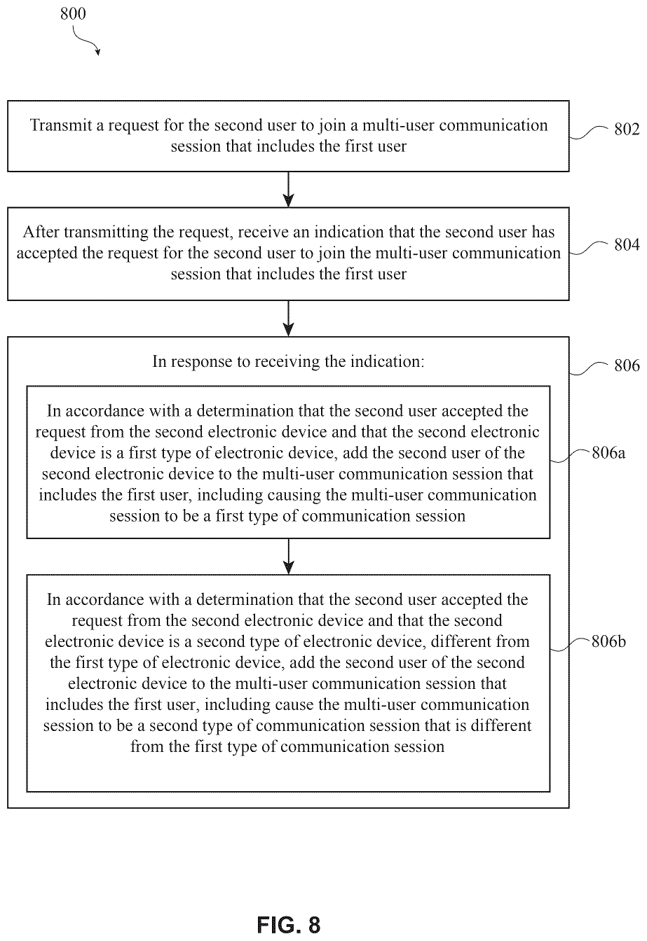

FIG. 8 illustrates a flow diagram illustrating a method 800 for initiating different types of multi-user communication sessions with a second user of a second electronic device based on a type of electronic device from which the second user of the second electronic device accepts a request to join a multi-user communication session with a first user of a first electronic device, according to some examples. In some examples, method 800 begins at a first electronic device in communication with one or more first displays and one or more first input devices. In some examples, the first electronic device includes one or more characteristics of the first electronic device 101a in FIGS. 7A through 7E-1. One or more examples of method 800 are illustrated and/or described above with reference to one or more of FIGS. 7A through 7E-1. It is understood that method 800 is an example and that more, fewer, or different operations can be performed in the same or in a different order. Additionally, the operations in method 800 described below are, optionally, implemented by running one or more functional modules in an information processing apparatus such as general-purpose processors (e.g., as described with respect to FIGS. 2A-2C) or application specific chips, and/or by other components of FIGS. 2A-2C.

Therefore, according to the above, some examples of the disclosure are directed to a method (e.g., method 800 of FIG. 8). In some examples, the method 800 is performed at a first electronic device in communication with one or more first displays and one or more first input devices. In some examples, a first user of the first electronic device is collocated with a second user of a second electronic device in a physical environment, such as described with reference to the first user 402 of the first electronic device 101a being collocated with the second user 404 of the second electronic device 101b in the physical environment 400 in FIG. 7A. The method 800 includes, transmitting (802) a request for the second user to join a multi-user communication session that includes the first user, such as described with reference to the first electronic device 101a transmitting a request for the second user 404 to join a multi-user communication session with the first user 402 in response to the input directed to the option 702 in FIG. 7A. The method 800 includes, after transmitting the request, receiving (804) an indication that the second user has accepted the request for the second user to join the multi-user communication session that includes the first user, such as described with reference to the first electronic device 101a receiving the indication from the second electronic device 101b that indicates that the second user 404 has accepted the request for the second user 404 to join the multi-user communication session with the first user 402 in response to the input directed to the user interface element 712a in FIG. 7B. The method 800 includes, in response to receiving the indication (806), in accordance with a determination that the second user accepted the request from (e.g., via) the second electronic device and that the second electronic device is a first type of electronic device, adding (806a) the second user of the second electronic device to the multi-user communication session that includes the first user, including causing the multi-user communication session to be a first type of communication session, such as described with reference to the first electronic device 101a adding the second user 404 to a multi-user communication session of the second type from FIG. 7A to FIG. 7B to FIG. 7C to FIG. 7D. The method 800 includes, in response to receiving the indication (806), in accordance with a determination that the second user accepted the request from (e.g., via) the second electronic device and that the second electronic device is a second type of electronic device, different from the first type of electronic device, and that the second user accepted the request from the second electronic device, adding (806b) the second user of the second electronic device to the multi-user communication session that includes the first user, including causing the multi-user communication session to be a second type of communication session that is different from the first type of communication session, such as described with reference to the first electronic device 101a adding the second user 404 to a multi-user communication session of the first type from FIG. 7A to FIG. 7B to FIG. 7E.

Additionally or alternatively, in some examples, the second user of the second electronic device in the physical environment is also a user of a third electronic device, different from the second electronic device, in the physical environment, such as described with reference to the second user 404 being a user of the second electronic device 101b and a user of the second respective electronic device 101b-1 in FIG. 7A. Additionally or alternatively, in some examples, transmitting the request for the second user to join the multi-user communication session that includes the first user includes, transmitting, to the second electronic device, a request for the second user to join the multi-user communication session that includes the first user via the second electronic device, such as described with reference to the first electronic device 101a transmitting the request to the second electronic device 101b in response to the input in FIG. 7A, and transmitting, to the third electronic device, a request for the second user to join the multi-user communication session that includes the first user via the third electronic device, such as described with reference to the first electronic device 101a transmitting the request to the second respective electronic device 101b-1 in response to the input in FIG. 7A. Additionally or alternatively, in some examples, the method 800 includes, in accordance with a determination that the second user accepted the request from (e.g., via) the third electronic device and that the third electronic device is the second type of electronic device, adding the second user to the multi-user communication session that includes the first user, including causing the multi-user communication session to be the second type of communication session, such as described with reference to the second user 404 accepting the request to join the multi-user communication session with the first user 402 via the second respective electronic device 101b-1.

Additionally or alternatively, in some examples, the second user of the second electronic device in the physical environment is also a user of a third electronic device, different from the second electronic device, in the physical environment, where the third electronic device is a different type of electronic device from the second electronic device and is the first type of electronic device or the second type of electronic device, such as described with reference to the second user 404 being a user of the second electronic device 101b and a user of the second respective electronic device 101b-1 in FIG. 7A. Additionally or alternatively, in some examples, transmitting the request for the second user to join the multi-user communication session that includes the first user includes, transmitting, to the second electronic device, the request for the second user to join the multi-user communication session that includes the first user, including causing the second electronic device to present a first notification to the second user for notifying the second user of the request for the second user to join the multi-user communication session that includes the first user, such as the second electronic device 101b presenting the user interface element 712a in FIG. 7B. Additionally or alternatively, in some examples, transmitting the request for the second user to join the multi-user communication session that includes the first user includes, transmitting, to the third electronic device, the request for the second user to join the multi-user communication session that includes the first user, causing the third electronic device to present a second notification to the second user for notifying the second user of the request for the second user to join the multi-user communication session that includes the first user, such as the second respective electronic device 101b-1 presenting the user interface element 714a (e.g., notification) in FIG. 7B.

Additionally or alternatively, in some examples, the first notification is a first type of notification, such as the audio notification 712b in FIG. 7B, and the second notification of a second type of notification that is different from the first type of notification, such as the user interface element 712a (e.g., visual notification) in FIG. 7B. Additionally or alternatively, in some examples, the second electronic device is the first type of electronic device, such as the second electronic device 101b in FIG. 7B, the first type of notification includes audio, such as the audio notification 712b in FIG. 7B, and the second type of notification does not include audio, such as the user interface element 714a in FIG. 7B.

Additionally or alternatively, in some examples, causing the multi-user communication session that includes the first user to be the second type of communication session includes displaying, via the one or more first displays, a virtual representation of the second user of the second electronic device, such as the visual representation 725 of the second user 404 (“Alice”) in FIG. 7E. Additionally or alternatively, in some examples, causing the multi-user communication session that includes the first user to be the first type of communication session includes presenting, via the one or more first displays, the second user, without displaying the virtual representation of the second user of the second electronic device, such as shown presentation of the physical body of the second user 404 in the field of view of the display 120a of the first electronic device 101a without the first electronic device 101a of FIG. 7D presenting the visual representation 725 of the second user 404 (“Alice”) of FIG. 7E.

Additionally or alternatively, in some examples, causing the multi-user communication session that includes the first user to be the second type of communication session includes initiating a process to present, via one or more first audio output devices of the first electronic device, detected audio of the second user, such as described herein with reference to the first type of multi-user communication session (e.g., in FIG. 3). Additionally or alternatively, in some examples, causing the multi-user communication session that includes the first user to be the first type of communication session includes forgoing initiating the process, including forgoing presentation of audio of the second user, such as described herein with reference to the second type of multi-user communication session (e.g., in FIGS. 4H and/or 7D).

Additionally or alternatively, in some examples, causing the multi-user communication session that includes the first user to be the first type of communication session includes initiating a process to establish a shared spatial coordinate system of the physical environment between the first electronic device and the second electronic device, such as described with reference to the first electronic device 101a establishing a shared spatial coordinate system of the physical environment 400 with the second electronic device 101b in FIG. 7C. Additionally or alternatively, in some examples, the shared spatial coordinate system of the physical environment is based on first map data determined by the first electronic device relative to a viewpoint of the first electronic device, such as described with reference to the first electronic device 101a in FIG. 7C, and second map data determined by the second electronic device relative to a viewpoint of the second electronic device, such as described with reference to the second electronic device 101b in FIG. 7C. Additionally or alternatively, in some examples, causing the multi-user communication session that includes the first user to be the second type of communication session includes forgoing initiating the process to establish the shared spatial coordinate system of the physical environment. For example, the first electronic device 101a and the second electronic device 101b do not establish a shared spatial coordinate system of the physical environment 400 from FIG. 7B to FIG. 7E because the multi-user communication session in which the first electronic device 101a and the second electronic device 101b in FIG. 7E participate is a multi-user communication session of the first type (and is not a multi-user communication session of the second type).

Additionally or alternatively, in some examples, the method 800 includes, adding, after adding the second user of the second electronic device to the multi-user communication session that includes the first user, a third user of a third electronic device to the multi-user communication session that includes the first user and the second user, where the third user of the third electronic device is not collocated in the physical environment with the first user. For example, the first electronic device 101a optionally detects an indication that the third user 406 of the third electronic device 101c in FIG. 7B has accepted the request of the first user 402 to join the multi-user communication session that includes the first user 402 after detecting an indication that the second user 404 has accepted the request of the first user 402 to join the multi-user communication session that includes the first user 402. Continuing with this example, in response to detecting the indication that the second user 404 has accepted the request of the first user 402 to join the multi-user communication session that includes the first user 402, the first electronic device 101a adds the second user 404 to the multi-user communication session, and in response to detecting the indication that the third user 406 of the third electronic device 101c has accepted the request of the first user 402 to join the multi-user communication session that includes the first user 402, the first electronic device 101a adds the third user 406, which is optionally after the adding of the second user 404.

Additionally or alternatively, in some examples, the method 800 includes, after adding the third user of the third electronic device to the multi-user communication session that includes the first user and the second user, in accordance with a determination that the second electronic device is the first type of electronic device, transmitting, to the third electronic device, an indication that the first user of the first electronic device and the second user of the second electronic device are in a first spatial group in the multi-user communication session that is different from a second spatial group in the multi-user communication session in which the third electronic device participates. For example, in response to detecting the indication that the first user 402 and the second user 404 are in a first spatial group that is different from a second spatial group in the multi-user communication session in which the third electronic device participates in FIG. 7D, the third electronic device 101c of FIG. 7D optionally presents, in a three-dimensional environment of the third electronic device 101c, representations (e.g., avatars) of the first user 402 and the second user 404 in a spatial arrangement that is based on their spatial arrangement in the physical environment 400. Additionally or alternatively, in some examples, the method 800 includes, after adding the third user of the third electronic device to the multi-user communication session that includes the first user and the second user, in accordance with a determination that the second electronic device is the second type of electronic device, transmitting, to the third electronic device, an indication that the first user of the first electronic device and the second user of the second electronic device are in the second spatial group with the third electronic device. For example, in response to detecting the indication that the first user 402 and the second user 404 are in the same spatial group with the third user 406 in FIG. 7E, the third electronic device 101c of FIG. 7E optionally presents, in a three-dimensional environment of the third electronic device 101c, representations (e.g., avatars) of the first user 402 and the second user 404 in a spatial arrangement that does not consider (e.g., is not based on or is independent of) a spatial arrangement of the first user 402 and the second user 404 in the physical environment 400.

Additionally or alternatively, in some examples, the method 800 includes, while the multi-user communication session includes the first user and the second user, displaying, via the one or more first displays, shared virtual content of the multi-user communication session, including a user interface of the application, at a first location in a first three-dimensional environment of the first electronic device. For example, in FIG. 7D-1, the first electronic device 101a shares, in the multi-user communication session that includes the first user 402, the second user 404, and the third user 406, the user interface 434a that is being displayed in the first three-dimensional environment presented via the first electronic device 101a. Additionally or alternatively, in some examples, in accordance with a determination that the second electronic device is the first type of electronic device, the first location is a first shared location in a shared spatial coordinate system of the physical environment between the first electronic device and the second electronic device, such as the first electronic device 101a and the second electronic device 101b presenting the user interface 434a at the same corresponding physical location in the physical environment 400 using the shared spatial coordinate system of the physical environment 400 between the first electronic device 101a and the second electronic device 101b in FIG. 7D-1. Additionally or alternatively, in some examples, in accordance with a determination that the second electronic device is the second type of electronic device, the first location is not a respective shared location in the shared spatial coordinate system of the physical environment, such as the first electronic device 101a and the second electronic device 101b presenting the user interface 434a at different corresponding physical locations (e.g., in different manners) in the physical environment 400 in FIG. 7E-1, which is optionally because the first electronic device 101a and the second electronic device 101b have not established a shared spatial coordinate system of the physical environment 400 in FIG. 7E-1.

Additionally or alternatively, in some examples, the first type of electronic device is a head-mounted device, such as described with reference to the first electronic device 101a in FIG. 7A. Additionally or alternatively, in some examples, the second type of electronic device is a phone, laptop computer, or tablet, such as described with reference to the second respective electronic device 101b-1. In some examples, the second type of electronic device is a handheld device or a wrist device, such as a watch.

Some examples of the disclosure are directed to an electronic device, comprising: one or more processors; memory; and one or more programs stored in the memory and configured to be executed by the one or more processors, the one or more programs including instructions for performing any of the above methods. Some examples of the disclosure are directed to a non-transitory computer readable storage medium storing one or more programs, the one or more programs comprising instructions, which when executed by one or more processors of an electronic device, cause the electronic device to perform any of the above methods. Some examples of the disclosure are directed to an electronic device, comprising one or more processors, memory, and means for performing any of the above methods. Some examples of the disclosure are directed to an information processing apparatus for use in an electronic device, the information processing apparatus comprising means for performing any of the above methods.

FIGS. 9A through 9F generally illustrate examples of a first electronic device detecting and responding to a third user of a third electronic device being collocated in a physical environment with a first user of the first electronic device while in a multi-user communication session that includes the first user of the first electronic device and a second user of a second electronic device, without including the third user of the third electronic device, where the first user and the second user are collocated in the physical environment, and where a shared spatial coordinate system of the physical environment between the first electronic device and the second electronic device is established, according to some examples of the disclosure.

In FIG. 9A, the first user 402 of the first electronic device 101a and the second user 404 of the second electronic device 101b are in a multi-user communication session of the second type, as indicated by glyph 901a. The multi-user communication session of the second type in FIG. 9A is hosted on (e.g., communicated via) a first networking channel (e.g., a first communication protocol, such as Wi-Fi, a first type of BLUETOOTH communication protocol, and/or another type of networking channel). For example, communications between the first electronic device 101a and the second electronic device 101b that involve the multi-user communication session of the second type are hosted on the first networking channel. For example, the first electronic device 101a and the second electronic device 101b detect and respond to communications between each other in the multi-user communication session of the second type using receivers, transmitters, and/or transceivers of the first electronic device 101a and the second electronic device 101b that are configured for operation with data that use the first networking channel (e.g., data that is encoded and/or transmitted or received on the first networking channel).

In FIG. 9A, the first user 402 and the second user 404 are collocated in the physical environment 400, such as described with reference to the first electronic device 101a and the second electronic device 101b being collocated in a physical environment (e.g., the physical environment 400 of FIG. 4A). Additionally, in FIG. 9A, the first electronic device 101a and the second electronic device 101b are presenting the first user interface at the same corresponding location in the physical environment 400 using the shared spatial coordinate system of the physical environment 400 that is established between the first electronic device 101a and the second electronic device 101b (e.g., the established shared spatial coordinate system of the physical environment 400 indicated in glyph 901b). In some examples, the shared spatial coordinate system of the physical environment 400 between the first electronic device 101a and the second electronic device 101b is established according to the process to establish the shared spatial coordinate system of the physical environment 400 between the first electronic device 101a and the second electronic device 101b described above. For instance, in some examples, the process to establish the shared spatial coordinate system of the physical environment 400 between the first electronic device 101a and the second electronic device 101b includes aligning first map data of the physical environment 400 determined by the first electronic device 101a with second map data of the physical environment 400 determined by the second electronic device 101b to establish the shared spatial coordinate system of the physical environment 400 between the first electronic device 101a and the second electronic device 101b. In some examples, the process to establish the shared spatial coordinate system of the physical environment 400 between the first electronic device 101a and the second electronic device 101b includes detecting image data of the physical environment 400 via one or more sensors of the first electronic device 101a and detecting image data of the physical environment 400 via one or more sensors of the second electronic device 101b, and then merging and/or aligning the image data to create and/or determine the shared spatial coordinate system of the physical environment 400. For example, the first electronic device 101a transmits, to the second electronic device 101b, the image data of the physical environment 400 captured via the one or more sensors of the first electronic device 101a, and the second electronic device 101b transmits, to the first electronic device 101a, the image data of the physical environment 400 captured via the one or more sensors of the second electronic device 101b.

The shared spatial coordinate system of the physical environment 400 in FIG. 9A is hosted on (e.g., communicated via) a second networking channel that is different from the first networking channel (e.g., a second communication protocol, such as Wi-Fi, a second type of BLUETOOTH communication protocol, and/or another type of networking channel). For example, the shared spatial coordinate system of the physical environment 400 is established and/or updated by the first electronic device 101a and the second electronic device 101b using the second networking channel. For example, communications between the first electronic device 101a and the second electronic device 101b that involve the shared spatial coordinate system of the physical environment 400 between the first electronic device 101a and the second electronic device 101b and/or that involve the process to establish the shared spatial coordinate system of the physical environment 400 between the first electronic device 101a and the second electronic device 101b are hosted on the second networking channel. For example, the first electronic device 101a and the second electronic device 101b detect and respond to communications between each other relating to the shared spatial coordinate system of the physical environment 400 between the first electronic device 101a and the second electronic device 101b and/or relating to the establishment thereof using receivers, transmitters, and/or transceivers of the first electronic device 101a and the second electronic device 101b that are configured for operation with data that use the second networking channel (e.g., data that is encoded and/or transmitted or received on the second networking channel). Accordingly, in some examples, the first electronic device 101a and the second electronic device 101b include communication systems that permit different types of communications on different networking channels between each other, such as shown in glyphs 901a/901b in FIG. 9A.

In some examples, in FIG. 9A, the user interface 434a is shared from the first electronic device 101a to the second electronic device 101b in one or more sharing conditions. For example, provided that the first user 402 enabled editing of the user interface 434a, the second user 404 can interact with the user interface 434a by moving the user interface 434a in the three-dimensional environment of the second electronic device 101b and/or editing the content of the user interface 434a, either of which would optionally result in a corresponding change in three-dimensional environment presented via the first electronic device 101a (e.g., a corresponding change in the position of the user interface 434a in the three-dimensional environment presented via the first electronic device 101a and/or in the content of the user interface 434a in the three-dimensional environment presented via the first electronic device 101a). As another example, provided that the first user 402 enabled viewing without editing of the user interface 434a, the second user 404 can interact with the user interface 434a by viewing the content of the user interface 434a, without editing capabilities. Note that the user interface 434a is optionally shared from the first electronic device 101a to the second electronic device 101b using the first networking channel described above, since the user interface 434a is being shared in the multi-user communication session of the second type between the first electronic device 101a and the second electronic device 101b. In some examples, the user interface 434a is shared from the second electronic device 101b to the second electronic device 101b in one or more sharing conditions.

From FIG. 9A to FIG. 9B, the third user 406 of the third electronic device 101c enters the physical environment 400 in which the first user 402 and the second user 404 are located. In FIG. 9B, the third user 406 is not in a multi-user communication session with the first user 402 and/or the second user 404. For example, in FIG. 9B, the third user 406 is not in the multi-user communication session (e.g., the multi-user communication session of the second type) in which the first user 402 and the second user 404 participate, as shown in glyph 901a.

Additionally, in FIG. 9B, the first electronic device 101a detects (or determines) that the third user 406 and the first user 402 (e.g., the first electronic device 101a and the third electronic device 101c) are collocated in the physical environment 400, such as described with reference to herein with reference to the first electronic device 101a and the second electronic device 101b being collocated in a physical environment (e.g., the physical environment 400 of FIG. 4A). For example, the first electronic device 101a and the third electronic device 101c are collocated in FIG. 9A because the first electronic device 101a and the third electronic device 101c satisfy the determination criteria described with reference to FIG. 4A. For example, the first electronic device 101a and the third electronic device 101c are determined to be collocated in the physical environment 400 in FIG. 9A optionally based on a distance between the first electronic device 101a and the third electronic device 101c, based on communication between the first electronic device 101a and the third electronic device 101c, based on a strength of a wireless signal transmitted and detected between the first electronic device 101a and the third electronic device 101c, based on the first electronic device 101a and the third electronic device 101c being connected to a same network (e.g., wireless network) in the physical environment 716, based on visual detection of the first electronic device 101a and the third electronic device 101c in the physical environment 400, based on the user of the other electronic device being in a contact list of the electronic device (e.g., the third user 406 being in a contact list of an application on the first electronic device 101a and/or the first user 402 being in a contact list of an application on the third electronic device 101c), and/or because the first electronic device 101a and the third electronic device 101c are in the same physical room (e.g., the physical environment 716). In response to detecting that the third user 406 is collocated with the first user 402 in the physical environment 400, the first electronic device 101a transmits, to the third electronic device 101c, the shared spatial coordinate system of the physical environment 400 between the first electronic device 101a and the second electronic device 101b, as indicated with glyph 901c in FIG. 9C. In some examples, the first electronic device 101a transmits, to the third electronic device 101c, the shared spatial coordinate system of the physical environment 400 between the first electronic device 101a and the second electronic device 101b using the second networking channel described above.

In some examples, transmitting, to the third electronic device 101c, the shared spatial coordinate system of the physical environment 400 between the first electronic device 101a and the second electronic device 101b, as indicated with glyph 901c in FIG. 9C, includes transmitting, to the third electronic device 101c, map data of the physical environment 400 captured between the first electronic device 101a and the second electronic device 101b. For example, the map data of the physical environment 400 is optionally based on first map data determined by the first electronic device 101a relative to a viewpoint of the first electronic device 101a in the physical environment 400 and second map data determined by the second electronic device 101b relative to a viewpoint of the second electronic device 101b in the physical environment 400. For example, the first electronic device 101a optionally captures portions of the physical environment 400 surrounding the first electronic device 101a using one or more sensors of the first electronic device 101a in order to determine a mapping of the physical environment 400 from the viewpoint of the first electronic device 101a in the physical environment 400. Continuing with this example, the second electronic device 101b optionally captures portions of the physical environment 400 surrounding the second electronic device 101b using one or more sensors of the second electronic device 101b in order to determine a mapping of the second electronic device 101b from the viewpoint of the second electronic device 101b in the physical environment 400. In some examples, the shared spatial coordinate system of the physical environment 400 includes and/or is based on the SLAM map data from the first electronic device 101a and/or the second electronic device 101b, as described above. Accordingly, in some examples, while in a multi-user communication session with the second electronic device 101b and without the third electronic device 101c, the first electronic device 101a transmits, to the third electronic device 101c, the shared spatial coordinate system of the physical environment 400 that is being utilized between the first electronic device 101a and the second electronic device 101b in the multi-user communication session.

In some examples, while and/or after transmitting, to the third electronic device 101c, the shared spatial coordinate system of the physical environment 400 between the first electronic device 101a and the second electronic device 101b, the first electronic device 101a detects and responds to user input requesting to add the third user 406 to the multi-user communication session in which the first electronic device 101a participates with the second electronic device 101b, as shown in FIG. 9D. In FIG. 9D, the first electronic device 101a detects input that corresponds to a request to add the third user 406 to the multi-user communication session that includes the first user 402 and the second user 404. For example, the first electronic device 101a detects attention 904a (e.g., gaze) of the first user 402 directed to the user interface element 902a while the hand 402a of the first user 402 performs an air pinch gesture. In response to detecting the input, the first electronic device 101a transmits, to the third electronic device 101c, an indication that the first user 402 requests for the third user 406 to join the multi-user communication session with the first user 402. In response to detecting the indication that the first user 402 requests for the third user 406 to join the multi-user communication session, the third electronic device 101c notifies the third user 406, such as shown in FIG. 9E.

In FIG. 9E, the third electronic device 101c notifies the third user 406 of the request of the first user 402 for the third user 406 to join a multi-user communication session that includes the first user 402 by presenting a user interface element 902b. In some examples, the user interface element 902b provides the third user 406 with options to accept or deny the request. In some examples, if the third electronic device 101c detects user input from the third user 406 that corresponds to denial of the request, such as user input directed to an option that is selectable to deny the request, the third electronic device 101c would transmit, to the first electronic device 101a, an indication that the third user 406 denies the request to join the multi-user communication session. In FIG. 9E, the third electronic device 101c detects user input from the third user 406 that corresponds to acceptance of the request. For example, in FIG. 9E, the third electronic device 101c detects attention 904b (e.g., gaze) of the third user 406 directed to the user interface element 902b while the hand 406a of the third user 406 performs an air pinch gesture. In response, the third electronic device 101c transmits, to the first electronic device 101a, an indication that the third user 406 accepts the request of the first user 402 for the third user 406 to join the multi-user communication session.

Note that the request of the first user 402 for the third user 406 to join the multi-user communication session that includes the first user 402 is a request of the first user 402 for the third user 406 to join a multi-user communication session of the second type. As described above, multi-user communication sessions of the second type involve establishments of shared spatial coordinate systems of the physical environments of the electronic devices that participate in the multi-user communication sessions of the second type with each other. In some examples, the process for establishing a shared spatial coordinate system of a physical environment is initiated before a user accepts a request to join the multi-user communication session of the second type, such as shown with the transmission of the shared spatial coordinate system of the physical environment 400 between the first electronic device 101a and the second electronic device 101b to the third electronic device 101c, which is not party to the multi-user communication session of the second type that includes the first user 402 and the second user 404, as described with reference to glyph 901c in FIG. 9C. For example, the shared spatial coordinate system of the physical environment 400 that is being utilized in the multi-user communication session of the second type between the first electronic device 101a and the second electronic device 101b in FIG. 9A and that does not include map data captured by the third electronic device 101c is transmitted from the first electronic device 101a to the third electronic device 101c before the first electronic device 101a transmits a request for the third user 406 to join the multi-user communication session of the second type with the first user 402 and the second user 404.

In FIG. 9F, the first electronic device 101a adds the third user 406 to the multi-user communication session of the second type that includes the first user 402 and the second user 404 (e.g., in response to detecting the indication from the third electronic device 101c that the third user 406 has accepted the request). Additionally, the third electronic device 101c displays the user interface 434a at the same corresponding location in the physical environment 400 that the first electronic device 101a and the second electronic device 101b display the user interface 434a, using the shared spatial coordinate system of the physical environment 400. In some examples, when the third electronic device 101c initially displays the user interface 434a, the third electronic device 101c displays the user interface 434a using the shared spatial coordinate system of the physical environment 400 between the first electronic device 101a and the second electronic device 101b. In some examples, the shared spatial coordinate system of the physical environment 400 that the first electronic device 101a transmits to the third electronic device 101c is the mapping of the physical environment 400—which is the same physical environment 400 in which the third user 406 is located—that solely the first electronic device 101a and the second electronic device 101b developed (e.g., that solely the electronic devices that are party to the multi-user communication session of the second type developed before the adding of the third user 406 to the multi-user communication session). In some examples, when the third electronic device 101c initially displays the user interface 434a, the third electronic device 101c displays the user interface 434a using a shared spatial coordinate system of the physical environment 400 that is based on map data of the physical environment 400 captured via sensors of the third electronic device 101c, in addition to map data of the physical environment 400 that is captured via sensors of the first electronic device 101a and map data of the physical environment 400 that is captured via sensors of the second electronic device 101b. In some examples, when the third electronic device 101c is added to the multi-user communication session that includes the first user 402 and the second user 404 (e.g., that includes the first electronic device 101a and the second electronic device 101b), the third electronic device 101c updates the shared spatial coordinate system of the physical environment 400 to be based on the map data of the physical environment 400 captured via sensors of the third electronic device 101c, in addition to map data of the physical environment 400 that is captured via sensors of the first electronic device 101a and map data of the physical environment 400 that is captured via sensors of the second electronic device 101b. For example, the shared spatial coordinate system of the physical environment 400 by which the first electronic device 101a displays the user interface 434a in FIG. 9F is optionally updated with map data from the third electronic device 101c. Likewise, the shared spatial coordinate system of the physical environment 400 by which the second electronic device 101b display the user interface 434a in FIG. 9F is optionally updated with map data from the third electronic device 101c. For example, when the third user 406 is added to the multi-user communication session that includes the first user 402 and the second user 404, the third electronic device 101c transmits, to the first electronic device 101a and/or the second electronic device 101b, map data of the physical environment 400 that is captured via sensors of the third electronic device 101c, and this transmission is optionally on the second networking channel—the same networking channel on which the first electronic device 101a and the second electronic device 101b communicate the shared spatial coordinate system of the physical environment 400 with each other, as described with reference to glyph 901b. In some examples, the first electronic device 101a and/or the second electronic device 101b receive the transmission and update the shared spatial coordinate system of the physical environment 400 by which the first electronic device 101a and/or the second electronic device 101b display content of the multi-user communication session, respectively.

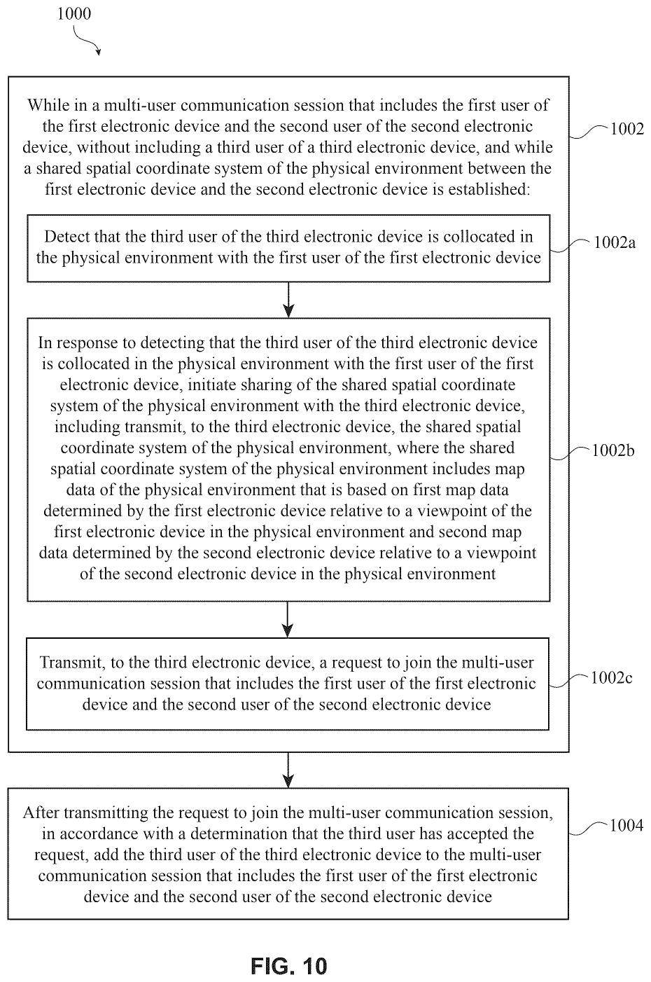

FIG. 10 illustrates a flow diagram illustrating a method 1000 for detecting and responding to a third user of a third electronic device being collocated in a physical environment with a first user of the first electronic device while in a multi-user communication session that includes the first user of the first electronic device and a second user of a second electronic device, without including the third user, where the first user and the second user are collocated in the physical environment, and where a shared spatial coordinate system of the physical environment between the first electronic device and the second electronic device is established, according to some examples of the disclosure.

In some examples, method 1000 begins at a first electronic device in communication with one or more first displays and one or more first input devices. In some examples, the first electronic device includes one or more characteristics of the first electronic device 101a in FIGS. 9A through 9F. One or more examples of method 1000 are illustrated and/or described with reference to one or more of FIGS. 9A through 9F. It is understood that method 1000 is an example and that more, fewer, or different operations can be performed in the same or in a different order. Additionally, the operations in method 1000 described below are, optionally, implemented by running one or more functional modules in an information processing apparatus such as general-purpose processors (e.g., as described with respect to FIGS. 2A-2C) or application specific chips, and/or by other components of FIGS. 2A-2C.

Therefore, according to the above, some examples of the disclosure are directed to a method (e.g., method 1000 of FIG. 10). In some examples, the method 1000 is performed at a first electronic device in communication with one or more first displays and one or more first input devices. In some examples, a first user of the first electronic device is collocated with a second user of a second electronic device in a physical environment, such as described with reference to the first user 402 of the first electronic device 101a being collocated with the second user 404 of the second electronic device 101b in the physical environment 400 in FIG. 9A.

The method 1000 includes, while (1002) in a multi-user communication session that includes the first user of the first electronic device and the second user of the second electronic device, without including a third user of a third electronic device, such as the multi-user communication session of the second type that includes the first user 402 and the second user 404 without including the third user 406 of the third electronic device 101c in FIG. 9A, and while a shared spatial coordinate system of the physical environment between the first electronic device and the second electronic device is established, such as the shared spatial coordinate system of the physical environment 400 between the first electronic device 101a and the second electronic device 101b indicated by glyph 901b in FIG. 9A, detecting (1002a) that the third user of the third electronic device is collocated in the physical environment with the first user of the first electronic device. For example, as described with reference to FIGS. 9B and 9C, the first electronic device 101a detects that the third user 406 of the third electronic device 101c is collocated in the physical environment 400 with the first user 402 while the first electronic device 101a is in the multi-user communication session of the second type with the second user 404 and while the shared spatial coordinate system of the physical environment 400 between the first electronic device 101a and the second electronic device 101b is established.

The method 1000 includes, while (1002) in the multi-user communication session that includes the first user of the first electronic device and the second user of the second electronic device, without including the third user of the third electronic device, and while the shared spatial coordinate system of the physical environment between the first electronic device and the second electronic device is established, in response to detecting that the third user of the third electronic device is collocated in the physical environment with the first user of the first electronic device, initiating (1002b) sharing of the shared spatial coordinate system of the physical environment with the third electronic device, such as described with reference to glyph 901c in FIG. 9C. In some examples, initiating sharing of the shared spatial coordinate system of the physical environment with the third electronic device includes transmitting, to the third electronic device, the shared spatial coordinate system of the physical environment, such as described with reference to glyph 901c in FIG. 9C. In some examples, the shared spatial coordinate system of the physical environment includes (and/or is based on) map data of the physical environment that is based on first map data determined by the first electronic device relative to a viewpoint of the first electronic device in the physical environment, and second map data determined by the second electronic device relative to a viewpoint of the second electronic device in the physical environment, such as described with reference to glyph 901c in FIG. 9C.

Additionally, the method 1000 includes, while (1002) in the multi-user communication session that includes the first user of the first electronic device and the second user of the second electronic device, without including the third user of the third electronic device, and while the shared spatial coordinate system of the physical environment between the first electronic device and the second electronic device is established, transmitting (1002c), to the third electronic device, a request to join the multi-user communication session that includes the first user of the first electronic device and the second user of the second electronic device, such as described with reference to the first electronic device 101a transmitting the request in response to detecting the input directed to the user interface element 902a in FIG. 9D.

Additionally, the method 1000 includes, after transmitting the request to join the multi-user communication session, in accordance with a determination that the third user has accepted the request, adding (1004) the third user of the third electronic device to the multi-user communication session that includes the first user of the first electronic device and the second user of the second electronic device, such as the adding of the third user 406 of the third electronic device 101c to the multi-user communication session of the second type that includes the first user 402 and the second user 404 from FIG. 9E to FIG. 9F.

Additionally or alternatively, in some examples, the multi-communication session that includes the first user and the second user is hosted on a first networking channel, such as indicated by the glyph 901a in FIG. 9A, and the shared spatial coordinate system of the physical environment is established on a second networking channel that is different from the first networking channel, such as described with reference to glyph 901b in FIG. 9A. Additionally or alternatively, in some examples, the shared spatial coordinate system of the physical environment is transmitted to the third electronic device using a networking channel that is different from the first networking channel. For example, data corresponding to the shared spatial coordinate system of the physical environment 400 indicated by glyph 901b in FIG. 9A is being transmitted, as indicated by glyph 901c in FIG. 9C, to the third electronic device 101c using a networking channel that is different from the first networking channel. In some examples, the networking channel that is different from the first networking channel is the second networking channel, such as the second networking channel described with reference to glyph 901b in FIG. 9A. In some examples, the second networking channel is a BLUETOOTH-based networking channel (e.g., BLUETOOTH CLASSIC (BR/EDR) or BLUETOOTH LOW ENERGY (BLE), or another type of BLUETOOTH-based networking channel). In some examples, the second networking channel is Wi-Fi (e.g., utilizes Wi-Fi).

Additionally or alternatively, in some examples, the multi-user communication session that includes the first user of the first electronic device and the second user of the second electronic device, without including the third user of the third electronic device, also includes a fourth user of a fourth electronic device. Additionally or alternatively, in some examples, the shared spatial coordinate system of the physical environment is based on, the first map data determined by the first electronic device relative to the viewpoint of the first electronic device in the physical environment, the second map data determined by the second electronic device relative to the viewpoint of the second electronic device in the physical environment, and third map data determined by the fourth electronic device relative to a viewpoint of the fourth electronic device in the physical environment. For instance, if the first electronic device 101a were to be collocated with the second electronic device 101b and a fourth electronic device in the physical environment 400, and if the multi-user communication session of the second type were to include the first electronic device 101a, the second electronic device 101b, and the fourth electronic device in FIG. 9B, the shared spatial coordinate system of the physical environment 400 that the first electronic device 101a transmits to the third electronic device 101c in FIG. 9C is based on map data from the first electronic device 101a, the second electronic device 101b, and the fourth electronic device.

Additionally or alternatively, in some examples, the method 1000 includes, while in the multi-user communication session that includes the first user of the first electronic device, the second user of the second electronic device, and the third user of the third electronic device, detecting fourth map data from the third electronic device, where the fourth map data is determined by the third electronic device relative to a viewpoint of the third electronic device in the physical environment. Additionally or alternatively, in some examples, the method 1000 includes, in response to detecting the fourth map data from the third electronic device, updating the shared spatial coordinate system of the physical environment. In some examples, the shared spatial coordinate system of the physical environment is updated to be based on the first map data determined by the first electronic device relative to the viewpoint of the first electronic device in the physical environment, the second map data determined by the second electronic device relative to the viewpoint of the second electronic device in the physical environment, and the fourth map data determined by the third electronic device relative to the viewpoint of the third electronic device in the physical environment.

Additionally or alternatively, in some examples, the method 1000 includes, after adding the third user of the third electronic device to the multi-user communication session that includes the first user of the first electronic device and the second user of the second electronic device, detecting third map data from the third electronic device, where the third map data is determined by the third electronic device relative to a viewpoint of the third electronic device in the physical environment. For example, the first electronic device 101a optionally detects map data from the third electronic device 101c while the third electronic device 101c is in the multi-user communication session of the second type with the first user 402 and the second user 404 in FIG. 9E. Additionally or alternatively, in some examples, the method 1000 includes, in response to detecting the third map data from the third electronic device, updating the shared spatial coordinate system of the physical environment. In some examples, the updated shared spatial coordinate system is based on the first map data determined by the first electronic device relative to the viewpoint of the first electronic device in the physical environment, the second map data determined by the second electronic device relative to the viewpoint of the second electronic device in the physical environment, and the third map data determined by the third electronic device relative to the viewpoint of the third electronic device in the physical environment. For example, while the third electronic device 101c is in the multi-user communication session of the second type with the first user 402 and the second user 404 as in FIG. 9E, the first electronic device 101a optionally updates the shared spatial coordinate system of the physical environment 400 that the first electronic device 101a uses to display the user interface 434a at the illustrated location in FIG. 9E using map data detected by the third electronic device 101c.

Additionally or alternatively, in some examples, the method 1000 includes, after adding the third user of the third electronic device to the multi-user communication session that includes the first user of the first electronic device and the second user of the second electronic device, detecting an indication that a respective user in the multi-user communication session (e.g., the first user, the second user, or the third user) requests to share a user interface of an application in the multi-user communication session. For example, when the third user 406 is added to the multi-user communication session of the second type that includes the first user 402 and the second user 404 in FIG. 9E, the user interface 434a is optionally not being shared between the electronic devices that are in the multi-user communication session (e.g., the user interface 434a is optionally private to the first electronic device 101a when the third user 406 is added to the multi-user communication session). Continuing with this example, the first electronic device 101a optionally detects an input corresponding to a request to share the user interface 434a into the multi-user communication session. For example, the first electronic device 101a optionally detects attention (e.g., gaze) of the first user 402 directed to a user interface element that is selectable to share the user interface 434a into the multi-user communication session while the hand 402a of the first user 402 performs an air pinch gesture. In some examples, the method 1000 includes, in response to detecting the indication that the respective user requests to share the user interface of the application in the multi-user communication session, displaying, via the one or more first displays, the user interface of the application at a first location in a first three-dimensional environment, where the first location corresponds to a shared location in the shared spatial coordinate system of the physical environment. For example, in response to detecting the input corresponding to the request to share the user interface 434a into the multi-user communication session, as described above, the first electronic device 101a displays the user interface 434a at the illustrated location in FIG. 9E, which is associated with the same corresponding physical location at which the third electronic device 101c displays the user interface 434a in FIG. 9E.

Additionally or alternatively, in some examples, the method 1000 includes, while in the multi-user communication session that includes the first user of the first electronic device and the second user of the second electronic device, without including the third user of the third electronic device, displaying, via the one or more first displays, shared virtual content of the multi-user communication session at a first location in a first three-dimensional environment, wherein the first location in the first three-dimensional environment corresponds to a first shared location in the shared spatial coordinate system of the physical environment between the first electronic device and the second electronic device, such as shown with the first electronic device 101a and the second electronic device 101b displaying the user interface 434a at locations in the three-dimensional environments 450A/450B that correspond to the same location in the physical environment 400 in FIG. 9B, using the shared spatial coordinate system of the physical environment 400 between the first electronic device 101a and the second electronic device 101b as indicated by glyph 901b in FIG. 9B. Additionally or alternatively, in some examples, the method 1000 includes, after adding the third user of the third electronic device to the multi-user communication session that includes the first user of the first electronic device and the second user of the second electronic device, continuing display of the shared virtual content, such as shown with the maintaining of display of the user interface 434a from FIG. 9E to FIG. 9F, and causing the third electronic device to display, via one or more third displays of the third electronic device, the user interface of the application at a first location in a respective three-dimensional environment of the third electronic device, where the first location in the respective three-dimensional environment corresponds to the first shared location in the shared spatial coordinate system of the physical environment, such as shown with the third electronic device 101c displaying the user interface 434a from FIG. 9E to 9F at a location in the third three-dimensional environment 450C that corresponds to the same location in the physical environment 400 that is associated with the display of the user interface 434a via the first electronic device 101a.

Additionally or alternatively, in some examples, detecting that the third user of the third electronic device is collocated in the physical environment with the first user of the first electronic device includes detecting that the first user and the third user previously interacted in the physical environment. For example, the first electronic device 101a determines that the first user 402 and the third user 406 are collocated in the physical environment 400 from FIG. 9B to FIG. 9C because the first electronic device 101a determines that the first user 402 and the third user 406 previously interacted with each other in the physical environment 400. Additionally or alternatively, in some examples, detecting that the first user and the third user previously interacted in the physical environment includes detecting that the first user and the third user were previously in a respective multi-user communication session while collocated in the physical environment. For example, the first electronic device 101a determines that the first user 402 and the third user 406 are collocated in the physical environment 400 from FIG. 9B to FIG. 9C because the first electronic device 101a determines that the first user 402 and the third user 406 were previously party to a multi-user communication session of the second type with each other while collocated with each other in the physical environment 400. Additionally or alternatively, in some examples, the first electronic device includes a first head-mounted device, such as the first electronic device 101a in FIG. 9A, the second electronic device includes a second head-mounted device, such as the second electronic device 101b in FIG. 9A, and the third electronic device includes a third head-mounted device, such as the third electronic device 101c in FIG. 9F.

Some examples of the disclosure are directed to an electronic device, comprising: one or more processors; memory; and one or more programs stored in the memory and configured to be executed by the one or more processors, the one or more programs including instructions for performing any of the above methods. Some examples of the disclosure are directed to a non-transitory computer readable storage medium storing one or more programs, the one or more programs comprising instructions, which when executed by one or more processors of an electronic device, cause the electronic device to perform any of the above methods. Some examples of the disclosure are directed to an electronic device, comprising one or more processors, memory, and means for performing any of the above methods. Some examples of the disclosure are directed to an information processing apparatus for use in an electronic device, the information processing apparatus comprising means for performing any of the above methods.

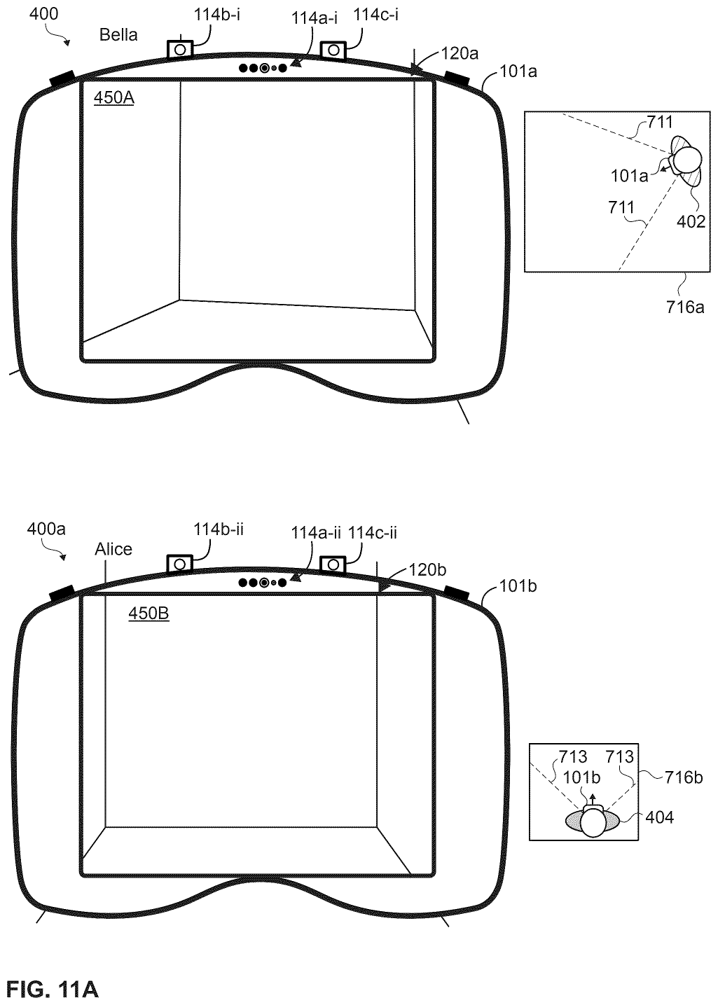

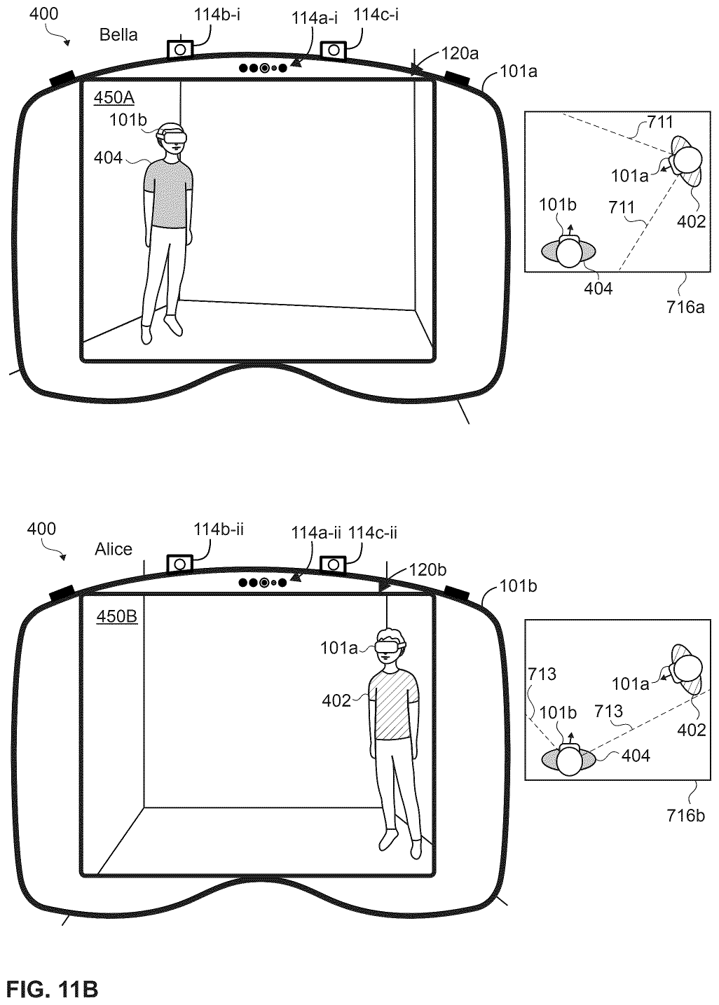

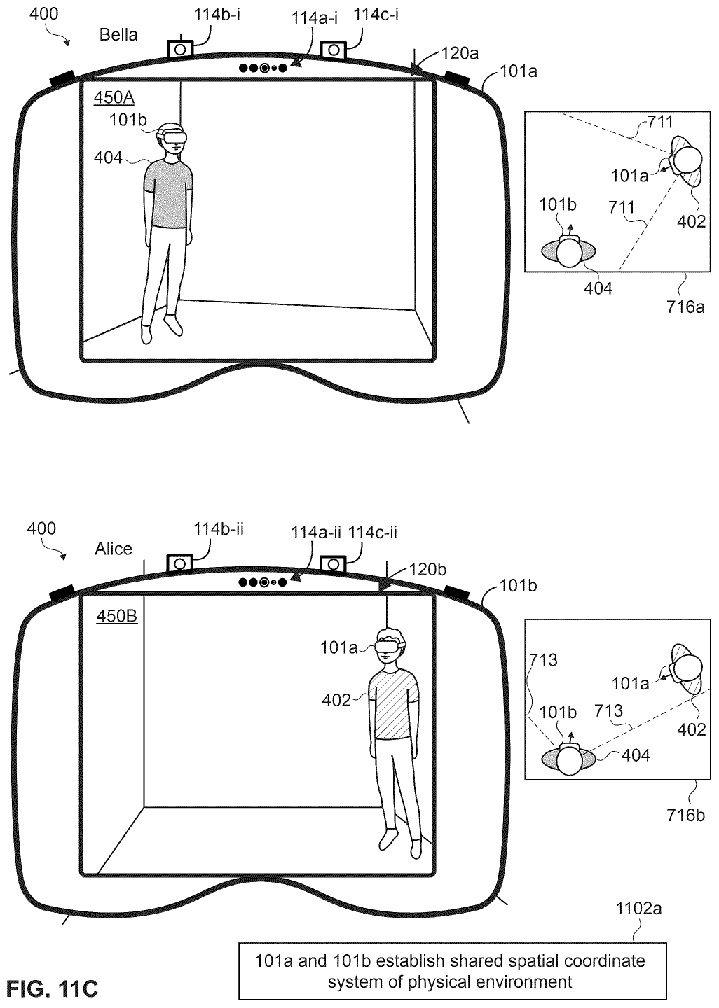

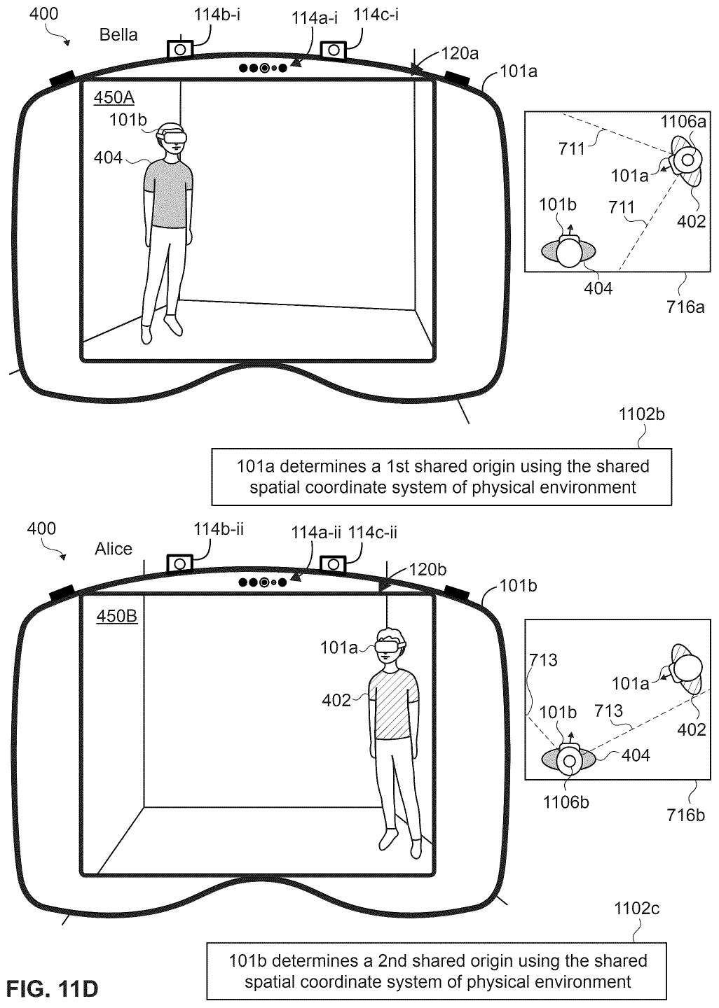

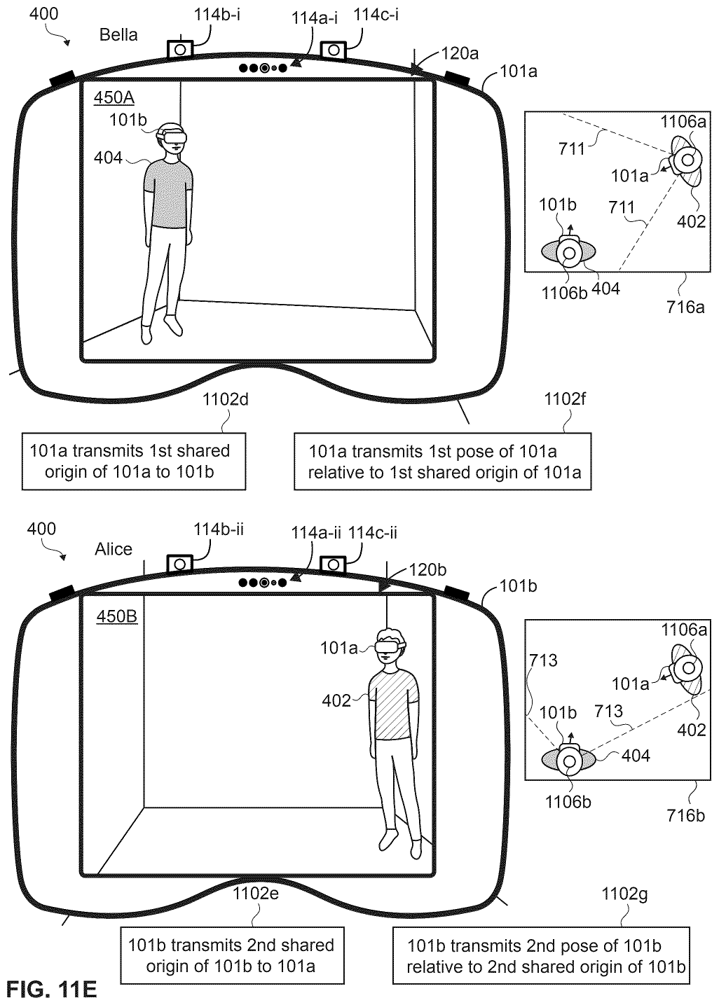

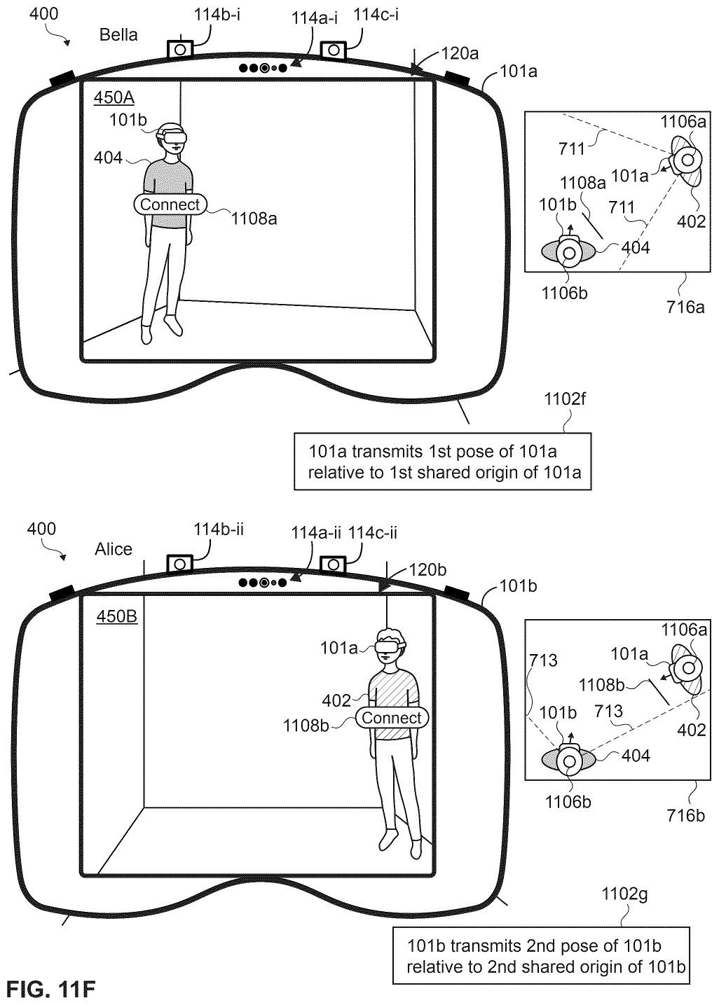

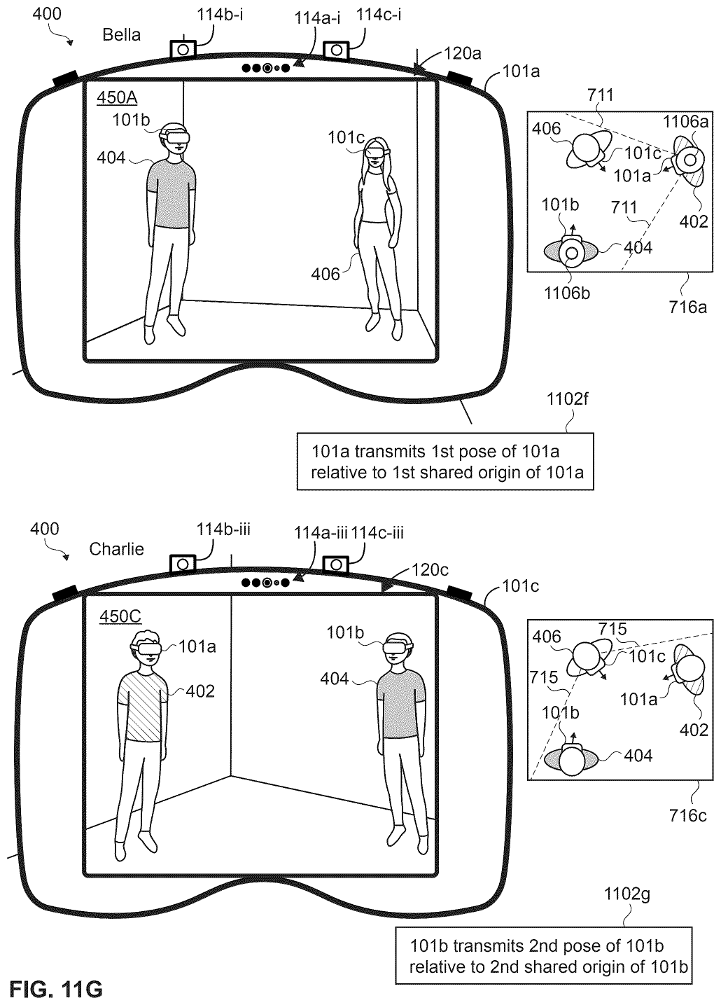

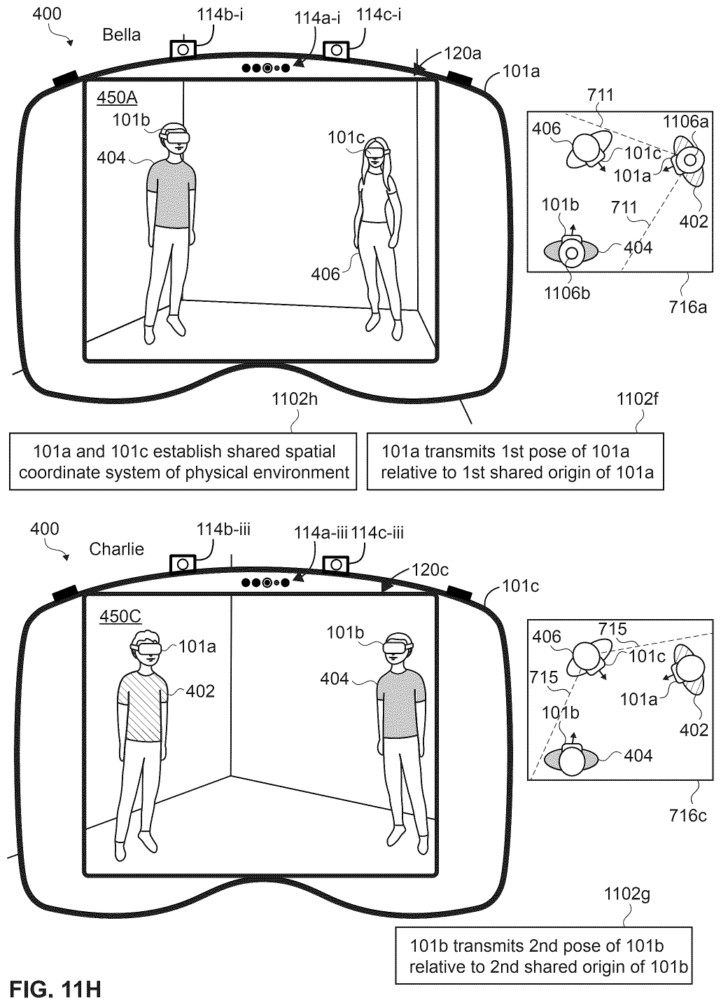

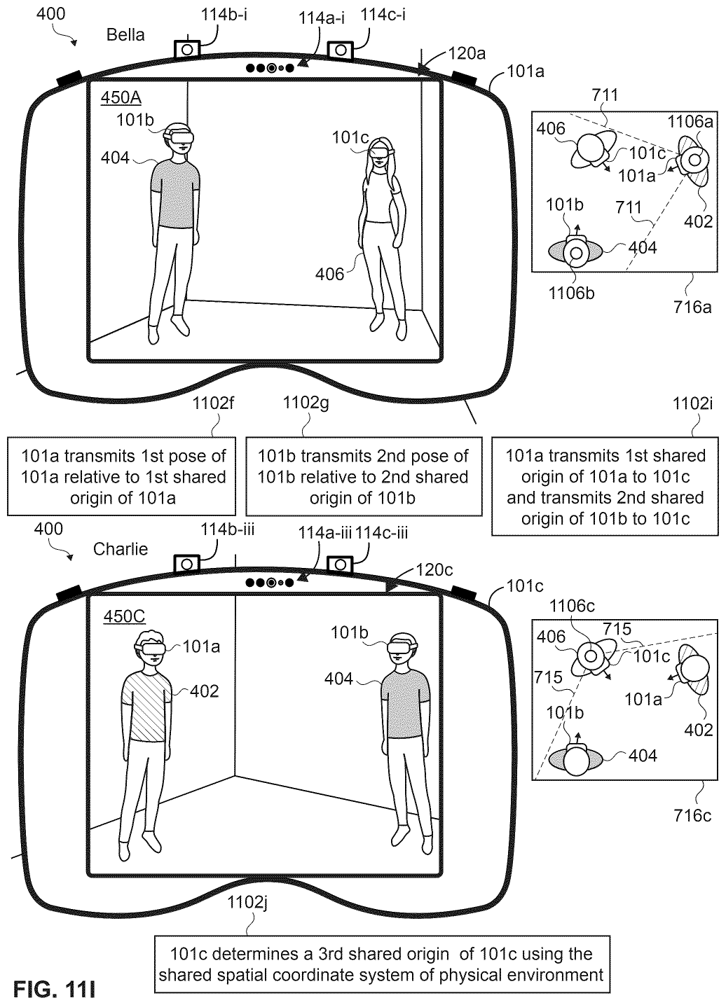

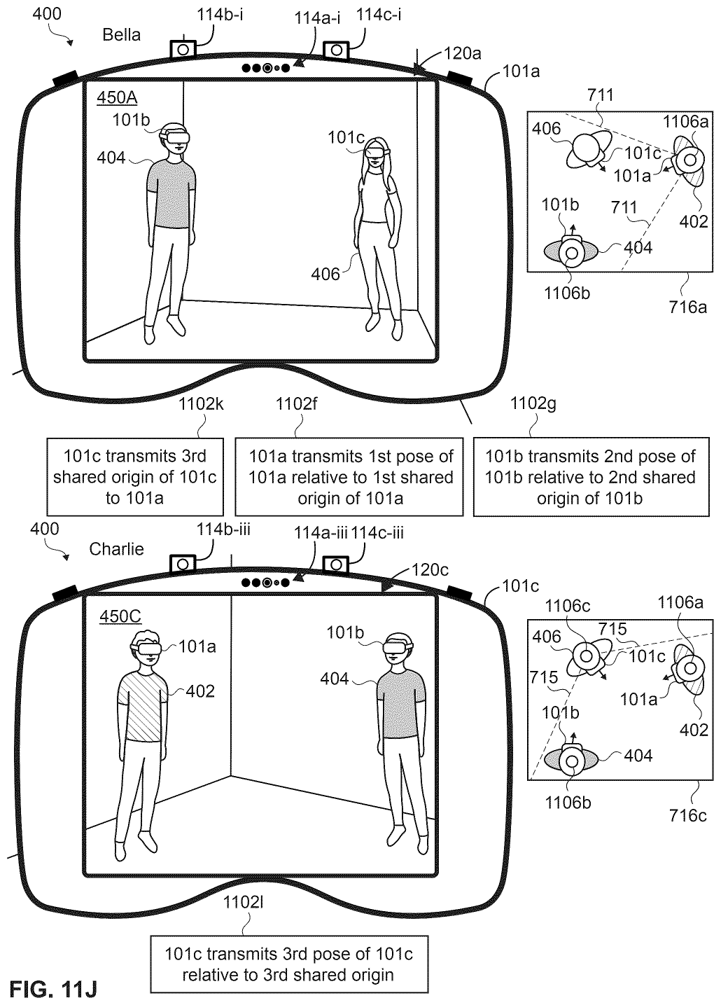

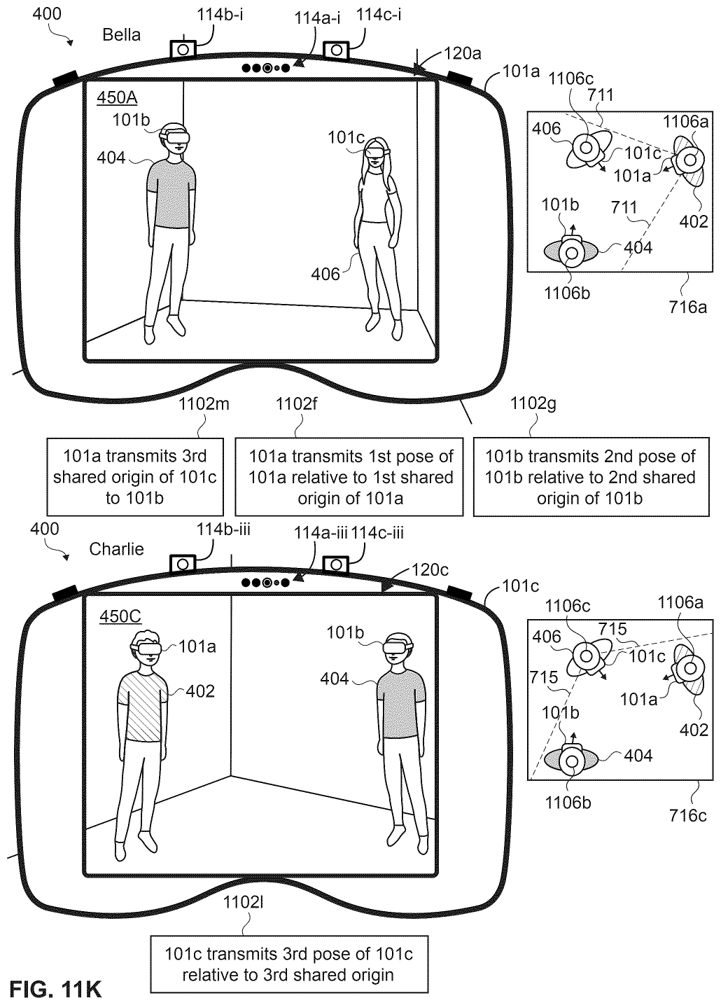

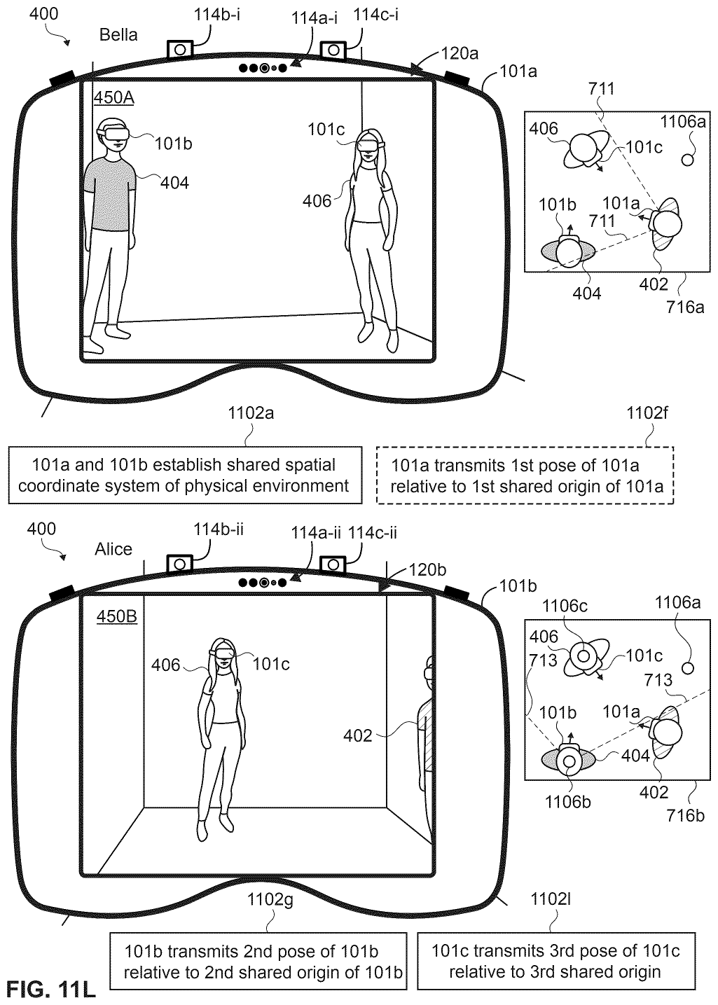

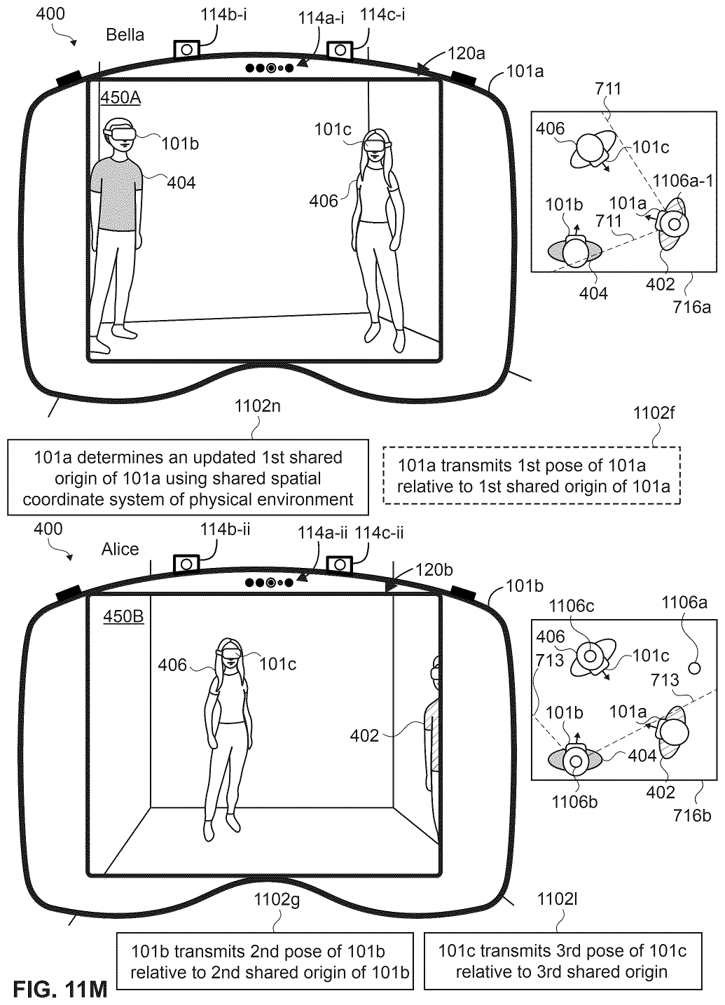

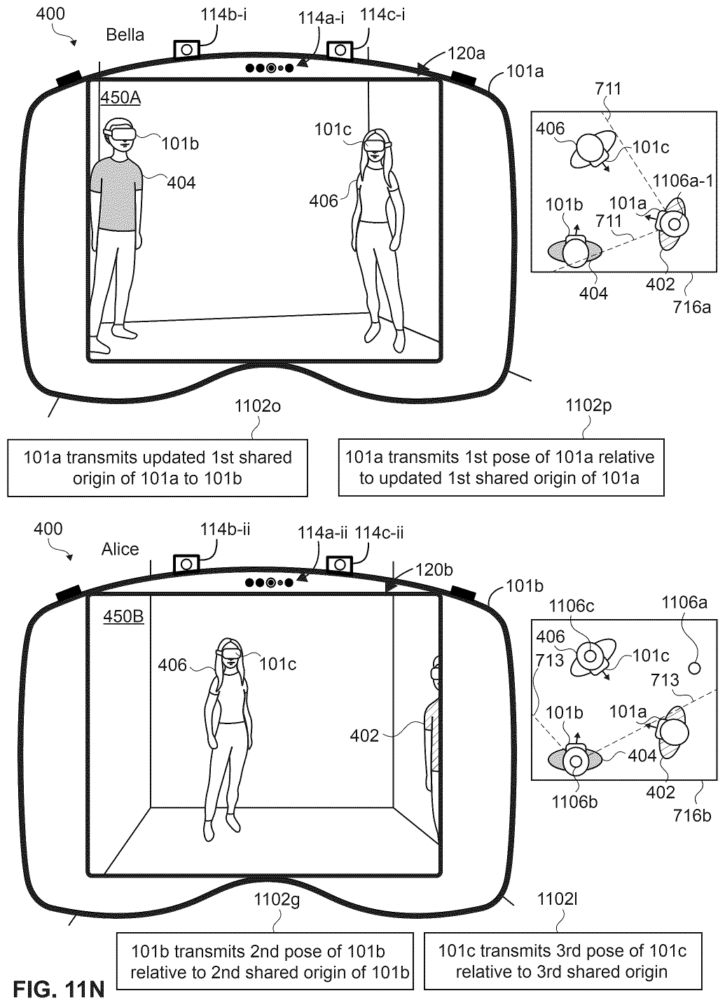

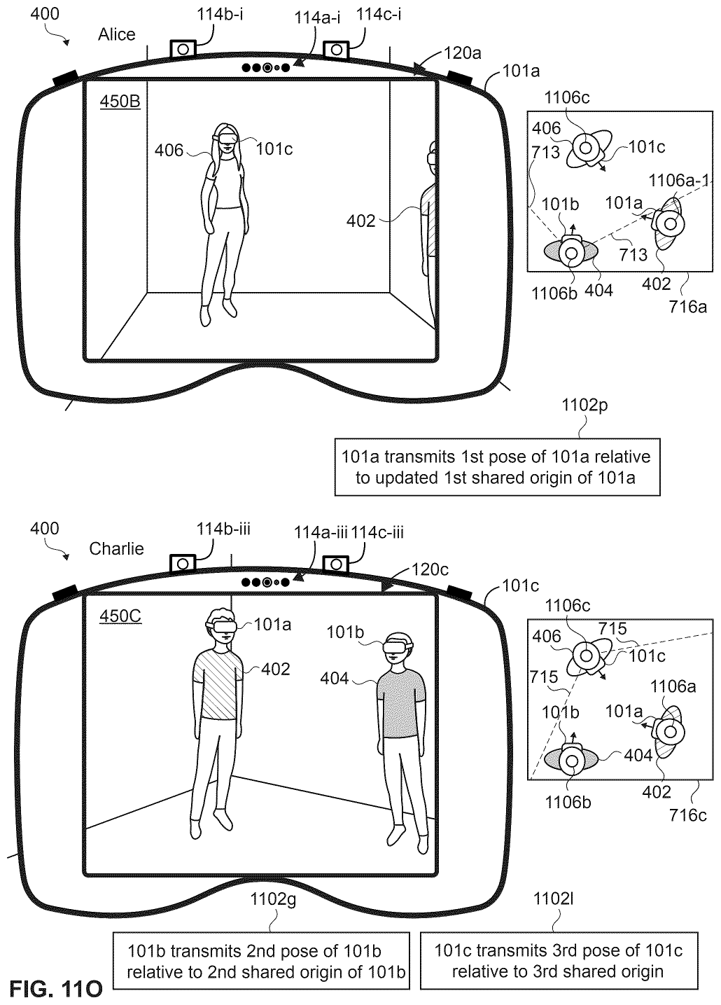

FIGS. 11A through 110 generally illustrate examples of a first electronic device performing different location tracking processes with different electronic devices, according to some examples of the disclosure.

In some examples, a first electronic device performs a location tracking process with a second electronic device in response to detecting that the second electronic device is collocated with the first electronic device in a physical environment. In some examples, performing the location tracking process with the second electronic device includes establishing a shared spatial coordinate system of the physical environment between the first electronic device and the second electronic device. In some examples, in response to establishing the shared spatial coordinate system of the physical environment between the first electronic device and the second electronic device, the first electronic device determines a first shared reference origin (e.g., a first shared anchor) according to which a first pose (e.g., position and/or orientation) of the first electronic device is defined in the physical environment using the shared spatial coordinate system of the physical environment that the first electronic device and the second electronic device established between each other. The first shared reference origin of the first electronic device is associated with a reference location and/or orientation in the physical environment. For example, using the shared spatial coordinate system of the physical environment that the first electronic device and the second electronic device established between each other, the first electronic device determines the first shared reference origin of the first electronic device. In some examples, the first electronic device transmits, to the second electronic device, the first shared reference origin of the first electronic device. In some examples, the first electronic device transmits, to the second electronic device, the first pose of the first electronic device, and the second electronic device determines a pose of the first electronic device in a local coordinate system of the second electronic device. In some examples, the second electronic device transmits, to the first electronic device, a second shared reference origin of the second electronic device. In some examples, the second electronic device transmits, to the first electronic device, a second pose of the second electronic device and the first electronic device determines a pose of the second electronic device in a local coordinate system of the first electronic device. In some examples, the first electronic device maintains the first shared reference origin of the first electronic device and the second shared reference origin of the second electronic device even after establishing the shared spatial coordinate system of the physical environment with the second electronic device. In some examples, if the first electronic device establishes a shared spatial coordinate system of the physical environment with a third electronic device after establishing a shared spatial coordinate system of the physical environment with the second electronic device, the first electronic device transmits the first shared reference origin of the first electronic device instead of determining an updated first shared reference origin of the first electronic device using the shared spatial coordinate system of the physical environment between the first electronic device and the third electronic device. Additionally, the first electronic device transmits, to the third electronic device, the second shared reference origin of the second electronic device, which allows the third electronic device to determine a pose of the second electronic device in the local coordinate system of the third electronic device without the second electronic device and the third electronic device directly establishing a shared spatial coordinate system of the physical environment with each other, which reduces processing power involved in a location tracking process performed by the third electronic device for tracking a location of the second electronic device in the local coordinate system of the third electronic device.

In FIG. 11A, the first user 402 of the first electronic device 101a is in the physical environment 400. From FIG. 11A to FIG. 11B, the second user 404 of the second electronic device 101b enters the physical environment 400 in which the first user 402 of the first electronic device 101a is located. From FIG. 11B to FIG. 11C, the first electronic device 101a detects that the second electronic device 101b is collocated with the first electronic device 101a in the physical environment 400 (e.g., the first electronic device 101a detects that the second user 404 of the second electronic device 101b is collocated with the first user 402 of the first electronic device 101a in the physical environment 400), such as described with reference to the first electronic device 101a and the second electronic device 101b being collocated (e.g., being determined to be collocated) in a physical environment (e.g., the physical environment 400 of FIG. 4A). Alternatively, in some examples, from FIG. 11B to FIG. 11C, the second user 404 enters the physical environment 400 with the second electronic device 101b without wearing the second electronic device 101b, and then wears (e.g., dons) the second electronic device 101b, which optionally activates and/or initiates a process to determine whether the first electronic device 101a and the second electronic device 101b (e.g., the first user 402 of the first electronic device 101a and the second user 404 of the second electronic device 101b) are collocated in the physical environment 400.

In response to detecting that the first user 402 and the second user 404 are collocated in the physical environment 400, the first electronic device 101a and the second electronic device 101b establish a shared spatial coordinate system of the physical environment 400 (e.g., perform a location tracking process with each other), as indicated by the glyph 1102a in FIG. 11C. In some examples, establishing the shared spatial coordinate system of the physical environment 400 between the first electronic device 101a and the second electronic device 101b includes performing one or more of operations described herein above (e.g., with reference to FIG. 4C (e.g., blocks 414, 416, 418, and/or 420 in FIG. 4C) and/or with reference to FIG. 7C (e.g., glyph 720 in FIG. 7C)).

As shown in FIG. 11D, after establishing the shared spatial coordinate system of the physical environment 400 between the first electronic device 101a and the second electronic device 101b, the first electronic device 101a determines a first shared reference origin 1106a of the first electronic device 101a (e.g., a first shared anchor of the first electronic device 101a or a first shared origin of the first electronic device 101a) using the shared spatial coordinate system of the physical environment 400 between the first electronic device 101a and the second electronic device 101b, as indicated by glyph 1102b and as shown in overhead view 716a. In some examples, the first shared reference origin 1106a of the first electronic device 101a is associated with a location and/or orientation in the physical environment 400. For example, the first shared reference origin 1106a of the first electronic device 101a corresponds to a reference location and/or a reference orientation in the physical environment 400. In some examples, the first electronic device 101a defines a pose (e.g., a position and/or orientation) of the first electronic device 101a in the physical environment 400 relative to the first shared reference origin 1106a of the first electronic device 101a.

Additionally, as shown in FIG. 11D, after establishing the shared spatial coordinate system of the physical environment 400 between the first electronic device 101a and the second electronic device 101b, the second electronic device 101b determines a second shared reference origin 1106b of the second electronic device 101b (e.g., a second shared anchor of the second electronic device 101b or a second shared origin of the second electronic device 101b) using the shared spatial coordinate system of the physical environment 400 between the first electronic device 101a and the second electronic device 101b, as indicated by glyph 1102c and as shown in overhead view 716b. In some examples, the second shared reference origin 1106b of the second electronic device 101b is associated with a location and/or orientation in the physical environment 400. For example, the second shared reference origin 1106b of the second electronic device 101b corresponds to a reference location and/or a reference orientation in the physical environment 400. In some examples, the second electronic device 101b defines a pose (e.g., a position and/or orientation) of the second electronic device 101b in the physical environment 400 relative to the second shared reference origin 1106b of the second electronic device 101b. In some examples, the first shared reference origin 1106a of the first electronic device 101a is associated with a first location and/or orientation in the physical environment 400 and the second shared reference origin 1106b of the second electronic device 101b is associated with a second location and/or orientation in the physical environment 400 that is different from the first location and/or orientation in the physical environment 400.

In FIG. 11E, after determining the first shared reference origin 1106a of the first electronic device 101a, the first electronic device 101a transmits the first shared reference origin 1106a of the first electronic device 101a to the second electronic device 101b, as shown in glyph 1102d. In response to receiving the first shared reference origin 1106a of the first electronic device 101a (e.g., the data indicative of the first shared reference origin 1106a of the first electronic device 101a), the second electronic device 101b notes (e.g., decodes and/or translates) the first shared reference origin 1106a of the first electronic device 101a in a coordinate system (e.g., a local mapping of the physical environment 400) of the second electronic device 101b, such as shown in overhead view 716b. In some examples, the coordinate system of the second electronic device 101b is private to and/or not shared with the first electronic device 101a. The coordinate system of the second electronic device 101b is different from the established shared spatial coordinate system of the physical environment 400 between the first electronic device 101a and the second electronic device 101b. For example, the second electronic device 101b decodes (e.g., translates) the first shared reference origin 1106a of the first electronic device 101a, which is optionally encoded in the shared spatial coordinate system of the physical environment 400 between the first electronic device 101a and the second electronic device 101b, to the coordinate system of the second electronic device 101b. Accordingly, if the shared spatial coordinate system of the physical environment between the first electronic device 101a and the second electronic device 101b is no longer established after the decoding of the first shared reference origin 1106a of the first electronic device 101a to the coordinate system of the second electronic device 101b, the second electronic device 101b still knows the location in the physical environment 400 to which the first shared reference origin 1106a of the first electronic device 101a corresponds because the second electronic device 101b noted the location of the first shared reference origin 1106a of the first electronic device 101a in the coordinate system of the second electronic device 101b.

Likewise, in FIG. 11E, after determining the second shared reference origin 1106b of the second electronic device 101b, the second electronic device 101b transmits the second shared reference origin 1106b of the second electronic device 101b to the first electronic device 101a, as shown in glyph 1102e. In response to receiving the second shared reference origin 1106b of the second electronic device 101b (e.g., the data indicative of the second shared reference origin 1106b of the second electronic device 101b), the first electronic device 101a notes (e.g., decodes and/or translates) the second shared reference origin 1106b of the second electronic device 101b in a coordinate system (e.g., a local mapping of the physical environment 400) of the first electronic device 101a, such as shown in overhead view 716a. In some examples, the coordinate system of the first electronic device 101a is private to and/or not shared with the second electronic device 101b. The coordinate system of the first electronic device 101a is different from the established shared spatial coordinate system of the physical environment between 400 the first electronic device 101a and the second electronic device 101b. For example, the first electronic device 101a decodes (e.g., translates) the second shared reference origin 1106b of the second electronic device 101b, which is optionally encoded in the shared spatial coordinate system of the physical environment 400 between the first electronic device 101a and the second electronic device 101b, to the coordinate system of the first electronic device 101a. Accordingly, if the shared spatial coordinate system of the physical environment between the first electronic device 101a and the second electronic device 101b is no longer established after the decoding of the second shared reference origin 1106b of the second electronic device 101b to the coordinate system of the first electronic device 101a, the first electronic device 101a still knows the location in the physical environment 400 to which the second shared reference origin 1106b of the second electronic device 101b corresponds because the first electronic device 101a noted the location of the first shared reference origin of the second electronic device 101b in the coordinate system of the first electronic device 101a.

In some examples, the second electronic device 101b maintains the first shared reference origin 1106a of the first electronic device 101a (e.g., the location and/or orientation in the physical environment 400 to which the first shared reference origin 1106a of the first electronic device 101a corresponds) after performing the location tracking process with the first electronic device 101a described above with reference to FIGS. 11B through 11E (e.g., after establishing the shared spatial coordinate system of the physical environment 400 between the first electronic device 101a and the second electronic device 101b and/or while the shared spatial coordinate system of the physical environment 400 between the first electronic device 101a and the second electronic device 101b is no longer established and/or no longer being updated). In some examples, the first electronic device 101a maintains the second shared reference origin 1106b of the second electronic device 101b (e.g., the location and/or orientation in the physical environment 400 to which the second shared reference origin 1106b of the second electronic device 101b corresponds) after performing the location tracking process with the second electronic device 101b described above with reference to FIGS. 11B through 11E (e.g., after establishing the shared spatial coordinate system of the physical environment 400 between the first electronic device 101a and the second electronic device 101b and/or while the shared spatial coordinate system of the physical environment between the first electronic device 101a and the second electronic device 101b is no longer established and/or no longer being updated).

Additionally, in FIG. 11E, after (e.g., in response to) determining the first shared reference origin 1106a of the first electronic device 101a, the first electronic device 101a computes a first pose (e.g., a position and/or orientation) of the first electronic device 101a in the physical environment 400 using (e.g., relative to) the first shared referenced origin 1106a of the first electronic device 101a, and then transmits the first pose of the first electronic device 101a to other electronic devices (e.g., other electronic devices in the physical environment 400), such as shown in glyph 1102f. For example, the first electronic device 101a transmits the first pose of the first electronic device 101a to the second electronic device 101b in FIG. 11E. In some examples, the first electronic device 101a transmits (e.g., broadcasts) the pose of the first electronic device 101a relative to the first shared referenced origin 1106a of the first electronic device 101a even if the shared spatial coordinate system of the physical environment 400 between the first electronic device 101a and the second electronic device 101b is no longer established (e.g., independent of whether or not the shared spatial coordinate system of the physical environment 400 between the first electronic device 101a and the second electronic device 101b is still established). In response to receiving the first pose of the first electronic device 101a, the second electronic device 101b determines a pose (e.g., a position and/or orientation) of the first electronic device 101a in the coordinate system of the second electronic device 101b using the first pose of the first electronic device 101a and the first shared reference origin 1106a of the first electronic device 101a that the second electronic device 101b previously noted (e.g., as described above) in the coordinate system of the second electronic device 101b.

Likewise, in FIG. 11E, after (e.g., in response to) determining the second shared reference origin 1106b of the second electronic device 101b, the second electronic device 101b computes (e.g., determines, calculates) the second pose (e.g., a position and/or orientation) of the second electronic device 101b in the physical environment 400 using (e.g., relative to) the second shared referenced origin of the second electronic device 101b, and then transmits the second pose of the second electronic device 101b to other electronic devices (e.g., other electronic devices in the physical environment 400), such as shown in glyph 1102g. For example, the second electronic device 101b transmits the second pose of the second electronic device 101b to the first electronic device 101a in FIG. 11E. In some examples, the second electronic device 101b transmits (e.g., broadcasts) the pose of the second electronic device 101b relative to the second shared referenced origin 1106b of the second electronic device 101b even if the shared spatial coordinate system of the physical environment 400 between the first electronic device 101a and the second electronic device 101b is no longer established (e.g., independent of whether or not the shared spatial coordinate system of the physical environment 400 between the first electronic device 101a and the second electronic device 101b is still established). In response to receiving the second pose of the second electronic device 101b, the first electronic device 101a determines a pose (e.g., a position and/or orientation) of the second electronic device 101b in the coordinate system of the first electronic device 101a using the second pose of the second electronic device 101b and the second shared reference origin 1106b of the second electronic device 101b that the first electronic device 101a previously noted (e.g., as described above) in the coordinate system of the first electronic device 101a.

In some examples, the first electronic device 101a displays a user interface element 1108a based on the determined location of the second electronic device 101b, such as shown in FIG. 11F, and such as described with reference to the user interface element 440a in FIG. 4E. For example, the user interface element in FIG. 11F is optionally selectable to initiate a process to establish a multi-user communication session with the second user 404 (e.g., a multi-user communication session of the second type with the second user 404). In some examples, the first electronic device 101a detects user input directed to the user interface element in FIG. 11F. In some examples, in response to detecting user input directed to the user interface element in FIG. 11F, the first electronic device 101a initiates the process to establish the multi-user communication session with the second user 404 (e.g., a multi-user communication session of the second type with the second user 404).

Likewise, in some examples, the second electronic device 101b displays a user interface element 1108b based on the determined location of the first electronic device 101a, such as shown in FIG. 11F, and such as described with reference to the user interface element 440a in FIG. 4E. For example, the user interface element in FIG. 11F is optionally selectable to initiate a process to establish a multi-user communication session with the first user 402 (e.g., a multi-user communication session of the second type with the first user 402). In some examples, the second electronic device 101b detects user input directed to the user interface element 1108b in FIG. 11F. In some examples, in response to detecting user input directed to the user interface element 1108b in FIG. 11F, the second electronic device 101b initiates the process to establish the multi-user communication session with the first user 402.

FIGS. 11G and 11H illustrate an example of the first electronic device 101a detecting that the third user 406 of the third electronic device 101c is collocated with the first user 402 in the physical environment 400, such as described herein with reference to the first user 402 and the second user 404 being collocated in the physical environment 400, according to some examples. In FIG. 11G, the third user 406 enters the physical environment 400 (e.g., room) in which the first user 402 and the second user 404 are located. From FIG. 11G to FIG. 11H, the first electronic device 101a detects that the third electronic device 101c is collocated with the first electronic device 101a in the physical environment 400 (e.g., the first electronic device 101a detects that the third user 406 of the third electronic device 101c is collocated with the first user 402 of the first electronic device 101a in the physical environment 400), such as described herein (e.g., above with reference to the first electronic device 101a and the second electronic device 101b being collocated in a physical environment (e.g., the physical environment 400 of FIG. 4A), but applying to the first electronic device 101a and the third electronic device 101c being collocated in the physical environment).

In response to detecting that the first user 402 and the third user 406 are collocated in the physical environment 400, the first electronic device 101a and the third electronic device 101c establish a shared spatial coordinate system of the physical environment 400 (e.g., perform a location tracking process with each other such as a location tracking process that includes one or more characteristics of the location tracking process described with reference to FIGS. 11B through 11E, but between the first electronic device 101a and the third electronic device 101c), as indicated by the glyph 1102h in FIG. 11H. In some examples, establishing the shared spatial coordinate system of the physical environment 400 between the first electronic device 101a and the third electronic device 101c includes one or more of the operations described herein (e.g., above with reference to FIG. 4C (e.g., blocks 414, 416, 418, and/or 420 in FIG. 4C), FIG. 7C (e.g., glyph 720 in FIG. 7C), and/or FIG. 11C (e.g., glyph 1102a in FIG. 11C) but between the first electronic device 101a and the third electronic device 101c).

In FIG. 11I, in response to establishing the shared spatial coordinate system of the physical environment 400 between the first electronic device 101a and the third electronic device 101c, the third electronic device 101c determines a third shared reference origin 1106c of the third electronic device 101c (e.g., a third shared anchor of the third electronic device 101c or a third shared origin of the third electronic device 101c) using the shared spatial coordinate system of the physical environment 400 between the first electronic device 101a and the third electronic device 101c, as indicated by glyph 1102j and as shown in overhead view 716c. In some examples, the third shared reference origin 1106c of the third electronic device 101c is associated with a location and/or orientation in the physical environment 400. For example, the third shared reference origin 1106c of the third electronic device 101c corresponds to a reference location and/or a reference orientation in the physical environment 400. In some examples, the third electronic device 101c defines a pose (e.g., a position and/or orientation) of the third electronic device 101c in the physical environment 400 relative to the third shared reference origin 1106c of the third electronic device 101c. In some examples, the first shared reference origin 1106a of the first electronic device 101a is associated with a first location and/or orientation in the physical environment 400 and the second shared reference origin 1106b of the second electronic device 101b is associated with a second location and/or orientation in the physical environment 400 that is different from the first location and/or orientation in the physical environment 400, and the third shared reference origin 1106c of the third electronic device 101c is associated with a third location and/or orientation in the physical environment 400 that is different from the first location and/or orientation and the second location and/or orientation.

In some examples, in response to (or after) determining the third shared reference origin 1106c of the third electronic device 101c, as shown in glyph 1102j in FIG. 11I, the third electronic device 101c transmits, to the first electronic device 101a, the third shared reference origin 1106c of the third electronic device 101c, as shown in glyph 1102k in FIG. 11J. In response to receiving the third shared reference origin 1106c of the third electronic device 101c (e.g., the data indicative of the third shared reference origin 1106c of the third electronic device 101c), the first electronic device 101a notes (e.g., decodes and/or translates) the third shared reference origin 1106c of the third electronic device 101c in the coordinate system (e.g., the local mapping of the physical environment 400) of the first electronic device 101a, such as shown in overhead view 716a from FIG. 11J to FIG. 11K. In some examples, in response to (or after) receiving the third shared reference origin 1106c of the third electronic device 101c, the first electronic device 101a transmits, to the second electronic device 101b, the third shared reference origin 1106c of the third electronic device 101c, such as shown in glyph 1102m in FIG. 11K. In some examples, in response to receiving the third shared reference origin 1106c of the third electronic device 101c (e.g., the data indicative of the third shared reference origin 1106c of the third electronic device 101c), the second electronic device 101b notes (e.g., decodes and/or translates) the third shared reference origin 1106c of the third electronic device 101c in the coordinate system (e.g., the local mapping of the physical environment 400) of the second electronic device 101b. In some examples, the second electronic device 101b comprehends the data corresponding to the third shared reference origin 1106c of the third electronic device 101c, without having established a shared spatial coordinate system of the physical environment 400 with the third electronic device 101c, because the first electronic device 101a and the second electronic device 101b have previously established a shared spatial coordinate system of the physical environment 400 with each other from which the first electronic device 101a and the second electronic device 101b have a common spatial understanding of the physical environment 400. For example, even if the shared spatial coordinate system of the physical environment 400 between the first electronic device 101a and the second electronic device 101b is no longer established, the second electronic device 101b can understand the third shared reference origin 1106c of the third electronic device 101c that the first electronic device 101a transmits to the second electronic device 101b using a function that involves the first pose of the first electronic device 101a and/or the first shared reference origin 1106a of the first electronic device 101a and/or coordinates of the third shared reference origin 1106c of the third electronic device 101c that are noted in the coordinate system of the first electronic device 101a, as these variables may serve as references from which the communication of the third shared reference origin 1106c of the third electronic device 101c to the second electronic device 101b can be understood.

Additionally, after (e.g., in response to) determining the third shared reference origin 1106c of the third electronic device 101c in FIG. 11I, the third electronic device 101c computes (e.g., determines or calculates) the third pose (e.g., a position and/or orientation) of the third electronic device 101c in the physical environment 400 using (e.g., relative to) the third shared reference origin 1106c of the third electronic device 101c, and then transmits (e.g., broadcasts) broadcasts the third pose of the third electronic device 101c to other electronic devices (e.g., other electronic devices in the physical environment 400), such as shown in glyph 11021 in FIG. 11J. For example, the third electronic device 101c transmits the third pose of the third electronic device 101c to the first electronic device 101a and the second electronic device 101b in FIG. 11J. In some examples, the third electronic device 101c transmits (e.g., broadcasts) the pose of the third electronic device 101c relative to the third shared referenced origin 1106c of the third electronic device 101c even if the shared spatial coordinate system of the physical environment 400 between the first electronic device 101a and the third electronic device 101c is no longer established (e.g., independent of whether or not the shared spatial coordinate system of the physical environment 400 between the first electronic device 101a and the third electronic device 101c is still established). In some examples, in response to receiving the third pose of the third electronic device 101c, the first electronic device 101a determines a pose (e.g., a position and/or orientation) of the third electronic device 101c in the coordinate system of the first electronic device 101a using the third pose of the third electronic device 101c and the third shared reference origin 1106c of the third electronic device 101c that the first electronic device 101a previously noted (e.g., as described above) in the coordinate system of the first electronic device 101a. Likewise, in some examples, in response to receiving the third pose of the third electronic device 101c, the second electronic device 101b determines a pose (e.g., a position and/or orientation) of the third electronic device 101c in the coordinate system of the second electronic device 101b using the third pose of the third electronic device 101c (e.g., received directly from the third electronic device 101c) and the third shared reference origin 1106c of the third electronic device 101c (e.g., received directly from the first electronic device 101a).

Additionally, in FIG. 11I, in response to establishing the shared spatial coordinate system of the physical environment 400 between the first electronic device 101a and the third electronic device 101c, the first electronic device 101a transmits the first shared reference origin 1106a of the first electronic device 101a (e.g., the first shared reference origin of the first electronic device 101a that was determined while performing the location tracking process with the second electronic device 101b as described with reference to glyph 1102b in FIG. 11D) instead of determining a new first shared reference origin of the first electronic device 101a, as shown in glyph 1102i. Furthermore, in FIG. 11I, in response to establishing the shared spatial coordinate system of the physical environment 400 between the first electronic device 101a and the third electronic device 101c, the first electronic device 101a transmits, to the third electronic device 101c, the second shared reference origin 1106b of the second electronic device 101b (e.g., the second shared reference origin 1106b of the second electronic device 101b that was determined by the second electronic device 101b during the location tracking process performed between the first electronic device 101a and the second electronic device 101b as described with reference to glyph 1102c in FIG. 11D), as shown in glyph 1102i. Accordingly, in FIG. 11I, the second electronic device 101b does not transmit, to the third electronic device 101c, the second shared reference origin 1106b of the second electronic device 101b. Rather, the first electronic device 101a transmits the second shared reference origin 1106b of the second electronic device 101b to the third electronic device 101c as described above. In some examples, the second electronic device 101b does not transmit, to the third electronic device 101c, the second shared reference origin 1106b of the second electronic device 101b because the second electronic device 101b and the third electronic device 101c have not established a shared spatial coordinate system of the physical environment 400 with each other, so the second electronic device 101b and the third electronic device 101c do not have a common coordinate system with each other from which the third electronic device 101c can interpret the second shared reference origin 1106b of the second electronic device 101b from the second electronic device 101b. However, the first electronic device 101a and the third electronic device 101c have established a shared spatial coordinate system of the physical environment 400 with each other, so data corresponding to shared reference origins of electronic devices that is transmitted from the first electronic device 101a may be interpreted by the third electronic device 101c using the shared spatial coordinate system of the physical environment 400 between the first electronic device 101a and the third electronic device 101c. In some examples, while the first electronic device 101a and the third electronic device 101c are establishing a shared spatial coordinate system of the physical environment 400 with each other in FIG. 11H, the second electronic device 101b and the third electronic device 101c are not establishing a shared spatial coordinate system of the physical environment 400 between the second electronic device 101b and the third electronic device 101c (e.g., the second electronic device 101b and the third electronic device 101c are not transmitting map data of the physical environment 400 between each other).

From FIG. 11I to FIG. 11J, in response to receiving (e.g., from the first electronic device 101a) the first shared reference origin 1106a of the first electronic device 101a and the second shared reference origin 1106b of the second electronic device 101b (e.g., the data indicative of the first shared reference origin 1106a of the first electronic device 101a and the second shared reference origin 1106b of the second electronic device 101b), the third electronic device 101c notes (e.g., decodes and/or translates) the first shared reference origin 1106a of the first electronic device 101a and the second shared reference origin 1106b of the second electronic device 101b in a coordinate system (e.g., a local mapping of the physical environment 400) of the third electronic device 101c, such as shown in overhead view 716c. Accordingly, if the shared spatial coordinate system of the physical environment between the first electronic device 101a and the third electronic device 101c is no longer established after the decoding of the first shared reference origin 1106a of the first electronic device 101a and the second shared reference origin 1106b of the second electronic device 101b to the coordinate system of the third electronic device 101c, the third electronic device 101c still knows where the first shared reference origin 1106a of the first electronic device 101a and the second shared reference origin 1106b of the second electronic device 101b are located in the physical environment 400 because the third electronic device 101c noted the location of the first shared reference origin 1106a of the first electronic device 101a and the second shared reference origin 1106b of the second electronic device 101b in the coordinate system of the third electronic device 101c.

Additionally, having received the first shared reference origin 1106a of the first electronic device 101a and the second shared reference origin 1106b of the second electronic device 101b (e.g., the data indicative of the first shared reference origin 1106a of the first electronic device 101a and the second shared reference origin 1106b of the second electronic device 101b), the third electronic device 101c can now determine a pose of the first electronic device 101a and a pose of the second electronic device 101b in the coordinate system of the third electronic device 101c. For example, in FIG. 11J, the first electronic device 101a transmits the first pose of the first electronic device 101a to the second electronic device 101b and the third electronic device 101c, as shown in glyph 11021.

In some examples, the first shared reference origin 1106a of the first electronic device 101a and the second shared reference origin 1106b of the second electronic device 101b include respective keys for decoding an encryption corresponding to pose of the first electronic device 101a that the first electronic device 101a is transmitting (e.g., in the physical environment 400) and the pose of the second electronic device 101b that the second electronic device 101b is transmitting (e.g., in the physical environment 400). In some examples, the first electronic device 101a transmits (e.g., broadcasts) the first pose of the first electronic device 101a independent of whether or not the third electronic device 101c has received the first shared reference origin 1106a of the first electronic device 101a, but the first shared reference origin 1106a of the first electronic device 101a allows the third electronic device 101c to determine the pose of the first electronic device 101a in the coordinate system of the third electronic device 101c (e.g., since the pose of the first electronic device 101a is defined relative to the first shared reference origin 1106a of the first electronic device 101a). In response to receiving the first pose of the first electronic device 101a, the third electronic device 101c determines a pose (e.g., a position and/or orientation) of the first electronic device 101a in the coordinate system of the third electronic device 101c using the first pose of the first electronic device 101a and the first shared reference origin 1106a of the first electronic device 101a that the third electronic device 101c previously noted (e.g., as described above) in the coordinate system of the third electronic device 101c.

In some examples, the second electronic device 101b transmits (e.g., broadcasts) the second pose of the second electronic device 101b independent of whether or not the third electronic device 101c has received the second shared reference origin 1106b of the second electronic device 101b, but the second shared reference origin 1106b of the second electronic device 101b allows the third electronic device 101c to determine the pose of the second electronic device 101b in the coordinate system of the third electronic device 101c (e.g., since the pose of the second electronic device 101b is defined relative to the second shared reference origin 1106b of the second electronic device 101b). In response to receiving the second pose of the second electronic device 101b, the third electronic device 101c determines a pose (e.g., a position and/or orientation) of the second electronic device 101b in the coordinate system of the third electronic device 101c using the second pose of the second electronic device 101b and the second shared reference origin 1106b of the second electronic device 101b that the third electronic device 101c previously noted (e.g., as described above) in the coordinate system of the third electronic device 101c.

As such, the third electronic device 101c can track a location (e.g., pose) of the second electronic device 101b in the physical environment 400 without directly establishing a shared spatial coordinate system of the physical environment 400 with the second electronic device 101b. That is, as illustrated and described herein, in some examples, the third electronic device 101c establishes a shared spatial coordinate system of the physical environment 400 with the first electronic device 101a, and the first electronic device 101a transmits, to the third electronic device 101c, the second shared reference origin 1106b of the second electronic device 101b that was transmitted to the first electronic device 101a in response to (or after) establishment of the shared spatial coordinate system of the physical environment 400 between the first electronic device 101a and the second electronic device 101b. The third electronic device 101c understands the second shared reference origin 1106b of the second electronic device 101b that is transmitted from the first electronic device 101a because the third electronic device 101c and the first electronic device 101a have established a shared spatial coordinate system of the physical environment 400, and as such, have a common mapping (e.g., spatial understanding of the physical environment 400) from which communications regarding spatial data are sent and received between each other.

In some examples, the third electronic device 101c displays user interface elements based on the determined locations of the first electronic device 101a and the second electronic device 101b, such as described with reference to the first electronic device 101a and the second electronic device 101b displaying user interface elements 1108a/1108b in FIG. 11F. The user interface elements are optionally selectable to initiate processes to establish multi-user communication sessions (e.g., multi-user communication session of the second type with the first user 402 and the second user 404), such as described with reference to the user interface element 1108a/1108b in FIG. 11F.

In some examples, after determining the first shared reference origin 1106a of the first electronic device 101a, the first electronic device 101a determines that one or more criteria are satisfied for initiating a process to determine an updated first shared reference origin 1106a of the first electronic device 101a. In some examples, the one or more criteria include a requirement that a distance between a location in the physical environment that corresponds to the first shared reference origin 1106a of the first electronic device 101a and a location in the physical environment that corresponds to the pose of the first electronic device 101a is greater than a threshold distance in order for the one or more criteria to be satisfied. In some examples, the greater the distance, the lower the accuracy of the pose of the first electronic device 101a (e.g., due to anchor drift or angular drift, such as drifting of the first shared reference origin 1106a of the first electronic device 101a). Additionally or alternatively, in some examples, the one or more criteria include a requirement that the first electronic device 101a has been deactivated or doffed and then activated or donned again (optionally at different locations) in order for the one or more criteria to be satisfied. Additionally or alternatively, in some examples, the one or more criteria include a requirement that the first shared reference origin 1106a of the first electronic device 101a has been (e.g., previously) pruned by the first electronic device 101a in order for the one or more criteria to be satisfied. Additionally or alternatively, in some examples, the one or more criteria include a requirement that a location tracking process is being performed (or can be performed) with an electronic device in the physical environment 400 with which the first electronic device 101a has not previously established a shared spatial coordinate system of the physical environment 400.

From FIG. 11K to FIG. 11L, the first electronic device 101a has moved a distance in the physical environment 400 to a location that is greater than the threshold distance described above, which meets the requirement of the one or more criteria that the distance between the location in the physical environment 400 that corresponds to the first shared reference origin 1106a of the first electronic device 101a and the location in the physical environment 400 that corresponds to the pose of the first electronic device 101a is greater than the threshold distance. For example, in FIG. 11L, a distance between a position in the physical environment 400 that corresponds to the first shared reference origin 1106a of the first electronic device 101a and a position in the physical environment 400 that corresponds to the pose of the first electronic device 101a is greater than the threshold distance. In some examples, in response to detecting that the first electronic device 101a has moved in the physical environment 400 to a location that is greater than the threshold distance described above, the first electronic device 101a initiates a process to establish (e.g., re-establish) a shared spatial coordinate system of the physical environment 400 with the second electronic device 101b, as shown with glyph 1102a in FIG. 11L. In some examples, after establishing (e.g., re-establishing) the shared spatial coordinate system of the physical environment 400 between the first electronic device 101a and the second electronic device 101b, the first electronic device 101a determines an updated first shared reference origin 1106a-1 of the first electronic device 101a (e.g., an updated first shared anchor of the first electronic device 101a or an updated first shared origin of the first electronic device 101a) using the shared spatial coordinate system of the physical environment 400 between the first electronic device 101a and the second electronic device 101b, as indicated by glyph 1102n and as shown in overhead view 716a in FIG. 11M. In some examples, the updated first shared reference origin 1106a-1 of the first electronic device 101a includes one or more characteristics described with reference to the first shared reference origin 1106a of the first electronic device 101a. In FIG. 11N, in response to determining the updated first shared reference origin 1106a-1 of the first electronic device 101a, the first electronic device 101a transmits the updated first shared reference origin 1106a-1 of the first electronic device 101a to electronic devices in the physical environment 400 with which the first electronic device 101a has previously established a shared spatial coordinate system of the physical environment 400, such as indicated in glyph 11020. For example, in FIG. 11N, in response to determining the updated first shared reference origin 1106a-1 of the first electronic device 101a, the first electronic device 101a transmits, to the second electronic device 101b and the third electronic device 101c, the updated first shared reference origin 1106a-1 of the first electronic device 101a. In some examples, in response to receiving the updated first shared reference origin 1106a-1 of the first electronic device 101a, the second electronic device 101b notes (e.g., decodes and/or translates) the updated first shared reference origin 1106a-1 of the first electronic device 101a in the coordinate system of the second electronic device 101a, as shown in overhead view 716b in FIG. 11O, and optionally, prunes the first shared reference origin 1106a of the first electronic device 101a from the coordinate system of the second electronic device 101b, as shown in overhead view 716b from FIG. 11N to FIG. 11O. Additionally, in some examples, in response to receiving the updated first shared reference origin 1106a-1 of the first electronic device 101a, the third electronic device 101c notes (e.g., decodes and/or translates) the updated first shared reference origin 1106a-1 of the first electronic device 101a in the coordinate system of the third electronic device 101c, as shown in overhead view 716c in FIG. 11O, and optionally, prunes the first shared reference origin 1106a of the first electronic device 101a from the coordinate system of the third electronic device 101c.

Additionally, in FIG. 11O, in response to determining the updated first shared reference origin 1106a-1 of the first electronic device 101a, the first electronic device 101a computes (e.g., determines or calculates) the first pose of the first electronic device 101a using (e.g., relative to) the updated first shared reference origin 1106a-1 of the first electronic device 101a and then transmits the first pose of the first electronic device 101a to other electronic devices (e.g., other electronic devices in the physical environment 400), as shown in glyph 1102p. For example, after determining the updated first shared reference origin 1106a-1 of the first electronic device 101a, the first electronic device 101a computes the first pose of the first electronic device 101a using (e.g., relative to) the updated first shared reference origin 1106a-1 of the first electronic device 101a and not using the first shared reference origin 1106a of the first electronic device 101a. For example, the first electronic device 101a transmits, to the second electronic device 101b and the third electronic device 101c, the first pose of the first electronic device 101a that is defined relative to the updated first shared reference origin 1106a-1 of the first electronic device 101a and not defined relative to the first shared reference origin 1106a of the first electronic device 101a. The second electronic device 101b and the third electronic device 101c may then determine the pose of the first electronic device 101a in the coordinate system of the second electronic device 101b and the third electronic device 101c using the first pose of the first electronic device 101a and the updated first shared reference origin 1106a-1 of the first electronic device 101a that the second electronic device 101b and the third electronic device 101c previously noted (e.g., as described above) in the coordinate system of the second electronic device 101b and the third electronic device 101c, respectively.

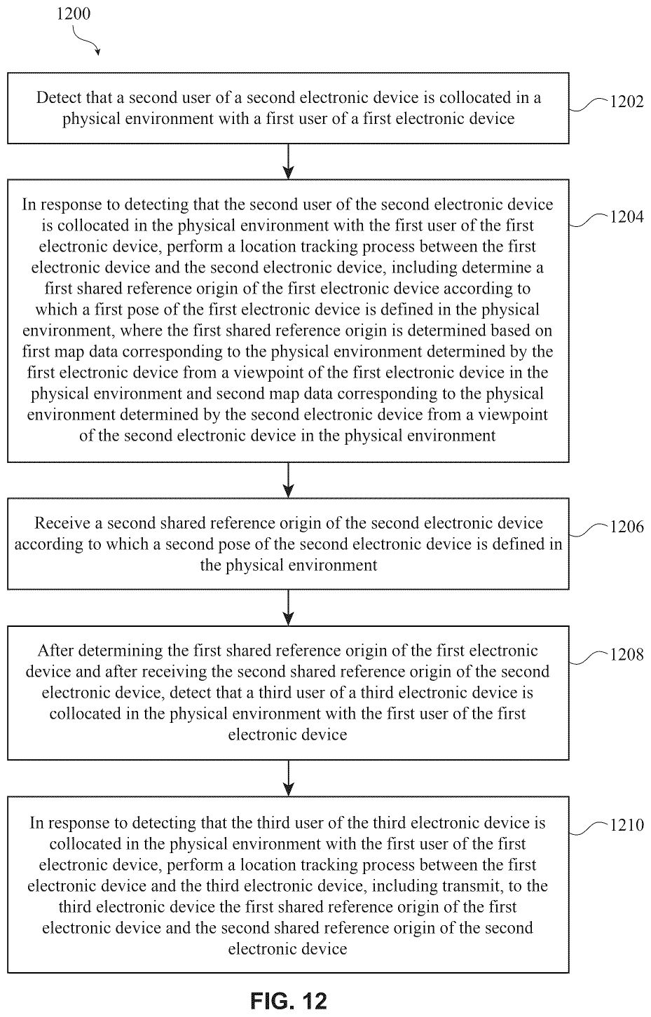

FIG. 12 illustrates a flow diagram illustrating a method 1200 for performing different location tracking processes with different electronic devices in response detecting collocation with the different electronic devices, according to some examples of the disclosure. In some examples, method 1200 begins at a first electronic device in communication with one or more first displays and one or more first input devices. In some examples, the first electronic device includes one or more characteristics of the first electronic device 101a in FIGS. 11A through 11O. One or more examples of method 1200 are illustrated and/or described with reference to one or more of FIGS. 11A through 11O. It is understood that method 1200 is an example and that more, fewer, or different operations can be performed in the same or in a different order. Additionally, the operations in method 1200 described below are, optionally, implemented by running one or more functional modules in an information processing apparatus such as general-purpose processors (e.g., as described with respect to FIGS. 2A-2C) or application specific chips, and/or by other components of FIGS. 2A-2C.

Therefore, according to the above, some examples of the disclosure are directed to a method (e.g., method 1200 of FIG. 12). In some examples, the method 1200 is performed at a first electronic device in communication with one or more first displays and one or more first input devices. The method 1200 includes, detecting (1202) that a second user of a second electronic device is collocated in a physical environment with a first user of the first electronic device, such as described with reference to the first user 402 of the first electronic device 101a being collocated with the second user 404 of the second electronic device 101b in the physical environment 400 in FIG. 11B. The method 1200 includes, in response to detecting that the second user of the second electronic device is collocated in the physical environment with the first user of the first electronic device, performing (1204) a location tracking process between the first electronic device and the second electronic device, such as shown in glyph 1102a in FIG. 11C. In some examples, performing a location tracking process between the first electronic device and the second electronic device includes, determining a first shared reference origin of the first electronic device according to which a first pose of the first electronic device is defined in the physical environment, such as shown in glyph 1102b in FIG. 11D. In some examples, the first shared reference origin is determined based on first map data corresponding to the physical environment determined by the first electronic device from a viewpoint of the first electronic device in the physical environment and second map data corresponding to the physical environment determined by the second electronic device from a viewpoint of the second electronic device in the physical environment, such as shown in glyph 1102b in FIG. 11D. The method 1200 includes, receiving (1206) a second shared reference origin of the second electronic device according to which a second pose of the second electronic device is defined in the physical environment, such as shown with the first electronic device 101a receiving the second shared reference origin 1106b of the second electronic device 101b that the second electronic device 101b transmits to the first electronic device 101a as indicated in glyph 1102e in FIG. 11E. The method 1200 includes, after determining the first shared reference origin of the first electronic device and after receiving the second shared reference origin of the second electronic device, detecting (1208) that a third user of a third electronic device is collocated in the physical environment with the first user of the first electronic device, such as described with reference to the first user 402 and the third user 406 being collocated in the physical environment 400 in FIG. 11G. The method 1200 includes, in response to detecting that the third user of the third electronic device is collocated in the physical environment with the first user of the first electronic device, performing (1210) a location tracking process between the first electronic device and the third electronic device, such as shown in glyph 1102h in FIG. 11H. In some examples, performing the location tracking processing between the first electronic device and the third electronic device includes transmitting, to the third electronic device, the first shared reference origin of the first electronic device and the second shared reference origin of the second electronic device, such as shown in glyph 1102i in FIG. 11I.

Additionally or alternatively, in some examples, the second shared reference origin of the second electronic device is based on the first map data corresponding to the physical environment determined by the first electronic device from the viewpoint of the first electronic device in the physical environment, and the second map data corresponding to the physical environment determined by the second electronic device from the viewpoint of the second electronic device in the physical environment, such as shown in glyph 1102c in FIG. 11D.

Additionally or alternatively, in some examples, the method 1200 includes, after receiving the second shared reference origin of the second electronic device, receiving, from the second electronic device, data corresponding to the second pose of the second electronic device that is defined relative to the second shared reference origin of the second electronic device, such as the first electronic device 101a receiving the second pose of the second electronic device 101b that is transmitted from the second electronic device 101b as indicated in glyph 1102g in FIG. 11E. Additionally or alternatively, in some examples, the method 1200 includes, after receiving the second reference origin of the second electronic device, determining a pose of the second electronic device in the physical environment in a first coordinate system of the first electronic device using the second shared reference origin of the second electronic device and the data corresponding to the second pose of the second electronic device that is defined relative to the second shared reference origin of the second electronic device, such as described with reference to the first electronic device 101a determining the pose of the second electronic device 101b in the coordinate system of the first electronic device 101a using the second pose of the second electronic device 101b and the second shared reference origin 1106b of the second electronic device 101b. Additionally or alternatively, in some examples, the method 1200 includes, after determining the pose of the second electronic device in the physical environment in a first coordinate system of the first electronic device, displaying, via the one or more first displays, a user interface element that is selectable to initiate a process to establish a multi-user communication session with the second user of the second electronic device, such as the user interface element 1108a in FIG. 11F.

Additionally or alternatively, in some examples, the second shared reference origin of the second electronic device is received directly from the second electronic device, such as shown in glyph 1102e in FIG. 11E. Additionally or alternatively, in some examples, the second shared reference origin of the second electronic device is received directly from a fourth electronic device that is associated with a fourth user and that is different from the second electronic device, such as described with reference to the third electronic device 101c receiving the second shared reference origin 1106b of the second electronic device 101b from the first electronic device 101a and not from the second electronic device 101b in FIG. 11I.

Additionally or alternatively, in some examples, performing the location tracking process between the first electronic device and the third electronic device includes receiving, from the third electronic device, a third reference origin of the third electronic device according to which a third pose of the third electronic device is defined in the physical environment, such as shown in glyph 1102k in FIG. 11J. Additionally or alternatively, in some examples, the third shared reference origin of the third electronic device is determined based on the first map data corresponding to the physical environment determined by the first electronic device from the viewpoint of the first electronic device in the physical environment and third map data corresponding to the physical environment determined by the third electronic device from a viewpoint of the third electronic device in the physical environment, such as shown in glyph 1102j in FIG. 11I.

Additionally or alternatively, in some examples, the method 1200 includes, after receiving the second shared reference origin of the second electronic device, receiving, from the second electronic device, data corresponding to the second pose of the second electronic device that is defined relative to the second shared reference origin of the second electronic device, such as the first electronic device 101a receiving the second pose of the second electronic device 101b that is transmitted from the second electronic device 101b as indicated in glyph 1102g in FIG. 11E. Additionally or alternatively, in some examples, the method 1200 includes, after receiving the second shared reference origin of the second electronic device, determining a pose of the second electronic device in the physical environment in a first coordinate system of the first electronic device using the second shared reference origin of the second electronic device and the data corresponding to the second pose of the second electronic device that is defined relative to the second shared reference origin of the second electronic device, such as described with reference to the first electronic device 101a determining the pose of the second electronic device 101b in the coordinate system of the first electronic device 101a using the second pose of the second electronic device 101b and the second shared reference origin 1106b of the second electronic device 101b. Additionally or alternatively, in some examples, the method 1200 includes, after receiving the third shared reference origin of the third electronic device from the third electronic device, receiving, from the third electronic device, data corresponding to the third pose of the third electronic device that is defined relative to the third shared reference origin of the third electronic device, such as the first electronic device 101a receiving the third pose of the third electronic device 101c that is transmitted from the third electronic device 101c as indicated in glyph 11021 in FIG. 11J.

Additionally or alternatively, in some examples, the method 1200 includes, after receiving the third shared reference origin of the third electronic device from the third electronic device, determining a pose of the third electronic device in the physical environment in the first coordinate system of the first electronic device using the third shared reference origin of the third electronic device and the data corresponding to the third pose of the third electronic device that is defined relative to the third shared reference origin of the third electronic device, such as described with reference to the first electronic device 101a determining the pose of the third electronic device 101c in the coordinate system of the first electronic device 101a using the third pose of the third electronic device 101c and the third shared reference origin 1106c of the third electronic device 101c.

Additionally or alternatively, in some examples, performing the location tracking process between the first electronic device and the third electronic device includes receiving, from the third electronic device, a fourth shared reference origin of a fourth electronic device according to which a fourth pose of the fourth electronic device is defined in the physical environment, and the fourth electronic device is associated with a fourth user. For example, before performing a location tracking process with the first electronic device 101a, such as shown in the glyph 1102h, the third electronic device 101c performs a location tracking process with a fourth electronic device, including establishing a shared spatial coordinate system of the physical environment 400 with the fourth electronic device. Continuing with this example, the third electronic device 101c receives the fourth shared reference origin of the fourth electronic device that the fourth electronic device determines using the shared spatial coordinate system of the physical environment 400 established between the third electronic device 101c and the fourth electronic device, such as described with reference to the second electronic device 101b determining the second shared reference origin of the second electronic device 101b using the shared spatial coordinate system of the physical environment 400 established between the first electronic device 101a and the second electronic device 101b in glyph 1102c in FIG. 11D. Additionally or alternatively, in some examples, the method 1200 includes, receiving, from the fourth electronic device, data corresponding to the fourth pose of the fourth electronic device that is defined relative to the fourth shared reference origin of the fourth electronic device. For example, the fourth electronic device transmits, to the first electronic device 101a, the data corresponding to the fourth pose of the fourth electronic device that is defined relative to the fourth shared reference origin of the fourth electronic device, such as described with reference to the third electronic device 101c transmitting the third pose of the third electronic device 101c in glyph 11021 in FIG. 11J. Additionally or alternatively, in some examples, the method 1200 includes, determining a pose of the fourth electronic device in the physical environment in a first coordinate system of the first electronic device using the fourth shared reference origin of the fourth electronic device and the data corresponding to the fourth pose of the fourth electronic device that is defined relative to the fourth shared reference origin of the fourth electronic device, such as described with reference to the first electronic device 101a determining the pose of the third electronic device 101c in the coordinate system of the first electronic device 101a using the third pose of the third electronic device 101c and the third shared reference origin 1106c of the third electronic device 101c.

Additionally or alternatively, in some examples, the method 1200 includes, after receiving the third shared reference origin of the third electronic device, transmitting, to the second electronic device, the third shared reference origin of the third electronic device, such as shown in glyph 1102m in FIG. 11K.

Additionally or alternatively, in some examples, the method 1200 includes, after transmitting the first shared reference origin of the first electronic device and the second shared reference origin of the second electronic device to the third electronic device, transmitting, to the third electronic device, data corresponding to the first pose of the first electronic device that is defined relative to the first shared reference origin of the first electronic device, such as shown in glyph 1102f in FIG. 11J.

Additionally or alternatively, in some examples, the first shared reference origin of the first electronic device is associated with a first location in the physical environment, such as the first shared reference origin 1106a of the first electronic device 101a being associated with its illustrated location in the overhead view 716a in FIG. 11K. Additionally or alternatively, in some examples, the method 1200 includes, transmitting, to the second electronic device and/or the third electronic device, data corresponding to the first pose of the first electronic device that is defined relative to the first shared reference origin of the first electronic device, such as shown in glyph 1102f in FIG. 11K. Additionally or alternatively, in some examples, the method 1200 includes, after transmitting the data corresponding to the first pose of the first electronic device, detecting that one or more criteria are satisfied, such as described herein with reference to the one or more criteria that are satisfied for initiating a process to determine an updated first shared reference origin 1106a of the first electronic device 101a. Additionally or alternatively, in some examples, the method 1200 includes, in response to detecting that the one or more criteria are satisfied, determining an updated first shared reference origin of the first electronic device according to which the first pose of the first electronic device is defined in the physical environment, such as shown with glyph 1102n in FIG. 11M. Additionally or alternatively, in some examples, the updated first shared reference origin of the first electronic device is determined based on the first map data corresponding to the physical environment determined by the first electronic device from the viewpoint of the first electronic device in the physical environment and map data corresponding to the physical environment determined by a respective electronic device other than the first electronic device from a viewpoint of the respective electronic device in the physical environment, such as described with reference to glyph 1102n in FIG. 11M. Additionally or alternatively, in some examples, the method 1200 includes, after determining the updated first shared reference origin of the first electronic device according to which the first pose of the first electronic device is defined in the physical environment, transmitting, to the second electronic device and/or the third electronic device, the updated first shared reference origin of the first electronic device according to which the first pose of the first electronic device is defined in the physical environment, such as described with reference to glyph 11020 in FIG. 11N. Additionally or alternatively, in some examples, the updated first shared reference origin of the first electronic device is associated with a second location in the physical environment that is different from the first location in the physical environment, such as shown with the difference in location between the first shared reference origin 1106a and the updated first shared reference origin 1106a-1 in overhead view 716a from FIG. 11L to FIG. 11M. Additionally or alternatively, in some examples, the respective electronic device other than the first electronic device is the second electronic device, such as the second electronic device 101b, the third electronic device, such as the third electronic device 101c, or a fourth electronic device associated with a fourth user. Additionally or alternatively, in some examples, the one or more criteria include a criterion that is satisfied when a distance between the first electronic device and the first location in the physical environment is greater than a threshold distance, such as described with reference to the first electronic device 101a has moved in the physical environment 400 to a location that is greater than the threshold distance from FIG. 11K to FIG. 11L. Additionally or alternatively, in some examples, the method 1200 includes, after transmitting the updated first shared reference origin of the first electronic device, transmitting, to the second electronic device and/or the third electronic device, the data corresponding to the first pose of the first electronic device that is defined relative to the updated first shared reference origin of the first electronic device, as shown in glyph 1102p in FIG. 11O.

Additionally or alternatively, in some examples, the first electronic device includes a first head-mounted device, such as the first electronic device 101a in FIG. 11B, the second electronic device includes a second head-mounted device, such as the second electronic device 101b in FIG. 11B, and the third electronic device includes a third head-mounted device, such as the third electronic device 101c in FIG. 11G.

Some examples of the disclosure are directed to an electronic device, comprising: one or more processors; memory; and one or more programs stored in the memory and configured to be executed by the one or more processors, the one or more programs including instructions for performing any of the above methods. Some examples of the disclosure are directed to a non-transitory computer readable storage medium storing one or more programs, the one or more programs comprising instructions, which when executed by one or more processors of an electronic device, cause the electronic device to perform any of the above methods. Some examples of the disclosure are directed to an electronic device, comprising one or more processors, memory, and means for performing any of the above methods. Some examples of the disclosure are directed to an information processing apparatus for use in an electronic device, the information processing apparatus comprising means for performing any of the above methods.

It should be understood that the particular order in which the operations in methods 500, 600, 800, 1000, and/or 1200 have been described is merely exemplary and is not intended to indicate that the described order is the only order in which the operations could be performed. One of ordinary skill in the art would recognize various ways to reorder the operations described herein. In some examples, aspects/operations of methods 500, 600, 800, 1000, and/or 1200 may be interchanged, substituted, and/or added between these methods. For brevity, these details are not repeated here.

The present disclosure contemplates that in some examples, the data utilized can include personal information data that uniquely identifies or can be used to contact or locate a specific person. Such personal information data can include demographic data, content consumption activity, location-based data, telephone numbers, email addresses, TWITTER ID's, home addresses, data or records relating to a user's health or level of fitness (e.g., vital signs measurements, medication information, exercise information), date of birth, or any other identifying or personal information. Specifically, as described herein, one aspect of the present disclosure is tracking a user's location data.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data can be governed by federal and/or state laws, such as the Health Insurance Portability and Accountability Act (HIPAA); whereas health data in other countries can be subject to other regulations and policies and should be handled accordingly. Hence different privacy practices should be maintained for different personal data types in each country.

Despite the foregoing, the present disclosure also contemplates examples in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to enable recording of personal information data in a specific application (e.g., first application and/or second application). In addition to providing “opt in” and “opt out” options, the present disclosure contemplates providing notifications relating to the access or use of personal information. For instance, a user can be notified upon initiating collection that their personal information data will be accessed and then reminded again just before personal information data is accessed by the one or more devices.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification can be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

1. A method comprising:
at a first electronic device in communication with one or more first displays and one or more first input devices, wherein the first electronic device is collocated with a second electronic device in a physical environment, wherein the first electronic device has a first pose relative to a first reference origin of the first electronic device in the physical environment, and wherein the second electronic device has a second pose relative to a second reference origin of the second electronic device in the physical environment:
before establishing a multi-user communication session between the first electronic device and the second electronic device:
determining a shared reference origin in the physical environment based on:
first map data determined by the first electronic device; and
second map data determined by the second electronic device;
after determining the shared reference origin, receiving first information from the second electronic device, the first information including:
the second pose of the second electronic device relative to the second reference origin of the second electronic device; and
an offset of the second reference origin of the second electronic device relative to the shared reference origin; and
displaying, via the one or more first displays, a user interface element at a location that is based on the first information, the user interface element selectable to establish the multi-user communication session between the first electronic device and the second electronic device.

2. The method of claim 1, wherein the first electronic device being collocated with the second electronic device is in accordance with a determination that the second electronic device is in a field of view of the first electronic device in the physical environment.

3. The method of claim 1, wherein the first electronic device being collocated with the second electronic device is in accordance with a determination that the second electronic device is within a signal-based distance range of the first electronic device in the physical environment.

4. The method of claim 1, wherein the first electronic device being collocated with the second electronic device is in accordance with a determination that the second electronic device is within a threshold distance of the first electronic device.

5. The method of claim 1, wherein the first electronic device being collocated with the second electronic device is in accordance with a determination that a user of the second electronic device is in a contact list of the first electronic device.

6. The method of claim 1, wherein determining the shared reference origin is performed in accordance with at least one of:
a first determination that the second electronic device is within a signal-based distance range of the first electronic device in the physical environment,
a second determination that the second electronic device is within a threshold distance of the first electronic device, and
a third determination that a user of the second electronic device is in a contact list of the first electronic device.

7. The method of claim 1, wherein the shared reference origin is different from:
the first reference origin of the first electronic device; and
the second reference origin of the second electronic device.

8. The method of claim 1, wherein the first electronic device is also collocated with a third electronic device in the physical environment, wherein the third electronic device has a third pose relative to a third reference origin of the third electronic device in the physical environment, and wherein the method comprises:
while a multi-user communication session has not been established between the first electronic device and the third electronic device:
determining a respective shared reference origin in the physical environment based on:
the first map data detected by the first electronic device; and
third map data received from the third electronic device;
after determining the respective shared reference origin, receiving respective information from the third electronic device, the respective information including:
the third pose of the third electronic device relative to the third reference origin of the third electronic device; and
a respective offset of the third reference origin of the third electronic device relative to the respective shared reference origin; and
displaying, via the one or more first displays, a respective user interface element at a respective location that is based on the respective information, the respective user interface element selectable to establish the multi-user communication session between the first electronic device and the third electronic device.

9-83. (canceled)

84. A first electronic device comprising:
one or more processors; and
memory, wherein the first electronic device is in communication with one or more first displays and one or more first input devices, wherein the one or more processors are configured to execute one or more programs stored in the memory, and wherein the one or more programs include instructions for performing a method comprising:
before establishing a multi-user communication session between the first electronic device and a second electronic device, wherein the first electronic device is collocated with the second electronic device in a physical environment, wherein the first electronic device has a first pose relative to a first reference origin of the first electronic device in the physical environment, and wherein the second electronic device has a second pose relative to a second reference origin of the second electronic device in the physical environment:
determining a shared reference origin in a physical environment based on:
first map data determined by the first electronic device; and
second map data determined by a second electronic device;
after determining the shared reference origin, receiving first information from the second electronic device, the first information including:
the second pose of the second electronic device relative to the second reference origin of the second electronic device; and
an offset of the second reference origin of the second electronic device relative to the shared reference origin; and
displaying, via the one or more first displays, a user interface element at a location that is based on the first information, the user interface element selectable to establish the multi-user communication session between the first electronic device and the second electronic device.

85. The first electronic device of claim 84, wherein the location at which the user interface element is displayed corresponds to a respective location in the physical environment that is between a first location of the first electronic device in the physical environment and a second location of the second electronic device in the physical environment from a viewpoint of the first electronic device.

86. The first electronic device of claim 85, wherein:
a distance between the respective location and the first location is a first distance;
a distance between the respective location and the second location is a second distance; and
the first distance is less than the second distance.

87. The first electronic device of claim 85, wherein:
a distance between the respective location and the first location is a first distance;
a distance between the respective location and the second location is a second distance; and
the second distance is less than the first distance.

88. The first electronic device of claim 84, wherein the second pose of the second electronic device relative to the second reference origin of the second electronic device that is included in the first information is a first respective pose of the second electronic device at a first time, and wherein the method comprises:
after receiving the first information from the second electronic device and after displaying the user interface element at the location that is based on the first information, receiving updated first information from the second electronic device, the updated first information including:
a pose of the second electronic device at a second time, after the first time, wherein the pose of the second electronic device at the second time is a second respective pose, different from the first respective pose, of the second electronic device relative to the second reference origin of the second electronic device; and
the offset of the second reference origin of the second electronic device relative to the shared reference origin; and
displaying, via the one or more first displays, the user interface element at a respective location that is based on the updated first information.

89. The first electronic device of claim 84, wherein determining the shared reference origin is in accordance with detecting an indication that the second electronic device has selected the shared reference origin to be the shared reference origin.

90. The first electronic device of claim 84, wherein determining the shared reference origin includes:
determining a plurality of potential shared reference origins; and
selecting the shared reference origin from the plurality of potential shared reference origins.

91. The first electronic device of claim 84, wherein the method is part of a first location detection process for determining a location of the second electronic device and is not part of a second location detection process for determining a location of the second electronic device, and wherein the method comprises:
detecting, via the one or more first input devices, input corresponding to selection of the user interface element; and
in response to detecting the input corresponding to selection of the user interface element, performing the second location detection process for determining the location of the second electronic device without performing the first location detection process for determining the location of the second electronic device.

92. A non-transitory computer readable storage medium storing one or more programs, the one or more programs comprising instructions, which when executed by one or more processors of a first electronic device that is in communication with one or more first displays and one or more first input devices, cause the first electronic device to perform a method comprising:
before establishing a multi-user communication session between the first electronic device and a second electronic device, wherein the first electronic device is collocated with the second electronic device in a physical environment, wherein the first electronic device has a first pose relative to a first reference origin of the first electronic device in the physical environment, and wherein the second electronic device has a second pose relative to a second reference origin of the second electronic device in the physical environment:
determining a shared reference origin in a physical environment based on:
first map data determined by the first electronic device; and
second map data determined by a second electronic device;
after determining the shared reference origin, receiving first information from the second electronic device, the first information including:
the second pose of the second electronic device relative to the second reference origin of the second electronic device; and
an offset of the second reference origin of the second electronic device relative to the shared reference origin; and
displaying, via the one or more first displays, a user interface element at a location that is based on the first information, the user interface element selectable to establish the multi-user communication session between the first electronic device and the second electronic device.

93. The non-transitory computer readable storage medium of claim 92, wherein the second electronic device is in communication with one or more second displays, and wherein the method comprises:
while displaying the user interface element at the location based on the first information, detecting, via the one or more first input devices, input corresponding to selection of the user interface element;
in response to detecting the input corresponding to selection of the user interface element, establishing the multi-user communication session between the first electronic device and the second electronic device; and
while the multi-user communication session between the first electronic device and the second electronic device is active, displaying, via the one or more first displays, shared virtual content at a corresponding location in the physical environment, wherein the shared virtual content is also displayed via the one or more second displays at the corresponding location in the physical environment.

94. The non-transitory computer readable storage medium of claim 92, wherein the method comprises:
while displaying the user interface element, detecting, via the one or more first input devices, selection of the user interface element; and
in response to detecting the selection of the user interface element, establishing the multi-user communication session between the first electronic device and the second electronic device, wherein the multi-user communication session between the first electronic device and the second electronic device is a first multi-user communication session between the first electronic device and the second electronic device.

95. The non-transitory computer readable storage medium of claim 94, wherein the method comprises:
while in the first multi-user communication session with the second electronic device, tagging a first anchor of a coordinate system of the physical environment of the first electronic device with an indicator of a second user of the second electronic device; and
after tagging the first anchor of the coordinate system of the physical environment of the first electronic device with the indicator of the second user of the second electronic device, ceasing the first multi-user communication session.

96. The non-transitory computer readable storage medium of claim 95, wherein the method comprises:
after ceasing the first multi-user communication session:
in accordance with a determination that the first electronic device and the second electronic device are collocated in the physical environment after ceasing the first multi-user communication session, performing a first process; and
in accordance with a determination that the first electronic device and the second electronic device are not collocated in the physical environment after ceasing the first multi-user communication session, performing a second process that is different from the first process.

97. The non-transitory computer readable storage medium of claim 96, wherein the determination that the first electronic device and the second electronic device are collocated in the physical environment after ceasing the first multi-user communication session includes:
a determination that the second user of the second electronic device is in a contact list of an application on the first electronic device after ceasing the first multi-user communication session;
a determination that the second electronic device is within a signal-based distance range of the first electronic device in the physical environment after ceasing the first multi-user communication session;
a determination that an amount of time elapsed since ceasing of the first multi-user communication session is less than a threshold amount of time; or
a determination that the first anchor of the coordinate system of the physical environment of the first electronic device is still tagged with the indicator of the second user of the second electronic device after ceasing the first multi-user communication session; or
any combination thereof.

98. The non-transitory computer readable storage medium of claim 97, wherein:
determining that the first anchor of the coordinate system of the physical environment of the first electronic device is still tagged with the indicator of the second user of the second electronic device after ceasing the first multi-user communication session includes determining that the amount of time elapsed since ceasing of the first multi-user communication session is less than the threshold amount of time; and
determining that the first anchor of the coordinate system of the physical environment of the first electronic device is not still tagged with the indicator of the second user of the second electronic device after ceasing the first multi-user communication session includes determining that the amount of time elapsed since ceasing of the first multi-user communication session is not less than the threshold amount of time.

99. The non-transitory computer readable storage medium of claim 96, wherein:
after ceasing the first multi-user communication session:
the first electronic device is collocated with the second electronic device in the physical environment;
the first electronic device has a first respective pose relative to a first respective reference origin of the first electronic device in the physical environment; and
the second electronic device has a second respective pose relative to a second respective reference origin of the second electronic device in the physical environment; and
the first process includes:
before establishing a second multi-user communication session between the first electronic device and the second electronic device:
determining a respective shared reference origin in the physical environment based on:
first respective map data determined by the first electronic device; and
second respective map data determined by the second electronic device;
after determining the respective shared reference origin, receiving first respective information from the second electronic device, the first respective information including:
the second respective pose of the second electronic device relative to the second respective reference origin of the second electronic device; and
a respective offset of the second respective reference origin of the second electronic device relative to the respective shared reference origin; and
displaying, via the one or more first displays, the user interface element at a respective location that is based on the first respective information, the user interface element selectable to establish the second multi-user communication session between the first electronic device and the second electronic device.
